(19) United States
(12) Patent Application Publication
(10) Pub. No.: US 2009/0092801 A1
(43) Pub. Date: Apr. 9, 2009

(54) NONAQUEOUS INKJET INK, INK COMPOSITION FOR INKJET RECORDING, AND SUBSTRATE FOR COLOR FILTER

(75) Inventors: Shinichi Sato, Saitama (JP); Seiji Aida, Saitama (JP); Atsushi Nakazato, Hyougo (JP); Tsutomu Hiroshima, Hyougo (JP); Yoshikazu Tanaka, Saitama (JP); Dai Inagaki, Saitama (JP); Takayuki Nogami, Saitama (JP); Tomonori Ikegami, Saitama (JP)

Correspondence Address: HESLIN ROTHENBERG FARLEY & MESITI PC, 5 COLUMBIA CIRCLE, ALBANY, NY, 12203, US

(73) Assignee: TOYO INK MANUFACTURING CO., LTD., Tokyo (JP)

(21) Appl. No.: 12/298,422

(22) PCT Filed: Apr. 24, 2007
(86) PCT No.: PCT/JP2007/058847

§ 371 Date: Oct. 24, 2008

(30) Foreign Application Priority Data
Apr. 24, 2006 (JP) 2006-118996
Apr. 24, 2006 (JP) 2006-119001
Apr. 24, 2006 (JP) 2006-119009
Apr. 24, 2006 (JP) 2006-119029

(51) Int. Cl. B32B 3/10; C08G 18/61; C08G 18/72

(52) U.S. Cl. 428/195.1; 524/590

(57) ABSTRACT

A nonaqueous ink composition for an ink jet recording, comprising
(A) a urethane resin dispersant with an acidic functional group,
(B) a pigment, and
(C) an organic solvent [and optionally (D) a thermal reactive compound],
characterized in that
the urethane resin dispersant (A) is a branched urethane resin dispersant prepared by polymerizing a terminal-isocyanate-containing compound (p), which has been prepared by reacting
(a) a polyisocyanate having three or more isocyanate groups, and
(b) a monoalcohol,
under the condition that a molar ratio (Ma/Mb) of the number of moles (Ma) of isocyanate groups (NCO) from the polyisocyanate (a) to the number of moles (Mb) of hydroxyl groups (OH) from the monoalcohol (b) is 3/2 to 3/0.5,
(c) a compound having one or more acidic groups and two or more hydroxyl groups, and
(q) a polyol compound having two or more hydroxyl groups via 1 to 30 atoms,
   under the condition that the hydroxyl groups are in excess; and
   in that 25% to 60% by weight of the polyisocyanate (a) is used with respect to a total amount of nonvolatile components in the branched urethane resin dispersant, is disclosed.

### TECHNICAL FIELD

The present invention relates to a pigment-dispersed nonaqueous inkjet ink having excellent dispersibility, flowability, and stability in printing. Further, the present invention also relates to an ink composition for ink jet recording, and a substrate for a color filter. The ink composition for ink jet recording according to the present invention can be preferably used, for example, in the production of a color filter substrate for a liquid crystal display panel.

### BACKGROUND ART

In the past, an inkjet ink prepared by dissolving a water-soluble dyestuff, such as an acid dyestuff, a direct dyestuff, a basic dyestuff, or the like in a glycol-based solvent and water has been widely used (Patent References 1 to 3). In this case, a dyestuff having a high water-solubility is generally used as the water-soluble dyestuff to obtain a stable ink. Therefore, a printed record by inkjet recording generally has a poor water resistance, and if water is spilled on the printed record, dyestuff is readily bleeded from the printed record.

To improve the poor water resistance, it is attempted to alter the dyestuff structures, or prepare inks having strong basicity (Patent Reference 4). Further, it is attempted to improve water resistance by means of the reaction between a recording paper and an ink (Patent References 5 to 8). These methods exhibit remarkable effects on particular papers. However, the methods are restricted by the recording papers, and general versatility is defective. Further, if a medium other than the particular papers is used, a sufficient water resistance cannot be obtained from an ink containing a water soluble dyestuff, in many cases.

An ink prepared by dissolving or dispersing an oil-soluble dyestuff in a solvent having a high boiling point, or an ink prepared by dissolving an oil-soluble dyestuff in a volatile solvent are known as an ink having good water resistance. However, a dyestuff has no advantage over a pigment in many resistances such as a light resistance. Thus, an ink containing a pigment as a colorant is desired. However, an ink containing a pigment has problems, for example, it cannot be discharged due to a high viscosity, or it has a poor stability in printing.

A liquid crystal display panel used in a thin-screen television comprises a substrate for a color filter, a liquid crystal cell substrate, and a backlight unit, as main constitutional elements. The backlight unit is a luminous source provided on the back side of the liquid crystal cell substrate. The liquid crystal in the liquid crystal cell substrate is filled between the TFT (thin film transistor) array substrate and the substrate for a color filter. On the substrate for a color filter, repeating patterns of three elementary colors (red, green and blue: RGB) are formed at positions opposing to the respective pixels of the TFT array substrate. A transparent electrode is provided all over the substrate for a color filter. Orientation of the liquid crystal and thus an amount of light are controlled by a voltage between the transparent electrode and pixel electrodes of the TFT array substrate.

Specifically, the substrate for a color filter is formed by parallel or crosswise arranging fine stripes of the filter segments having three or more shades on a transparent substrate such as a glass plate, or lengthwise and breadthwise arranging fine mosaics of the filter segments. In order to enhance displaying contrast of the substrate for a color filter, light-shielding sectors (black matrices) having a certain width are arranged between the filter segments. The width of the stripe or the side length of the mosaic in the substrate for a color filter is as fine as about 70 μm. The stripes or the mosaics for each shade are regularly arranged in the determined order. A layer thickness of the substrate for a color filter is 0.8 to 1.5 μm, and the pigments account for 25 to 45 wt % in the filter segments.

In the past, the substrate for a color filter has been manufactured by repeating the steps of coating a transparent substrate with a photoresist liquid containing dispersed pigments, drying, exposing, developing, and curing. Therefore, the productivity rate is low, and a cost reduction is intensively desired. Particularly, a technique alternative to photoresist is desired as a large-sized liquid crystal display panel is prevailing.

In view of the above demands, the processes and apparatuses for manufacture thereof are reviewed, and a process for manufacturing the substrate for a color filter by an inkjet printing has now attracted attention. In the process of inkjet recording, particularly, an apparatus can be easily downsized, and thus, it has the advantage of high productivity. Recently, due to the technology advancement of a printer head or an ink therefor, a pigment-based ink is being used. As a result, light resistance or fastness is improved. Therefore, it is considered advantageous to apply the inkjet process to the substrate for a color filter, and many attempts are proposed (for example, Patent References 9 to 11).

In the formation of filter segments by the inkjet recording, black matrices are formed in advance on the transparent substrate, and inks are filled by the inkjet recording in the sections separated by the black matrices. However, a conventional ink for inkjet recording generally contains approximately 5 wt % of pigment to assure a low viscosity for a discharging stability or the like. If such an ink is used to form the substrate for a color filter with a normal thickness, the required concentration for the color filter substrate cannot be obtained.

In order to form filter segments with the required concentration, the amount of ink filled in the sections separated by the black matrices should be increased, or the content of pigments in an inkjet ink should be increased. However, if the amount of the ink filled in the sections separated by the black matrices is increased, the ink may overflow the black matrices into neighboring sections to affect the shades of the filter segments. If the content of pigments in an inkjet ink is increased, the viscosity of the ink becomes too high to be discharged as an inkjet ink.

### [Patent Reference 1] Japanese Unexamined Patent Publication (Kokai) No. 53-614112

### [Patent Reference 2] Japanese Unexamined Patent Publication (Kokai) No. 54-89811

### [Patent Reference 3] Japanese Unexamined Patent Publication (Kokai) No. 55-65269

### [Patent Reference 4] Japanese Unexamined Patent Publication (Kokai) No. 56-57862

### [Patent Reference 5] Japanese Unexamined Patent Publication (Kokai) No. 50-49004

### [Patent Reference 6] Japanese Unexamined Patent Publication (Kokai) No. 57-36692

### [Patent Reference 7] Japanese Unexamined Patent Publication (Kokai) No. 59-20696

### [Patent Reference 8] Japanese Unexamined Patent Publication (Kokai) No. 59-146889

### [Patent Reference 9] Japanese Unexamined Patent Publication (Kokai) No. 1-217302

### [Patent Reference 10] Japanese Unexamined Patent Publication (Kokai) No. 7-174915

### [Patent Reference 11] Japanese Unexamined Patent Publication (Kokai) No. 8-75916

### DISCLOSURE OF INVENTION

### Problems to be Solved by the Invention

The object of the present invention is to provide a pigment-dispersed nonaqueous inkjet ink having excellent dispersibility, flowability, and stability in printing.

Further, the present invention also provides an ink composition containing a high concentration of a dispersed pigment, which is at the same time capable of being stably discharged onto desired positions on a substrate by an inkjet recoding process.

Additionally, the present invention provides a substrate for a color filter which can be formed, by an inkjet recoding process using the above ink.

### Means for Solving the Problems

The present invention relates to a nonaqueous ink composition for an ink jet recording, comprising

(A) a urethane resin dispersant with an acidic functional group,
(B) a pigment, and
(C) an organic solvent,
characterized in that
the urethane resin dispersant (A) is a branched urethane resin dispersant prepared by polymerizing a terminal-isocyanate-containing compound (p), which has been prepared by reacting
(a) a polyisocyanate having three or more isocyanate groups, and
(b) a monoalcohol,
under the condition that a molar ratio (Ma/Mb) of the number of moles (Ma) of isocyanate groups (NCO) from the polyisocyanate (a) to the number of moles (Mb) of hydroxyl groups (OH) from the monoalcohol (b) is 3/2 to 3/0.5,
(c) a compound having one or more acidic groups and two or more hydroxyl groups, and
(q) a polyol compound having two or more hydroxyl groups via 1 to 30 atoms,
under the condition that the hydroxyl groups are in excess; and
in that 25% to 60% by weight of the polyisocyanate (a) is used with respect to a total amount of nonvolatile components in the branched urethane resin dispersant.

In the nonaqueous ink composition for ink jet recording according to the above embodiment of the present invention, (d) an acrylic resin having two or more hydroxyl groups via 1 to 30 atoms and/or (e) a siloxane resin having two or more hydroxyl groups via 1 to 30 atoms can be used as the polyol compound (q).

The nonaqueous ink composition for ink jet recording according to the above embodiment of the present invention may further comprise (D) a thermal reactive compound.

In the nonaqueous ink composition for ink jet recording according to the above embodiment of the present invention, the monoalcohol (b) may be at least one resin selected from the group consisting of (b1) a lactone resin having one hydroxyl group, (b2) an oxyalkylene resin having one hydroxyl group, (b3) an acrylic resin having one hydroxyl group, and (b4) a siloxane resin having one hydroxyl group.

The present invention also relates to a nonaqueous ink composition for an ink jet recording, comprising

(A) a urethane resin dispersant with an acidic functional group,
(B) a pigment, and
(C) an organic solvent,
characterized in that
the urethane resin dispersant (A) is a branched urethane resin dispersant prepared by polymerizing a terminal-isocyanate-containing compound (p), which has been prepared by reacting
(a) a polyisocyanate having three or more isocyanate groups, and
(b) a monoalcohol,
under the condition that a molar ratio (Ma/Mb) of the number of moles (Ma) of isocyanate groups (NCO) from the polyisocyanate (a) to the number of moles (Mb) of hydroxyl groups (OH) from the monoalcohol (b) is 3/2 to 3/0.5, and
(c) a compound having one or more acidic groups and two or more hydroxyl groups,
under the condition that the hydroxyl groups are in excess; in that 25% to 60% by weight of the polyisocyanate (a) is used with respect to a total amount of nonvolatile components in the branched urethane resin dispersant; and in that the monoalcohol (b) is at least one resin selected from the group consisting of (b1) a lactone resin having a hydroxyl group, (b2) an oxyalkylene resin having a hydroxyl group, (b3) an acrylic resin having a hydroxyl group, and (b4) a siloxane resin having a hydroxyl group.

The nonaqueous ink composition for ink jet recording according to the above embodiment of the present invention may further comprise (D) a thermal reactive compound.

In the nonaqueous ink composition for ink jet recording according to the above embodiments of the present invention, the polyisocyanate (a) may be a trimer of diisocyanate.

In the nonaqueous ink composition for ink jet recording according to the above embodiments of the present invention, the polyisocyanate (a) may be a trimer of isophoronediisocyanate.

In the nonaqueous ink composition for ink jet recording according to the above embodiments of the present invention, the lactone resin (b1) having one hydroxyl group is; (i) a homopolymer prepared by polymerizing a monoalcohol (b5) with at least one monomer selected from ε-caprolactone, 4-methylcaprolactone, 3,5,5-trimethylcaprolactone, 3,3,5-trimethylcaprolactone, β-propiolactone, γ-butyrolactone, δ-valerolactone, and enantholactone, or (ii) a copolymer prepared by copolymerizing at least two or more monomers selected from the above compounds with the monoalcohol (b5), or (iii) a mixture of two or more polymers selected from the above homopolymers (i) and the above copolymers (ii).

In the nonaqueous ink composition for ink jet recording according to the above embodiments of the present invention, the acrylic resin (b3) having one hydroxyl group may be prepared by polymerizing monomers containing 20% to 70% by weight of benzyl(meta)acrylate.

In the nonaqueous ink composition for ink jet recording according to the above embodiments of the present invention, the monoalcohol (b) may further comprise (meta)acrylate (b6) having one hydroxyl group.

Further, the present invention also relates to a nonaqueous ink composition for an ink jet recording, comprising

(A) a urethane resin dispersant with an acidic functional group,
(B) a pigment, and
(C) an organic solvent,
characterized in that
the urethane resin dispersant (A) is a branched urethane resin dispersant prepared by reacting
hydroxyl groups in a terminal-hydroxyl-containing compound prepared by polymerizing a terminal-isocyanate-containing compound (p), which has been prepared by reacting
(a) a polyisocyanate having three or more isocyanate groups, and
(b) a monoalcohol,
under the condition that a molar ratio (Ma/Mb) of the number of moles (Ma) of isocyanate groups (NCO) from the polyisocyanate (a) to the number of moles (Mb) of hydroxyl groups (OH) from the monoalcohol (b) is 3/2 to 3/0.5, and (q) a polyol compound having two or more hydroxyl groups via 1 to 30 atoms,
under the condition that the hydroxyl groups are in excess, and
acid anhydride groups in a compound (r) having acid anhydride groups; and
in that 25% to 60% by weight of the polyisocyanate (a) is used with respect to a total amount of nonvolatile components in the branched urethane resin dispersant.

In the nonaqueous ink composition for ink jet recording according to the above embodiment of the present invention, (d) an acrylic resin having two or more hydroxyl groups via 1 to 30 atoms and/or

(e) a siloxane resin having two or more hydroxyl groups via 1 to 30 atoms
may be used as the polyol compound (q).

The nonaqueous ink composition for ink jet recording according to the above embodiment of the present invention may further comprise (D) a thermal reactive compound.

In the nonaqueous ink composition for ink jet recording according to the above embodiment of the present invention, the monoalcohol (b) may be at least one resin selected from the group consisting of (b1) a lactone resin having a hydroxyl group, (b2) an oxyalkylene resin having a hydroxyl group, (b3) an acrylic resin having a hydroxyl group, and (b4) a siloxane resin having a hydroxyl group.

Further, the present invention also relates to a nonaqueous ink composition for an ink jet recording, comprising

(A) a urethane resin dispersant with an acidic functional group,
(B) a pigment, and
(C) an organic solvent,
characterized in that
the urethane resin dispersant (A) is a branched urethane resin dispersant prepared by reacting
hydroxyl groups in a terminal-hydroxyl-containing compound prepared by polymerizing a terminal-isocyanate-containing compound (p), which has been prepared by reacting
(a) a polyisocyanate having three or more isocyanate groups, and
(b) a monoalcohol,
under the condition that a molar ratio (Ma/Mb) of the number of moles (Ma) of isocyanate groups (NCO) from the polyisocyanate (a) to the number of moles (Mb) of hydroxyl groups (OH) from the monoalcohol (b) is 3/2 to 3/0.5, and (f) a polyol compound,
under the condition that the hydroxyl groups are in excess, and
acid anhydride groups in a compound (r) having acid anhydride groups;
in that 25% to 60% by weight of the polyisocyanate (a) is used with respect to a total amount of nonvolatile components in the branched urethane resin dispersant; and
in that the monoalcohol (b) is at least one resin selected from the group consisting of (b1) a lactone resin having a hydroxyl group, (b2) an oxyalkylene resin having a hydroxyl group, (b3) an acrylic resin having a hydroxyl group, and (b4) a siloxane resin having a hydroxyl group.

The nonaqueous ink composition for ink jet recording according to the above embodiment of the present invention may further comprise (D) a thermal reactive compound.

In the nonaqueous ink composition for ink jet recording according to the above embodiment of the present invention, the polyisocyanate (a) may be a trimer of diisocyanate.

In the nonaqueous ink composition for ink jet recording according to the above embodiment of the present invention, the polyisocyanate (a) may be a trimer of isophoronediisocyanate.

In the nonaqueous ink composition for ink jet recording according to the above embodiment of the present invention, the lactone resin (b1) having one hydroxyl group is; (i) a homopolymer prepared by polymerizing a monoalcohol (b5) with at least one monomer selected from ε-caprolactone, 4-methylcaprolactone, 3,5,5-trimethylcaprolactone, 3,3,5-trimethylcaprolactone, β-propiolactone, γ-butyrolactone, δ-valerolactone, and enantholactone, or (ii) a copolymer prepared by copolymerizing at least two or more monomers selected from the above compounds with the monoalcohol (b5), or (iii) a mixture of two or more polymers selected from the above homopolymers (i) and the above copolymers (ii).

In the nonaqueous ink composition for ink jet recording according to the above embodiment of the present invention, the acrylic resin (b3) having one hydroxyl group may be prepared by polymerizing monomers containing 20% to 70% by weight of benzyl(meta)acrylate.

In the nonaqueous ink composition for ink jet recording according to the above embodiment of the present invention, the monoalcohol (b) may further comprise (b6) a (meta) acrylate having one hydroxyl group.

In the nonaqueous ink composition for ink jet recording according to the above embodiment of the present invention, the compound (r) having an acid anhydride group may be trimellitic anhydride or pyromellitic dianhydride.

In the nonaqueous ink composition for ink jet recording according to the present invention, the monoalcohol (b) may further comprise (b7) a monoalcohol having a thermosetting site.

In the nonaqueous ink composition for ink jet recording according to the present invention, the monoalcohol (b7) having a thermosetting site may be oxetane alcohol or glycerine cyclocarbonate.

In the nonaqueous ink composition for ink jet recording according to the present invention, the thermal reactive compound may be at least one compound selected from the group consisting of a melamine compound, a benzoguanamine compound, an epoxy compound, a phenol compound, a blocked isocyanate compound, acrylate-based monomer, and silane coupling agent.

The nonaqueous ink composition for ink jet recording according to the present invention may further comprise a binder resin.

The nonaqueous ink composition for ink jet recording according to the present invention may further comprise a pigment derivative, and the pigment derivative may be a compound of the general formula (1a):

G¹-(E)q (1a)

wherein G¹ is a residue of a chromogen compound, E is a basic substituent, an acidic substituent or a neutral substituent, q is an integer from 1 to 4. Further, the pigment derivative may further contain at least one derivative selected from the group consisting of a pigment derivative having a basic group, an anthraquinone derivative having a basic group, an acridone derivative having a basic group, and a triazine derivative having a basic group.

In the nonaqueous ink composition for ink jet recording according to the present invention, a solid content may be 3 to 60% by weight with respect to a total weight of the ink composition.

In the nonaqueous ink composition for ink jet recording according to the present invention, the content of the pigment may be 1 to 30% by weight with respect to a total weight of the ink composition.

In the nonaqueous ink composition for ink jet recording according to the present invention, an amount of the urethane resin dispersant may be 3 to 150 parts by weight with respect to 100 parts by weight of the pigment.

In the nonaqueous ink composition for ink jet recording according to the present invention, when a concentration of a solid content ranges from not less than 20% by weight to less than 40% by weight, a viscosity [applied only in case that a shear rate is 100 (1/s); the viscosity has the same meaning in the following statements] may be 3 to 200 (mPa·s), and a T.I. value [the T.I. value is a ratio (ηa/ηb) of a viscosity ηa (mPa·s) at a shear rate of 10 (1/s) to a viscosity ηb (mPa·s) at a shear rate of 1000 (1/s); it has the same meaning in the following statements] may be 1 to 2, and when a concentration of a solid content ranges from not less than 40% by weight to not more than 60% by weight, the viscosity may be 10 to 200 (mPa·s), and the T.I. value may be 1 to 3.

In the nonaqueous ink composition for ink jet recording according to the present invention, a viscosity at 25° C. may be 2 to 40 mPa·s.

The nonaqueous ink composition for ink jet recording according to the present invention may be for a substrate for a color filter.

Further, the present invention also relates to a substrate for a color filter, having a printed layer formed from the above nonaqueous ink composition for ink jet recording.

### EFFECTS OF THE INVENTION

According to the present invention, a pigment-dispersed nonaqueous inkjet ink having excellent dispersibility, flowability, and stability in printing can be provided.

Further, since the ink composition for ink jet recording according to the present invention contains a urethane resin dispersant, it has an excellent stability for charging, even though a content of the pigment is high. Therefore, when the ink composition for ink jet recording according to the present invention is used to produce a substrate for a color filter, a printed layer having a sufficient concentration can be formed by an inkjet recording process.

### BEST MODE FOR CARRYING OUT THE INVENTION

### (I) Ink Composition without a Thermal Reactive Compound

The ink composition according to the present invention includes, as typical embodiments, an embodiment wherein a thermal reactive compound (D) is not contained, and an embodiment wherein a thermal reactive compound (D) is contained. The embodiment wherein a thermal reactive compound (D) is not contained will be explained first.

### (1) Pigments

Pigment contained in the inkjet ink of the present invention may be an achromatic pigment, such as carbon black, titanium oxide, calcium carbonate, or a chromatic organic pigment. As the organic pigment, there may be mentioned, Toluidine red, Toluidine maroon, Hansa yellow, Benzidine yellow, Pyrazolone red, or other insoluble azo pigments, Lithol Red, Helio Bordeaux, Pigment Scarlet, Permanent Red 2B, or other soluble azo pigments, alizarin, indanthrone, Thioindigo maroon, or other derivatives from vat dyestuffs, Phthalocyanine Blue, Phthalocyanine Green, or other phthalocyanine-based organic pigments, Quinacridone Red, Quinacridone Magenta, or other quinacridone-based organic pigments, Perylene Red, Perylene Scarlet, or other perylene-based organic pigments, Isoindolinone Yellow, Isoindolinone Orange, or other isoindolinone-based organic pigments, Pyranthrone Red, Pyranthrone Orange, or other pyranthrone-based organic pigments, thioindigo-based organic pigment, condensation azo-based organic pigment, benzimidazolone-based organic pigment, Quinophthalone Yellow, or other quinophthalone-based organic pigments, Isoindoline Yellow, or other isoindoline-based organic pigments. Further, as other pigments, there may be mentioned Flavanthrone Yellow, Acylamido Yellow, Nickel Azo Yellow, Copper Azo methane Yellow, Perinone Orange, Anthrone Orange, Dianthraquinolyl Red, Dioxazine Violet or the like.

The organic pigment can be indicated by color index (C.I.) numbers, as follows: C.I. Pigment Yellow 12, 13, 14, 17, 20, 24, 74, 83, 86, 93, 109, 110, 117, 125, 128, 129, 137, 138, 139, 147, 148, 150, 151, 153, 154, 155, 166, 168, 180, 185, C.I. Pigment Orange 16, 36, 43, 51, 55, 59, 61, C.I. Pigment Red 9, 48, 49, 52, 53, 57, 97, 122, 123, 149, 168, 177, 180, 192, 202, 206, 215, 216, 217, 220, 223, 224, 226, 227, 228, 238, 240, C.I. Pigment Violet 19, 23, 29, 30, 37, 40, 50, C.I. Pigment Blue 15, 15:1, 15:3, 15:4, 15:6, 22, 60, 64, C.I. Pigment Green 7, 36, C.I. Pigment Brown 23, 25, 26.

Of the above pigments, quinacridone-based organic pigment, phthalocyanine-based organic pigment, benzimidazolone-based organic pigment, isoindolinone-based organic pigment, condensed azo-based organic pigment, quinophthalone-based organic pigment, isoindoline-based organic pigment are preferable, due to an excellent light resistance. It is preferable that the organic pigment is a fine pigment having an average particle size of 10 to 300 nm as a value measured by a laser scatter. When the average particle size of the pigment is less than 10 nm, a light resistance is reduced due to the decrease of the particle size. When the average particle size is more than 300 nm, stability in dispersion is difficult to maintain, and thus the pigment is readily precipitated.

The organic pigment can be miniaturized by the following methods. Specifically, a mixture of at least three components, that is, an organic pigment, a water-soluble inorganic salt at an amount of at least three times weight of the organic pigment, and a water-soluble solvent is converted to a clay mixture, which is then intensively kneaded by a kneader or the like to be finely pulverized. The product is incorporated into water and stirred by a high-speed mixer or the like to obtain slurry. Thereafter, a filtration and washing with water are repeated to remove the water-soluble inorganic salt and the water-soluble solvent. In the pulverizing step, a resin or a pigment derivative may be added. As the water-soluble inorganic salt, sodium chloride, potassium chloride or the like may be used. The inorganic salt is used in an amount of at least three times weight, preferably not more than 20 times weight of the organic pigment. When the amount of the inorganic salt is less than three times weight of the organic pigment, a treated pigment having a desired size cannot be obtained. When the amount of the inorganic salt is more than 20 times weight of the organic pigment, the subsequent washing treatment becomes tremendous, and the amount of the organic pigment treated is substantially reduced.

The water-soluble solvent is used to form the clay state of the pigment and the water-soluble inorganic salt which is used as a pulverizing auxiliary agent, and to effectively carry out a sufficient pulverization. The water-soluble solvent is not particularly limited, but is preferably a solvent having a high boiling point of 120 to 250° C. This is because a solvent is liable to evaporate during the kneading step to raise the temperature. The water-soluble solvent may be, for example, 2-(methoxymethoxy)ethanol, 2-butoxyethanol, 2-(isopentyloxy)ethanol, 2-(hexyloxy)ethanol, diethyleneglycol, diethyleneglycol monomethyl ether, diethyleneglycol monoethyl ether, diethyleneglycol monobutyl ether, triethyleneglycol, triethyleneglycol monomethyl ether, liquid polyethyleneglycol, 1-methoxy-2-propanol, 1-ethoxy-2-propanol, dipropyleneglycol, dipropyleneglycol monomethyl ether, dipropyleneglycol monoethyl ether, low molecular weight polypropyleneglycol, or the like.

In the present invention, the pigment is contained, preferably, in an amount of 0.5 to 10% by weight in the inkjet ink to obtain a sufficient concentration and light resistance.

A surface electrical charge of the pigment is not limited in the present invention may have, so long as the pigment can be dispersed, but a basic surface electrical charge is preferable. When the pigment has a basic surface, the carboxyl groups on the dispersant pigment can strongly adsorb to the pigment surface whereby an inkjet ink having a low viscosity and stability in printing can be obtained. The pigment having a basic surface can be used without a treatment, whereas a pigment having an acidic or neutral surface is preferably used after the surface is rendered to basic by a conventional method.

### (2) Pigment Derivatives

In addition to the method wherein the pigment is treated to basic, a basic pigment derivative can be used together with a pigment. A preferable pigment derivative is a compound of the general formula (1):

P—[X—Y-Z-N(R⁴)R⁵]v (1)

wherein P is an organic colorant residue of heterocyclic residue, X is a divalent coupling group selected from the group consisting of —SO₂—, —CO₂—, —CH₂—, —CH₂S—, —CH₂O—, —O—, —COO—, —NH— and —CH₂NHCOCH—, Y is a direct bond, —O—, or —N(R)—, wherein R is H, an alkyl group having 1 to 18 carbon atoms, or Z-N(R⁴)R⁵, Z is an alkylene group having 1 to 6 carbon atoms, R⁴ and R⁵ is independently an optionally substituted alkyl group having 1 to 18 carbon atoms, or R⁴ and R⁵ together can form a substituted or unsubstituted ring which may further contain N, O or S, v is an integer of 1 to 3.

The organic colorant residue P is, for example, phthalocyanine-based, insoluble azo-based, azolake-based, anthraquinone-based, quinacridone-based, dioxazine-based, diketopyrrolopyrrole-based, anthrapyrimidine-based, anthanthrone-based, indanthrone-based, flavanthrone-based, perinone-based, perylene-based, thioindigo-based colorant residue or the like. The heterocyclic residue P is, for example, thiophene, furan, xanthene, pyrrole, imidazole, isoindoline, isoindolinone, benzimidazolone, indole, quinoline, carbazole, acridine, acridone, anthraquinone, or the like. The pigment derivative of the general formula (1) wherein P is a heterocyclic residue is hardly colored, and is preferable in general versatility.

In the general formula (1), X may be —SO₂—, —CO₂—, —CH₂—, —CH₂S—, —CH₂O—, —O—, —COO—, —NH— or —CH₂NHCOCH—, or a combination thereof, but is preferably SO₂—, —CO₂—, —CH₂—. When R⁴ or R⁵ is an alkyl group, a lower alkyl group, such as a methyl group, an ethyl group, a propyl group, a butyl group is preferable. The alkyl group may be branched or substituted so long as it has not more than 18 carbon atoms. R⁴ and R⁵ together can form a heterocyclic ring which further contains N, O or S.

It is not necessary that a molecular skeleton of the organic pigment conforms to that of the residue P in a pigment derivative, but it is preferable to combine the members having similar skeletons in view of the shades. Particularly, a combination of a blue pigment and a phthalocyanine-based residue; a red pigment and a quinacridone-based residue; or a yellow pigment and a benzimidazole-based residue is preferable. Examples of the pigment derivative are listed as follows:

TABLE 1

| Organic colorant residue | Substituent |
|---|---|
| a:C.I. Pigment Blue 15 | —SO₂NH(CH₂)₂N(C₂H₅)₂ |
| b:C.I. Pigment Yellow 24 | —SO₂NH(CH₂)₂N(C₃H₇)₂ |
| c:C.I. Pigment Violet 19 | —SO₂NH(CH₂)₃N(C₄H₉)₂ |
| d:C.I. Pigment Blue 15 | —CH₂S—CH₂N(C₃H₇)₂ |
| e:C.I. Pigment Yellow 83 | —SO₂NH(CH₂)₃N(C₂H₅)₂ |
| f:C.I. Pigment Yellow 108 | —CH₂O—CH₂N(C₂H₅)₂ |
| g:C.I. Pigment Violet 19 | —CH₂S—CH₂N(C₄H₉)₂ |

It is preferable to contain 0.01 to 5 wt % of the pigment derivative in the ink of the present invention. The pigment derivative can be added during the pulverizing step as mentioned above.

In the present invention, the pigment derivative may be used in the form of powder during a dispersing step of the pigment, or mixed with the pigment in advance. When the pigment derivative dissolved or dispersed in a solvent or an aqueous inorganic acid solution is used, the solution or dispersion may be added to slurry of the pigment in water or solvent so that the pigment derivative adsorbs to the surface of the pigment. Alternatively, the pigment derivative may be used in the form of a pigment composition prepared by adding the pigment derivative in the form of a powdery material or a solution or a dispersion, during a coupling step in case of an azo pigment, or a pigment-forming step, such as a salt milling method or a sulfuric acid dissolving method, in case of a phthalocyanine pigment, quinacridone pigment or a dioxazine pigment and so on, so that the pigment derivative adsorbs to the pigment surface, and filtering the product, and if necessary drying.

### (3) Urethane Resin Dispersants

One of most important characteristic features of the present invention is that the inkjet ink contains the urethane resin dispersant with an acidic functional group. The urethane resin dispersant used in the present invention includes a hydroxyl-type urethane resin dispersant and an acid anhydride-type urethane resin dispersant, as a typical embodiment. When it is not necessary to distinguish these two dispersants, it will be hereinafter referred to simply as the urethane resin dispersant, whereas when it is necessary to distinguish these two dispersants, it will be hereinafter referred to as the hydroxyl-type urethane resin dispersant or the acid anhydride-type urethane resin dispersant.

### (i) Polyisocyanate (a)

In the first place, the polyisocyanate (a) having three or more isocyanate groups which is a starting material of the branched urethane resin dispersant used in the present invention will be described hereinafter.

The polyisocyanate (a) is not limited, so long as it has three or more isocyanate groups in its molecule. The examples are an aromatic polyisocyanate, an aliphatic polyisocyanate, an aromatic aliphatic polyisocyanate, an aliphatic cyclic polyisocyanate, or the like.

The polyisocyanate (a) is preferably a trimethylol propane adduct of the diisocyanate as mentioned below, a burette of the diisocyanate as mentioned below reacted with water, or a trimer of the diisocyanate as mentioned below with an isocyanurate ring.

Examples of the diisocyanate are an aromatic diisocyanate, an aliphatic diisocyanate, an aromatic aliphatic diisocyanate, an aliphatic cyclic diisocyanate or the like.

Examples of the aromatic diisocyanate are 1,3-phenylene diisocyanate, 4,4′-diphenyl diisocyanate, 1,4-phenylene diisocyanate, 4,4′-diphenylmethane diisocyanate, 2,4-tolylene diisocyanate, 2,6-tolylene diisocyanate, 4,4′-toluidine diisocyanate, 2,4,6-triisocyanatetoluene, 1,3,5-triisocyanatebenzene, dianisidinediisocyanate, 4,4′-diphenyl ether diisocyanate, 4,4′,4″-triphenylmethane triisocyanate, or the like.

Examples of the aliphatic diisocyanate are trimethylene diisocyanate, tetramethylene diisocyanate, hexamethylene diisocyanate, pentamethylene diisocyanate, 1,2-propylene diisocyanate, 2,3-butylene diisocyanate, 1,3-butylene diisocyanate, dodecamethylene diisocyanate, 2,4,4-trimethylhexamethylene diisocyanate, or the like.

Examples of the aromatic aliphatic diisocyanate are ω,ω′-diisocyanate-1,3-dimethylbenzene, ω,ω′-diisocyanate-1,4-dimethylbenzene, ω,ω′-diisocyanate-1,4-dimethylbenzene, 1,4-tetramethylxylylene diisocyanate, 1,3-tetramethylxylylene diisocyanate, or the like.

Examples of the aliphatic cyclic diisocyanate are 3-isocyanatemethyl-3,5,5-trimethylcyclohexylisocyanate (isophorone diisocyanate), 1,3-cyclopentane diisocyanate, 1,3-cyclohexane diisocyanate, 1,4-cyclohexane diisocyanate, methyl-2,4-cyclohexane diisocyanate, methyl-2,6-cyclohexane diisocyanate, 4,4′-methylenebis(cyclohexylisocyanate), 1,3-bis(isocyanatemethyl)cyclohexane, 1,4-bis(isocyanatemethyl)cyclohexane, or the like.

Of the above diisocyanates, an aliphatic polyisocyanate, an aromatic aliphatic polyisocyanate, or an aliphatic cyclic polyisocyanate is preferable, an aliphatic cyclic polyisocyanate is more preferable, and a trimer of the isophoronediisocyanate is particularly preferable, in view of a viscosity after dispersion of the pigment.

One of the characteristic features of the present invention resides in that a rate of the polyisocyanate (a) in nonvolatile components in the branched urethane resin dispersant is 25% to 60% by weight. When the rate is less than 25 wt %, a sufficient adsorbability of the pigment is not obtained and thus, the pigment dispersibility becomes poor. When the rate is more than 60 wt %, the pigment adsorbability becomes too high to obtain a sufficient steric repulsion effect, and thus, the pigment dispersibility is rather lowered.

### (ii) Monoalcohol Compound (b)

Then, the monoalcohol compound (b) which is a starting material of the branched urethane resin dispersant in the present invention will be explained.

The monoalcohol compound (b) is not limited, so long as it has one hydroxyl group in the molecule, and for example, an aliphatic monoalcohol, an aromatic aliphatic monoalcohol, an aliphatic cyclic monoalcohol, or the like.

Examples of the aliphatic monoalcohol which may be used in the present invention are methanol, ethanol, propanol, isopropanol, butanol, n-amyl alcohol, hexanol, heptanol, n-octanol, 2-ethylhexanol, isooctanol, nonanol, decanol, isoundecanol, lauryl alcohol, cetyl alcohol, stearyl alcohol, or other liner or branched aliphatic alcohols. Examples of the aromatic aliphatic monoalcohol are benzyl alcohol, α-methylbenzyl alcohol, phenethyl alcohol, or the like. Examples of the aliphatic cyclic monoalcohol are cyclopentanol, cyclohexanol, cyclohexanemethanol, cycloheptanol, cyclooctanol, tricyclodecanemethanol, or the like.

Preferably, the monoalcohol compound (b) which may be used in the present invention is (b1) a lactone resin having a hydroxyl group, (b2) an oxyalkylene resin having a hydroxyl group, (b3) an acrylic resin having a hydroxyl group, and (b4) a siloxane resin having a hydroxyl group.

The lactone resin (b1) having a hydroxyl group is preferably (i) a homopolymer prepared by polymerizing a monoalcohol (b5) with at least one monomer selected from ε-caprolactone, 4-methylcaprolactone, 3,5,5-trimethylcaprolactone, 3,3,5-trimethylcaprolactone, β-propiolactone, γ-butyrolactone, δ-valerolactone, and enantholactone, (ii) a copolymer prepared by copolymerizing at least two or more monomers selected from the above compounds with the monoalcohol (b5), or (iii) a mixture of two or more polymers selected from the above homopolymers (i) and the above copolymers (ii).

The monoalcohol (b5) is not limited, so long as it becomes a terminal group of the lactone resin (b1), serves as an initiator, and contains a hydroxyl group in the molecule. Examples of the monoalcohol (b5) are an aliphatic monoalcohol, an aromatic aliphatic monoalcohol, an aliphatic cyclic monoalcohol, or the like.

Examples of the aliphatic monoalcohol are methanol, ethanol, propanol, isopropanol, butanol, n-amyl alcohol, hexanol, heptanol, n-octanol, 2-ethylhexanol, isooctanol, nonanol, decanol, isoundecanol, lauryl alcohol, cetyl alcohol, stearyl alcohol, or other linear or branched aliphatic alcohols. Examples of the aromatic aliphatic monoalcohol are benzyl alcohol, α-methylbenzyl alcohol, phenethyl alcohol. Examples of the aliphatic cyclic monoalcohol are cyclopentanol, cyclohexanol, cyclohexanemethanol, cycloheptanol, cyclooctanol, tricyclodecanemethanol.

The monoalcohol (b5) may be (b2) an oxyalkylene resin having a hydroxyl group, (b3) an acrylic resin having a hydroxyl group, and (b4) a siloxane resin having a hydroxyl group.

The oxyalkylene resin (b2) having a hydroxyl group is not limited, so long as it contains a hydroxyl group in the molecule and a segment having two or more repeating units of the general formula (2).

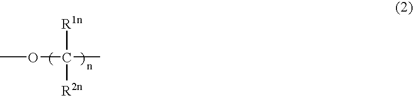

In the formula (2), n is an integer of 1 or more, R¹ⁿ and R²ⁿ are the n-th substituents, and a combination of 1 or more substituents selected from the group consisting of hydrogen, alkyl group, aryl group, alkenyl group, hydroxyl group, carboxyl group, epoxy group, amino group, amido group, ether group, and ester group.

The acrylic resin (b3) having a hydroxyl group is not limited, so long as it contains a hydroxyl group in the molecule. The acrylic resin (b3) having a hydroxyl group is, for example, a product prepared by polymerizing ethylenic unsaturated monomers with a compound having one or more thiol groups and a hydroxyl group as a polymerization initiator, or an acrylic resin prepared by a living polymerization method and having a hydroxyl group incorporated into the molecule. As the ethylenic unsaturated monomer, a compound having a unsaturated double bond which can be free-radical polymerized. A commercially available acrylic resin (b3) is, for example, UMM-1001, UME-1001, UMB-1001, each manufactured by Soken Chemical & Engineering Co., Ltd.

The ethylenic unsaturated monomer may be (meta)acrylic ester having 1 to 18 carbon atoms in the alkyl moiety, and for example, methyl(meta)acrylate, ethyl(meta)acrylate, n-propyl(meta)acrylate, isopropyl(meta)acrylate, n-butyl(meta)acrylate, isobutyl(meta)acrylate, n-hexyl(meta)acrylate, 2-ethylhexyl(meta)acrylate, benzyl(meta)acrylate, cyclohexyl(meta)acrylate, isooctyl(meta)acrylate, n-octyl(meta)acrylate, nonyl(meta)acrylate, isononyl(meta)acrylate, decyl(meta)acrylate, isodecyl(meta)acrylate, dodecyl(meta)acrylate, isododecyl(meta)acrylate, tridecyl(meta)acrylate, isotridecyl(meta)acrylate.

The carboxyl-group-containing ethylenic unsaturated monomer is, for example, acrylic acid, methacrylic acid, acrylic acid dimer, crotonic acid, itaconic acid, maleic acid, or the like. The amido-group-containing monomer is, for example, (meta)acrylamide, N-alkyl(meta)acrylamide, N,N-dialkyl(meta)acrylamide.

Further, an ethylenic unsaturated monomer having a cross-linkable group may be used. The cross-linkable group is, for example, epoxy group, alkoxysilyl group, acetoacetyl group, or the like.

The epoxy-group-containing monomer is, for example, glycidyl(meta)acrylate, allylglycidyl ether, or the like.

The alkoxysilyl-group-containing monomer is, for example, γ-(meta)acryloxy ethyl trimethoxysilane, γ-(meta)acryloxy ethyl triethoxysilane, γ-(meta)acryloxypropyl trimethoxysilane, γ-(meta)acryloxypropyl triethoxysilane, γ-(meta)acryloxypropylmethyl dimethoxysilane, γ-(meta)acryloxypropyldimethyl methoxysilane, γ-(meta)acryloxypropylmethyl diethoxysilane, γ-(meta)acryloxypropyldimethyl ethoxysilane, γ-(meta)acryloxypropyl trichlorosilane, γ-(meta)acryloxypropylmethyl dichlorosilane, γ-(meta)acryloxypropyldimethyl chlorosilane, γ-(meta)acryloxypropyl tripropioxysilane, γ-(meta)acryloxypropylmethyl dipropioxysilane, γ-(meta)acryloxypropyl tributoxysilane, γ-(meta)acryloxybutyl trimethoxysilane, γ-(meta)acryloxypentyl trimethoxysilane, γ-(meta)acryloxyhexyl trimethoxysilane, γ-(meta)acryloxyhexyl triethoxysilane, γ-(meta)acryloxyoctyl trimethoxysilane, γ-(meta)acryloxydecyl trimethoxysilane, γ-(meta)acryloxydodecyl trimethoxysilane, γ-(meta)acryloxyoctadecyl trimethoxysilane, vinyl trimethoxysilane, vinyl triethoxysilane, vinyl tripropoxy silane, vinylmethyl dimethoxysilane, vinylmethyl diethoxysilane, vinylmethyl dipropoxysilane, or the like.

The acetoacetyl-group-containing monomer is, for example, diacetone(meta)acrylamide, 2-(acetoacetoxy)ethyl (meta)acrylate, allylace to acetate, or the like.

The ethylenic unsaturated monomers as mentioned above may be used in combination thereof, and the kind or the ratio thereof is not limited, but may be selected in view of the purposes.

In the present invention, the acrylic resin (b3) is preferably a product prepared by polymerizing monomers containing 20 wt % to 70 wt % of benzyl(meta)acrylate. When the monomer contains less than 20 wt % of benzyl (meta)acrylate, the pigment adsorbability is insufficient and the pigment dispersibility may be lowered. When the monomer contains more than 70 wt % of benzyl(meta)acrylate, the pigment adsorbability becomes too high to obtain a sufficient steric repulsion effect, and thus, the pigment dispersibility is rather lowered.

The siloxane resin (b4) having a hydroxyl group is not limited, so long as it is a siloxane resin containing a hydroxyl group in the molecule. A commercially available resin is, for example, FM-0411, FM-0421, FM-0425, each manufactured by Chisso Corporation.

(iii) Compound (c)

Then, the compound (c) having one or more acidic groups, particularly carboxylic groups, and two or more hydroxyl groups, which is used to prepare the hydroxyl-type urethane resin dispersant used in the present invention will be described hereinafter. The compound (c) is used so that the acidic groups, particularly carboxylic groups can be introduced into the branched urethane resin dispersant used in the present invention.

The compound (c) having one or more acidic groups and two or more hydroxyl groups is not limited, and for example, 2,2-bis(hydroxymethyl)butyric acid [dimethylol butanoic acid], 2,2-bis(hydroxymethyl)propionic acid [dimethylol propionic acid], 2,2-bis(hydroxyethyl)propionic acid, 2,2-bis(hydroxypropyl)propionic acid, tartaric acid, dihydroxymethyl acetic acid, bis(4-hydroxyphenyl)acetic acid, 4,4-bis(p-hydroxyphenyl)pentanoic acid, 2,4-dihydroxybenzoic acid, 3,5-dihydroxybenzoic acid, homogentisic acid. It is preferable to use 2,2-bis(hydroxymethyl)butyric acid [dimethylol butanoic acid], 2,2-bis(hydroxymethyl)propionic acid [dimethylol propionic acid], 2,2-bis(hydroxyethyl)propionic acid, 2,2-bis(hydroxypropyl)propionic acid. Of these compounds, dimethylol butanoic acid, or dimethylol propionic acid is preferable.

The acidic-group-containing polyol prepared by an organic synthesis may be used. The acidic-group-containing polyol is prepared by, for example, reacting an acid anhydride and a polyfunctional alcohol.

The acid anhydride may be a compound having an acid anhydride group in the molecule, or a compound having two or more acid anhydride groups in the molecule, and may be used alone or in combination.

The compound having an acid anhydride group in the molecule is, for example, succinic anhydride, itaconic anhydride, maleic anhydride, glutaric anhydride, hexahydro phthalic anhydride, tetrahydro phthalic anhydride, or other aliphatic cyclic anhydrides, phthalic anhydride, isatoic anhydride, diphenic anhydride, or other aromatic cyclic anhydrides, or a derivative prepared by binding a saturated or unsaturated aliphatic hydrocarbon hydrocarbon radical, aryl group, halogen group, heterocyclic group thereto.

The having two or more acid anhydride groups in the molecule is, for example, tetracarboxylic dianhydride, hexacarboxylic trianhydride, hexacarboxylic dianhydride, maleic anhydride copolymer resin, or other polycarboxylic acid anhydrides. More particularly, tetracarboxylic dianhydride is, for example, aliphatic tetracarboxylic anhydride, aromatic tetracarboxylic anhydride, or polycyclic tetracarboxylic anhydride.

Examples of the aliphatic tetracarboxylic anhydride are 1,2,3,4-butanetetracarboxylic anhydride, 1,2,3,4-cyclobutanetetracarboxylic anhydride, 1,3-dimethyl-1,2,3,4-cyclobutanetetracarboxylic anhydride, 1,2,3,4-cyclopentanetetracarboxylic anhydride, 2,3,5-tricarboxycyclopentylacetic anhydride, 3,5,6-tricarboxynorbornane-2-acetic anhydride, 2,3,4,5-tetrahydrofurantetracarboxylic anhydride, 5-(2,5-dioxotetrahydrofural)-3-methyl-3-cyclohexene-1,2-dicarboxylic anhydride, bicyclo[2.2.2]-octo-7-ene-2,3,5,6-tetracarboxylic anhydride, or the like.

The aromatic tetracarboxylic anhydride is, for example, pyromellitic anhydride, ethyleneglycol trimellitic dianhydride ester, propyleneglycol trimellitic dianhydride ester, butyleneglycol trimellitic dianhydride ester, 3,3′,4,4′-benzophenonetetracarboxylic anhydride, 3,3′,4,4′-biphenylsulfonetetracarboxylic anhydride, 1,4,5,8-naphthalenetetracarboxylic anhydride, 2,3,6,7-naphthalenetetracarboxylic anhydride, 3,3′,4,4′-biphenylethertetracarboxylic anhydride, 3,3′,4,4′-dimethyldiphenylsilanetetracarboxylic anhydride, 3,3′,4,4′-tetraphenylsilanetetracarboxylic anhydride, 1,2,3,4-furantetracarboxylic anhydride, 4,4′-bis(3,4-dicarboxyphenoxy)diphenylsulfide anhydride, 4,4′-bis(3,4-dicarboxyphenoxy)diphenylsulfonic anhydride, 4,4′-bis(3,4-dicarboxyphenoxy)diphenyl propanoic anhydride, 3,3′,4,4′-perfluoroisopropylidenediphthalic anhydride, 3,3′,4,4′-biphenyltetracarboxylic anhydride, bis(phthalic acid)phenylphosphineoxide anhydride, p-phenylene-bis(triphenylphthalic acid)anhydride, M-phenylene-bis(triphenylphthalic acid)anhydride, bis(triphenylphthalic acid)-4,4′-diphenylether anhydride, bis(triphenylphthalic acid)-4,4′-diphenylmethane anhydride, 9,9-bis(3,4-dicarboxyphenyl) fluoric anhydride, 9,9-bis[4-(3,4-dicarboxyphenoxy)phenyl] fluoric anhydride.

The polycyclic tetracarboxylic anhydride is, for example, 3,4-dicarboxy-1,2,3,4-tetrahydro-1-naphthalenesuccinic anhydride, 3,4-dicarboxy-1,2,3,4-tetrahydro-6-methyl-1-naphthalenesuccinic anhydride, or the like.

The polyfunctional alcohol is, for example, ethyleneglycol, diethyleneglycol, triethyleneglycol, tetraethyleneglycol, trimethyleneglycol, propyleneglycol, butanediol, pentanediol, neopentylglycol, hexamethyleneglycol, dodecamethyleneglycol, or other aliphatic glycols, cyclohexanedimethanol, or other aliphatic cyclic glycols, 1,3-bis(2-hydroxyethoxy)benzene, 1,2-bis(2-hydroxyethoxy)benzene, 1,4-bis(2-hydroxyethoxy)benzene, or other aromatic-group-containing glycols, bisphenols, hydroquinone, 2,2-bis(4-β-hydroxyethoxyphenyl)propane, or other aromatic diols.

Further, the polyfunctional alcohol may contain a unit derived from a polyfunctional alcohol having three or more hydroxyl groups. For example, glycerine, 1,1,1-trimethylolethane, 1,1,1-trimethylolpropane, 1,1,1-trimethylolmethane, pentaerythritol or the like may be used. Two or more polyfunctional alcohols as above may be used in a combination thereof.

In the present invention, the compound (c) having one or more acidic groups and two or more hydroxyl groups may be used alone or in a combination thereof.

### (iv) Acrylic Resin (d)

The acrylic resin having two or more hydroxyl groups via 1 to 30 atoms which is a starting material of the branched urethane resin dispersant used in the present invention will be described hereinafter.

The acrylic resin (d) having two or more hydroxyl groups via 1 to 30 atoms is not limited, so long as it is an acrylic resin containing two or more hydroxyl groups via 1 to 30 atoms. The acrylic resin (d) is, for example, a product prepared by polymerizing ethylenic unsaturated monomers with a compound having one or more thiol groups and two or more hydroxyl groups via 1 to 30 carbon atoms as a polymerization initiator, or an acrylic resin prepared by a living polymerization method and having two hydroxyl groups incorporated into the molecule. As the ethylenic unsaturated monomer, a compound having a unsaturated double bond which can be free-radical polymerized. A commercially available acrylic resin (d) is, for example, UT-1001 manufacture by Soken Chemical & Engineering Co., Ltd.

AS the ethylenic unsaturated monomer, the monomers as explained regarding the acrylic resin (b3) may be used alone or in combination thereof, and the kind or the ratio thereof is not limited, but may be selected in view of the purposes.

### (v) Siloxane Resin (e)

Then, the siloxane resin (d) having two or more hydroxyl groups via 1 to 30 atoms which is used to prepare the branched urethane resin dispersant used in the present invention will be described hereinafter.

The siloxane resin (d) having two or more hydroxyl groups via 1 to 30 atoms is not limited, so long as it is a siloxane resin containing two or more hydroxyl groups via 1 to 30 atoms. A commercially available siloxane resin (d) is, for example, FM-DA11, FM-DA21, FM-DA26 (Chisso Corporation).

One of characteristic features in one embodiment of the present invention resides in that the acrylic resin (d) and/or the siloxane resin (e), each having two or more hydroxyl groups via 1 to 30 atoms, is used.

When the number of the carbon atoms between two hydroxyl groups is more than 30, a large amount of the acrylic resin (d) and the siloxane resin (e), each contributing to dispersing stability, is incorporated into a main chain of the urethane resin, and thus, a sufficient steric repulsion effect is not obtained and pigment dispersibility is lowered. However, if at least one resin selected from the group consisting of (b1) a lactone resin having one hydroxyl group, (b2) an oxyalkylene resin having one hydroxyl group, (b3) an acrylic resin having one hydroxyl group, and (b4) a siloxane resin having one hydroxyl group is used, the above disadvantageous phenomenon does not occur, and thus, it is not necessary to use the acrylic resin (d) and/or the siloxane resin (e) in this case.

### (vi) Polyol (f)

The compound (c) having one or more acidic groups and two or more hydroxyl groups, the acrylic resin (d) having two or more hydroxyl groups via 1 to 30 atoms, and/or the siloxane resin (e) having two or more hydroxyl groups via 1 to 30 atoms are used in the reaction with the reaction product of the polyisocyanate compound (a) having three or more isocyanate groups and the monoalcohol (b). During the above reaction, the polyol (f) as mentioned below may be used in combination thereof.

The polyol (f) is, for example, ethyleneglycol, diethyleneglycol, triethyleneglycol, tetraethyleneglycol, polyethyleneglycol, propyleneglycol, dipropyleneglycol, polypropyleneglycol, butyleneglycol, 1,3-butanediol, 1,4-butanediol, polybutyleneglycol, 3-methyl-1,5-pentanediol, 1,6-hexanediol, neopentylglycol, 1,9-nonanediol, cyclohexanedimethanol, hydrogenated bisphenol A, polycaprolactonediol, trimethylolethane, polytrimethylolethane, trimethylolpropane, polytrimethylolpropane, pentaerythritol, polypentaerythritol, sorbitol, mannitol, arabitol, xylitol, galactitol, glycerine, polyglycerol, polytetramethylene glycol, or other polyhydric alcohols;

2,2-bis(hydroxymethyl)butyric acid [dimethylolbutanoic acid], 2,2-bis(hydroxymethyl)propionic acid [dimethylolpropionic acid], 2,2-bis(hydroxyethyl)propionic acid, 2,2-bis(hydroxypropyl)propionic acid, tartaric acid, dihydroxymethylacetic acid, bis(4-hydroxyphenyl)acetic acid, 4,4-bis(p-hydroxyphenyl)pentanoic acid, 2,4-dihydroxybenzoic acid, 3,5-dihydroxybenzoic acid, homogentisic acid, or other acidic-group-containing low molecular polyhydric alcohols;
block copolymer or random copolymer of polyethylene oxide, polypropylene oxide, ethylene oxide/propylene oxide, or other polyether polyols;
polyester polyols which is a condensed product of the above polyhydric alcohol or polyether polyol, and polybasic acid, such as maleic anhydride, maleic acid, fumaric acid, itaconic anhydride, itaconic acid, adipic acid, or isophthalic acid;
polyols, such as caprolactone modified polytetramethylenepolyol, or other caprolactone modified polyols, polyolefin-based polyol, hydrogenated polybutadiene polyol, or other polyacetylene compound-based polyols. Further, a compound having two or more functional groups which is reactive with the isocyanate group, for example, a polyamine having at least two primary or secondary amino groups can be used in combination thereof.
(vii) Other Components

In the present invention, the (meta)acrylate (b6) having a hydroxyl group may be used as the monoalcohol (b). The (meta)acrylate (b6) may be used with the monoalcohols (b1) to (b4) mentioned as the monoalcohol (b). The branched urethane resin dispersant into which an ethylenic unsaturated group is incorporated may be prepared by using the (meta)acrylate (b6) having a hydroxyl group.

The (meta)acrylate (b6) having a hydroxyl group is not limited, so long as it is a (meta)acrylate compound which contains a hydroxyl group in the molecule, and is, for example, pentaerythritol tri(meta)acrylate, dipentaerythritol penta(meta)acrylate, 2-hydroxyethyl (meta)acrylate, 2-hydroxypropyl(meta)acrylate, 2-hydroxybutyl(meta)acrylate, 2-hydroxyethylacryloyl phosphate, 4-hydroxybutyl(meta)acrylate, 2-(meta) acryloyloxyethyl-2-hydroxypropyl phthalate, glycerol di(meta)acrylate, 2-hydroxy-3-acryloyloxypropyl(meta)acrylate, caprolactone-modified 2-hydroxyethyl(meta)acrylate, cyclohexanedimethanol mono(meta)acrylate, or the like. Of these compounds, pentaerythritol tri(meta)acrylate, or dipentaerythritol penta(meta)acrylate is preferable.

In the present invention, a monoalcohol (b7) having a thermosetting site may be used as the monoalcohol (b). The monoalcohol (b7) having a thermosetting site can be used together with each of the monoalcohols (b1) to (b4) or (b6) which are mentioned as the monoalcohol (b). The branched urethane resin dispersant containing a thermosetting site incorporated can be obtained by using the monoalcohol (b7) having a thermosetting site.

The monoalcohol (b7) having a thermosetting site is not limited, so long as it is a compound having one or more thermosetting sites and a hydroxyl group. The thermosetting site is, for example, a cyclic ether group such as epoxy group or oxetane group, a functional group which can be used in a Michael addition reaction, such as cyclocarbonate group, blocked isocyanate group, benzoxazine group, acid anhydride group, or α,β-unsaturated carbonyl group, an acetylene compound which can be converted into a cyclic trimer, a functional group which can be used in a Diels-Alder reaction, such as 1,3-butadiene or ethylene, or an alkoxysilyl group, amino group or methylol group contained in a melamine compound. Of these groups, oxetane group or cyclocarbonate group is preferable. Particularly, oxetane alcohol, glycerine cyclocarbonate is preferable.

(viii) Compound (r)

As a compound (r) having acid anhydride groups which is used to prepare the acid anhydride-type urethane resin dispersant used in the present invention, a compound containing an acid anhydride group in the molecule or a compound containing two or more acid anhydride groups in the molecule may be used. These compounds may be used alone or in a combination thereof.

The compound containing an acid anhydride group in the molecule is, for example, succinic anhydride, itaconic anhydride, maleic anhydride, glutaric anhydride, hexahydrophthalic anhydride, tetrahydrophthalic anhydride, or other aliphatic cyclic anhydrides, phthalic anhydride, isatoic anhydride, diphenic anhydride, trimellitic anhydride, or other aromatic cyclic anhydrides, or a derivative prepared by binding, to the above compound, a saturated or unsaturated aliphatic hydrocarbon radical, an aryl group, halogen group, hetrocyclic group.

The compound containing two or more acid anhydride groups in the molecule is, for example, tetracarboxylic dihydride, hexacarboxylic trianhydride, hexacarboxylic dianhydride, maleic anhydride copolymer resin, or other polyvalent carboxylic acid anhydrides. More particularly, tetracarboxylic dianhydride is, for example, aliphatic tetracarboxylic anhydride, aromatic tetracarboxylic anhydride, or polycyclic tetracarboxylic anhydride.

The aliphatic tetracarboxylic anhydride is, for example, 1,2,3,4-butanetetracarboxylic anhydride, 1,2,3,4-cyclobutanetetracarboxylic anhydride, 1,3-dimethyl-1,2,3,4-cyclobutanetetracarboxylic anhydride, 1,2,3,4-cyclopentanetetracarboxylic anhydride, 2,3,5-tricarboxycyclopentylacetic anhydride, 3,5,6-tricarboxynorbornane-2-acetic anhydride, 2,3,4,5-tetrahydrofurantetracarboxylic anhydride, 5-(2,5-dioxotetrahydrofural)-3-methyl-3-cyclohexene 1,2-dicarboxylic anhydride, bicyclo[2.2.2]-octo-7-ene-2,3,5,6-tetracarboxylic anhydride.

The aromatic tetracarboxylic anhydride is, for example, pyromellitic anhydride, ethyleneglycol trimellitic dianhydride ester, propyleneglycol trimellitic dianhydride ester, butyleneglycol trimellitic dianhydride ester, 3,3′,4,4′-benzophenonetetracarboxylic anhydride, 3,3′,4,4′-biphenylsulfonetetracarboxylic anhydride, 1,4,5,8-naphthalenetetracarboxylic anhydride, 2,3,6,7-naphthalenetetracarboxylic anhydride, 3,3′,4,4′-biphenylethertetracarboxylic anhydride, 3,3′,4,4′-dimethyldiphenylsilanetetracarboxylic anhydride, 3,3′,4,4′-tetraphenylsilanetetracarboxylic anhydride, 1,2,3,4-furantetracarboxylic anhydride, 4,4′-bis(3,4-dicarboxyphenoxy)diphenylsulfide anhydride, 4,4′-bis(3,4-dicarboxyphenoxy)diphenylsulfonic anhydride, 4,4′-bis(3,4-dicarboxyphenoxy)diphenylpropanoic anhydride, 3,3′,4,4′-perfluoroisopropylidenediphthalic anhydride, 3,3′,4,4′-biphenyltetracarboxylic anhydride, bis(phthalic acid)phenylphosphineoxide anhydride, p-phenylene-bis(triphenylphthalic acid) anhydride, m-phenylene-bis(triphenylphthalic acid) anhydride, bis(triphenylphthalic acid)-4,4′-diphenylether anhydride, bis(triphenylphthalic)-4,4′-diphenylmethane anhydride, 9,9-bis(3,4-dicarboxyphenyl)fluoric anhydride, 9,9-bis[4-(3,4-dicarboxyphenoxy)phenyl]fluoric anhydride.

The polycyclic tetracarboxylic anhydride is, for example, 3,4-dicarboxy-1,2,3,4-tetrahydro-1-naphthalenesuccinic anhydride, 3,4-dicarboxy-1,2,3,4-tetrahydro-6-methyl-1-naphthalenesuccinic anhydride.

The above compounds may be used in combination thereof, and the kind or the ratio thereof is not limited, but may be selected in view of the purposes. In the present invention, an aromatic acid anhydride is preferable, and trimellitic anhydride, or pyromellitic anhydride is more preferable.

### (ix) Catalysts

Any known catalysts may be used as a catalyst in the preparation of the branched urethane resin dispersant used in the present invention. For example, tertiary amine compound, organic metal compound or the like may be used.

The tertiary amine compound is, for example, triethylamine, triethylenediamine, N,N-dimethylbenzylamine, N-methylmorpholine, 1,8-diazabicyclo-[5.4.0]-7-undecen, 1,5-diazabicyclo-[4.3.0]-5-nonene, or the like.

The organic metal compound may be a tin compound or a non-tin compound. The tin compound is, for example, dibutyl tin dichloride, dibutyl tin oxide, dibutyl tin dibromide, dibutyl tin dimaleate, dibutyl tin dilaurate, dibutyl tin diacetate, dibutyl tin sulfide, tributyl tin sulfide, tributyl tin oxide, tributyl tin acetate, triethyl tin ethoxide, tributyl tin ethoxide, dioctyl tin oxide, tributyl tin chloride, tributyl tin trichloroacetate, tin 2-ethylhexanoate, or the like. The non-tin compound is, for example, dibutyl titanium dichloride, tetrabutyl titanate, butoxy titanium dichloride, or other titanium-based compounds, lead oleate, lead 2-ethylhexanoate, lead benzoate, lead naphthenate, or other lead-based compounds, iron 2-ethylhexanoate, iron acetylacetonato, or other iron-based compounds, cobalt benzoate, 2-ethylhexanoate, or other cobalt-based compounds, zinc naphthenate, zinc 2-ethylhexanoate, or other zinc-based compounds, zirconium naphthenate, or the like. The above compounds may be used alone or in combination thereof.

### (x) Solvents

The branched urethane resin dispersant used in the present invention may be prepared only from the starting materials as mentioned as above. However, in order to avoid a high viscosity or an uneven reaction, it is preferable to use a solvent, particularly, an organic solvent. Any known solvents may be used. For example, acetone, methyl ethyl ketone, methyl isobutyl ketone, cyclohexanone, ethyl acetate, butyl acetate, toluene, xylene, acetonitrile or the like may be used. The reaction temperature to prepare the branched urethane resin dispersant used in the present invention is preferably 40 to 140° C., more preferably 50 to 120° C.

### (xi) Manufacturing Methods

Methods for manufacturing the hydroxyl-type urethane resin dispersant used in the present invention will be described hereinafter.

The first method comprises

reacting (a) the polyisocyanate having three or more isocyanate groups, and (b) the monoalcohol at the molar ratio NCO/OH of 3/2 to 3/0.5 to obtain the terminal-isocyanate-containing compound (p), and then,
polymering, to the resulting isocyanate-containing compound (p),
(c) the compound having one or more acidic groups and two or more hydroxyl groups,
(d) the acrylic resin having two or more hydroxyl groups via 1 to 30 atoms, and/or
(e) the siloxane resin having two or more hydroxyl groups via 1 to 30 atoms
under the condition that the hydroxyl groups are in excess, to thereby obtain the desired product.

The second method comprises

reacting (a) the polyisocyanate having three or more isocyanate groups, and (b) the monoalcohol at the molar ratio NCO/OH of 3/2 to 3/0.5 to obtain the terminal-isocyanate-containing compound (p), and then,
polymering, to the resulting isocyanate-containing compound (p),
(c) the compound having one or more acidic groups and two or more hydroxyl groups,
(d) the acrylic resin having two or more hydroxyl groups via 1 to 30 atoms, and/or
(e) the siloxane resin having two or more hydroxyl groups via 1 to 30 atoms
under the condition that the hydroxyl groups are in excess, and
using, as the monoalcohol (b), at least one resin selected from the group consisting of (b1) a lactone resin having a hydroxyl group, (b2) an oxyalkylene resin having a hydroxyl group, (b3) an acrylic resin having a hydroxyl group, and (b4) a siloxane resin having a hydroxyl group, to thereby obtain the desired product.

The third method comprises

reacting (a) the polyisocyanate having three or more isocyanate groups, and (b) the monoalcohol at the molar ratio NCO/OH of 3/2 to 3/0.5 to obtain the terminal-isocyanate-containing compound (p), and then,
polymering, to the resulting isocyanate-containing compound (p),
(c) the compound having one or more acidic groups and two or more hydroxyl groups,
to thereby obtain the desired product, wherein the monoalcohol (b) must be at least one resin selected from the group consisting of (b) the lactone resin having one hydroxyl group, (c) the oxyalkylene resin having one hydroxyl group, (d) the acrylic resin having one hydroxyl group, and (e) the siloxane resin having one hydroxyl group.

Each of the first step wherein the polyisocyanate (a) is reacted with the monoalcohol (b), and the second step wherein the product of the first step is reacted with the polyol compounds (c) to (e) is a reaction of an isocyanate group and a hydroxyl group. Thus, a known urethanating technique can be used. In the first step, the terminal-isocyanate-containing compound (p) can be obtained by adjusting the molar ratio of the isocyanate (NCO) groups and the hydroxyl (OH) groups. In the second step, the hydroxyl-type branched urethane resin dispersant used in the present invention can be obtained by reacting the resulting terminal-isocyanate-containing compound (p) and the polyol compounds (c) to (e).

If the polyisocyanate (a) having three or more isocyanate groups is reacted with the monoalcohol (b) at the molar ratio NCO/OH of less than 3/2 in the first step of the above manufacturing methods, an amount of the isocyanate groups used in the subsequent reaction is decreased, and thus, the desired hydroxyl-type branched urethane resin dispersant cannot be obtained. If the reaction is carried out at the molar ratio NCO/OH of more than 3/0.5, gelatification may occur in the subsequent reaction, or a resin having a high molecular weight may be produced.

Then, the methods for manufacturing the acid anhydride-type urethane resin dispersant used in the present invention will be described hereinafter.

The first method comprises

reacting (a) the polyisocyanate having three or more isocyanate groups, and (b) the monoalcohol at the molar ratio NCO/OH of 3/2 to 3/0.5 to obtain the terminal-isocyanate-containing compound (p),
polymering, to the resulting isocyanate-containing compound (p),
(d) the acrylic resin having two or more hydroxyl groups via 1 to 30 atoms, and/or
(e) the siloxane resin having two or more hydroxyl groups via 1 to 30 atoms
under the condition that the hydroxyl groups are in excess, to thereby obtain a terminal-hydroxyl-containing compound, and then,
reacting the hydroxyl groups in the resulting terminal-hydroxyl-containing compound and the acid anhydride groups in the compound (r) having acid anhydride groups, to thereby obtain the acid anhydride-type branched urethane resin dispersant.

The second method comprises

reacting (a) the polyisocyanate having three or more isocyanate groups, and (b) the monoalcohol at the molar ratio NCO/OH of 3/2 to 3/0.5 to obtain the terminal-isocyanate-containing compound (p),
polymering, to the resulting isocyanate-containing compound (p),
(d) the acrylic resin having two or more hydroxyl groups via 1 to 30 atoms, and/or
(e) the siloxane resin having two or more hydroxyl groups via 1 to 30 atoms
under the condition that the hydroxyl groups are in excess, wherein, as the monoalcohol (b), at least one resin selected from the group consisting of (b1) a lactone resin having a hydroxyl group, (b2) an oxyalkylene resin having a hydroxyl group, (b3) an acrylic resin having a hydroxyl group, and (b4) a siloxane resin having a hydroxyl group is used, to thereby obtain a terminal-hydroxyl-containing compound, and then,
reacting the hydroxyl groups in the resulting terminal-hydroxyl-containing compound and the acid anhydride groups in the compound (r) having acid anhydride groups, to thereby obtain the acid anhydride-type branched urethane resin dispersant.

The third method comprises

reacting (a) the polyisocyanate having three or more isocyanate groups, and (b) the monoalcohol at the molar ratio NCO/OH of 3/2 to 3/0.5 to obtain the terminal-isocyanate-containing compound (p),
polymering the polyol (f) to the resulting isocyanate-containing compound (p), under the condition that the hydroxyl groups are in excess, and then,
reacting the hydroxyl groups in the resulting terminal-hydroxyl-containing compound and the acid anhydride groups in the compound (r) having acid anhydride groups, to thereby obtain the acid anhydride-type branched urethane resin dispersant, wherein the monoalcohol (b) must be at least one resin selected from the group consisting of (b1) a lactone resin having a hydroxyl group, (b2) an oxyalkylene resin having a hydroxyl group, (b3) an acrylic resin having a hydroxyl group, and (b4) a siloxane resin having a hydroxyl group.

Each of the first step wherein the polyisocyanate (a) is reacted with the monoalcohol (b), and the second step wherein the product of the first step is reacted with the polyol compounds (d), (e), (f) is a reaction of an isocyanate group and a hydroxyl group. Thus, a known urethanating technique can be used. In the first step, the terminal-isocyanate-containing compound can be obtained by adjusting the molar ratio of the isocyanate (NCO) group and the hydroxyl (OH) group. In the second step, the terminal-hydroxyl-containing compound can be obtained by reacting the resulting terminal-isocyanate-containing compound and the polyol compounds (d), (e), (f). The third step is a reaction between a hydroxyl group and an acid anhydride group. Thus, a known esterification technique can be used. The acid anhydride-type branched urethane resin dispersant used in the present invention can be obtained by adjusting the molar ratio of the hydroxyl groups and the acid anhydride groups.

If the polyisocyanate (a) having three or more isocyanate groups is reacted with the monoalcohol (b) at the molar ratio NCO/OH of less than 3/2 in the first step of the above manufacturing methods, an amount of the isocyanate groups used in the subsequent reaction is decreased, and thus, the desired acid anhydride-type branched urethane resin dispersant cannot be obtained. If the reaction is carried out at the molar ratio NCO/OH of more than 3/0.5, gelatification may occur in the subsequent reaction, or a resin having a high molecular weight may be produced.

(xii) Properties

An acid number of the branched urethane resin dispersant used in the present invention is preferably 10 to 100, more preferably 20 to 90, most preferably 30 to 80. If the acid number is less than 10, pigment adsorbability is insufficient, and pigment dispersibility may be deteriorated. If the acid number is more than 100, pigment adsorbability is too high to obtain a sufficient steric repulsion effect, and thus, pigment dispersibility may be rather lowered.

A weight average molecular weight of the branched urethane resin dispersant used in the present invention weight average molecular weight (value corresponding to that of polystyrene measured by GPC) is preferably 1000 to 100000, more preferably 1000 to 50000, most preferably 1000 to 30000. If the weight average molecular weight is less than 1000, a sufficient steric repulsion effect cannot be maintained and thus, pigment dispersibility may be lowered. If the weight average molecular weight is more than 100000, pigment dispersibility may be lowered by a cross-link between pigment particles.

The pigment composition according to the present invention can be obtained, using the branched urethane resin dispersant and the pigment. The pigment composition having excellent dispersibility, flowability, and storage stability can be obtained, by using the branched urethane resin dispersant.

### (4) Organic Solvents

In the present invention, solvents generally used organic solvent in the inkjet ink may be used. The solvent is not limited, so long as the hydroxyl-type urethane resin dispersant and the acid anhydride-type urethane resin dispersant used in the present invention can be dissolved or homogeneously suspended. The organic solvent is, for example, methyl alcohol, ethyl alcohol, n-propyl alcohol, isopropyl alcohol, n-butyl alcohol, or other alcohols, acetone, methyl ethyl ketone, methyl-n-propyl ketone, methyl isopropyl ketone, methyl-n-butyl ketone, methyl isobutyl ketone, methyl-n-amyl ketone, methyl isoamyl ketone, diethyl ketone, ethyl-n-propyl ketone, ethyl isopropyl ketone, ethyl-n-butyl ketone, ethyl isobutyl ketone, di-n-propyl ketone, diisobutyl ketone, cyclohexanone, methylcyclohexanone, isophorone, or other ketons, methyl acetate, ethyl acetate, n-propyl acetate, isopropyl acetate, n-butyl acetate, isobutyl acetate, hexyl acetate, octyl acetate, methyl lactate, propyl lactate, butyl lactate, or other esters, ethyleneglycol, ethyleneglycol monoisopropyl ether, ethyleneglycol monobutyl ether, ethyleneglycol monohexyl ether, diethyleneglycol monomethyl ether, diethyleneglycol monoethyl ether, diethyleneglycol monobutyl ether, ethyleneglycol dimethyl ether, ethyleneglycol diethyl ether, diethyleneglycol dimethyl ether, diethyleneglycol diethyl ether, propyleneglycol, propyleneglycol monomethyl ether, propyleneglycol monoethyl ether, propyleneglycol monopropyl ether, propyleneglycol monobutyl ether, dipropyleneglycol monomethyl ether, dipropyleneglycol monoethyl ether, dipropyleneglycol dipropyl ether, tripropyleneglycol monomethyl ether, or other glycols and glycol ethers, ethyleneglycol monomethylether acetate, ethyleneglycol monoethylether acetate, ethyleneglycol monobutylether acetate, diethyleneglycol monomethylether acetate, diethyleneglycol monoethylether acetate, diethyleneglycol monobutylether acetate, propyleneglycol monomethyl ether acetate, propyleneglycol monoethylether acetate, propyleneglycol monobutylether acetate, dipropyleneglycol monomethylether acetate, or other glycolacetates, n-hexane, isohexane, n-nonane, isononane, dodecane, isododecane, or other saturated hydrocarbons, 1-hexene, 1-heptene, 1-octene, or other unsaturated hydrocarbons, cyclohexane, cycloheptane, cyclooctane, cyclodecane, decalin, or other cyclic saturated hydrocarbons, γ-butyrolactone, δ-valerolactone, or other cyclic esters, N-methyl-2-pyrrolidone, N-ethyl-2-pyrrolidone, or other nitrogen-containing heterocycles, cyclohexene, cycloheptene, cyclooctene, 1,1,3,5,7-cyclooctatetraene, cyclododecene, or other cyclic unsaturated hydrocarbons, benzene, toluene, xylene, or other aromatic hydrocarbons. These organic solvents may be used alone or in combination of two or more of the above solvents.

### (5) Resins

To the inkjet ink according to the present invention, a resin, particularly a binder resin, may be added in order to achieve fixability when drawndown. The resin which may be used is, for example, petroleum resin, casein, shellac, rosin-modified maleic resin, rosin-modified phenol resin, nitrocellulose, cellulose acetate butyrate, cyclized rubber, chlorinated rubber, oxidized rubber, rubber hydrochloride, phenol resin, alkyd resin, polyester resin, unsaturated polyester resin, amino resin, epoxy resin, vinyl resin, vinyl chloride resin, polyvinylidene chloride, vinyl chloride vinyl acetate resin, ethylene vinyl acetate resin, acrylic resin, metacrylate resin, polyurethane resin, silicone resin, fluorocarbon resin, drying oil, synthetic drying oil, styrene maleic resin, styrene acrylic resin, polyamide resin, butyral resin.

### (6) Other Additives

The inkjet ink according to the present invention may contain a plasticizer, a surface adjusting agent, a UV protective agent, a light stabilizer, an antioxidant, an antistatic agent, an antiblocking agent, an antifoaming agent, a viscosity adjusting agent, wax, a surface-active agent, a leveling agent, or other various additives.

The inkjet ink according to the present invention can contain polymerizable monomers or oligomers, and be used as a radiation curing ink which may be cured by ultraviolet light or electron beam. The radiation polymerizable monomer used in the present invention includes a radical polymerizable monomer or a cationic polymerizable monomer.

Monofunctional monomer which may be cured by radical polymerization is, for example, but not limited to, butanediol monoacrylate, N,N-dimethylaminoethyl acrylate, 2-hydroxyethyl acrylate, 2-hydroxyethyl methacrylate, hydroxypropyl acrylate, 2-methoxyethyl acrylate, N-vinylcaprolactam, N-vinylpyrrolidone, acryloylmorpholine, N-vinylformamide, cyclohexyl acrylate, cyclohexyl methacrylate, dicyclopentanyl methacrylate, glycidyl acrylate, isobonyl acrylate, isodecyl acrylate, phenoxy methacrylate, stearylacrylate, tetrahydrofurfurylacrylate, 2-phenoxyethyl acrylate, 2-hydroxypropyl acrylate, 4-hydroxybutyl acrylate, isobutyl acrylate, T-butyl acrylate, isooctyl acrylate, isobornyl acrylate, methoxytriethylene glycol acrylate, 2-ethoxyethyl acrylate, tetrahydrofurfuryl acrylate, 3-methoxybutyl acrylate, benzyl acrylate, ethoxyethoxyethyl acrylate, butoxyethyl acrylate, ethoxydiethyleneglycol acrylate, methoxydipropyleneglycol acrylate, methylphenoxyethyl acrylate, dipropyleneglycol acrylate. Of these monomers, isooctyl acrylate, isobornyl acrylate, 2-phenoxyethyl acrylate, methylphenoxyethyl acrylate, or butoxyethyl acrylate is preferable. In view of curability or suitability to an inkjet ink, isobornyl acrylate, or 2-phenoxyethyl acrylate is particularly preferable.

Monofunctional monomer which may be cured by cationic polymerization is, for example, but not limited to, ethyleneglycol monovinyl ether, triethyleneglycol monovinyl ether, hydroxyethyl monovinyl ether, hydroxynonyl monovinyl ether, ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexanedimethanol monovinyl ether, n-propyl vinyl ether, isopropylvinylether, isopropenylether-O-propylene carbonate, dodecyl vinyl ether, diethyleneglycol monovinyl ether, octadecyl vinyl ether, or other monovinyl ether compounds, monofunctional cycloaliphatic epoxy, monofunctional oxetane. These compounds may be used alone or in combination thereof.

Difunctional monomer which may be cured by radical polymerization is, for example, but not limited to, ethyleneglycol di(meta)acrylate, diethyleneglycol di(meta)acrylate, polyethyleneglycol di(meta)acrylate, 1,6-hexanediol di(meta)acrylate, ethoxylated 1,6-hexanediol diacrylate, propoxylated 1,6-hexanediol diacrylate, neopentylglycol di(meta)acrylate, ethoxylated neopentylglycol di(meta)acrylate, propoxylated neopentylglycol di(meta)acrylate, tripropyleneglycol di(meta)acrylate, polypropyleneglycol diacrylate, 1,4-butanediol di(meta)acrylate, 1,9-nonanediol diacrylate, tetraethyleneglycol diacrylate, 2-n-butyl-2-ethyl-1,3-propanediol diacrylate, dimethylol-tricyclodecane diacrylate, hydroxypivalic acid neopentylglycol diacrylate, 1,3-butyleneglycol di(meta)acrylate, ethoxylated bisphenol A di(meta)acrylate, propoxylated bisphenol A di(meta)acrylate, cyclohexanedimethanol di(meta)acrylate, dimethyloldicyclopentane diacrylate.

Difunctional monomer which may be cured by cationic polymerization is, for example, but not limited to, ethyleneglycol divinyl ether, diethyleneglycol divinyl ether, triethyleneglycol divinyl ether, butanediol divinyl ether, propyleneglycol divinyl ether, dipropyleneglycol divinyl ether, hexanediol divinyl ether, cyclohexanedimethanol divinyl ether, difunctional cycloaliphatic epoxy, difunctional oxetane. These compounds may be used alone or in combination thereof.

Trifunctional monomer which may be cured by radical polymerization is, for example, but not limited to, trimethylolpropane triacrylate, ethoxylated trimethylolpropane triacrylate, propoxylated trimethylolpropane triacrylate, pentaerythritol triacrylate, tetramethylolpropane triacrylate, tetramethylolmethane triacrylate, caprolactone-modified trimethylolpropane triacrylate, ethoxylated isocyanuric acid triacrylate, tri(2-hydroxyethylisocyanurate)triacrylate, propoxylateglyceryl triacrylate.

Trifunctional monomer which may be cured by cationic polymerization is, for example, but not limited to, trimethylolpropane trivinyl ether, trifunctional cycloaliphatic epoxy, trifunctional oxetane. These compounds may be used alone or in combination thereof.

When a radiation curing monomer is used, the ink preferably contains a photopolymerization initiator. The photopolymerization initiator is, for example, benzophenone, 4,4-diethylaminobenzophenone, diethylthioxanthone, 2-methyl-1-(4-methylthio)phenyl-2-morpholinopropane-1-one, 4-benzoyl-4′-methyldiphenylsulfide, 1-chloro-4-propoxythioxanthone, isopropylthioxanthone, 2-hydroxy-2-methyl-1-phenylpropane-1-one, 1-hydroxy-cyclohexylphenylketone, bis-2,6-dimethoxybenzoyl-2,4,4-trimethylpentylphosphine oxide, 1-[4-(2-hydroxyethoxy)-phenyl]-2-hydroxy-2-methyl-1-propane-1-one, 2,2-dimethyl-2-hydroxyacetophenone, 2,2-dimethoxy-2-phenylacetophenone, 2,4,6-trimethylbenzyl-diphenylphosphine oxide, 2-benzyl-2-dimethylamino-1-(morpholinophenyl)-butane-1-one, or the like. The photopolymerization initiator can be used alone or in combination thereof. A photopolymerization accelerator which is used together with the radical-photopolymerization initiator is, for example, ethyl p-dimethylaminobenzoate ester, benzyl 4-dimethylaminobenzoate, or the like. The radical-photopolymerization accelerator may be used alone or in combination thereof. When a radical polymerizable monomer is used and an electron beam is used as radiation, the photopolymerization initiator is not always necessary. When the cationic polymerizable monomer is used, a cationic photopolymerization initiator is essentially necessary, regardless of the kind of radiation ray used. The cationic photopolymerization initiator is, for example, an arylsulfonium salt derivative, such as Cylacure UVI-6990, Cylacure UVI-6974 (manufactured by Union Carbide Corporation), ADEKA OPTOMER SP-150, ADEKA OPTOMER SP-152, ADEKA OPTOMER SP-170, ADEKA OPTOMER SP-172 (manufactured by Adeka Corporation), an aryliodonium salt derivative, such as RP-2074 (manufactured by Rhodia Ltd.), an allene-ion complex derivative, such as IRGACURE 261 manufactured by Chiba-Geigy K.k.), a diazonium salt derivative, a triazine-based initiator, an acid-generating agent such as halogenated compound. A photopolymerization accelerator which is used together with the cationic photopolymerization initiator is, for example, anthracene, anthracene derivative, such as ADEKA OPTOMER SP-100 manufactured by Adeka Corporation, 9,10-dibutoxyanthracene, 9,10-ethoxyanthracene, 9,10-dipropoxyanthracene manufactured by Kawasaki kasei Chemicals Ltd. Each of the cationic photopolymerization initiator and the cationic photopolymerization accelerator may be used alone, or in combination thereof.

The inkjet ink according to the present invention can be prepared by dissolving or suspending the urethane resin dispersant used in the present invention in an organic solvent, adding the pigment into the solvent, homogeneously dispersing and mixing the whole by a high-speed mixer or the like, and then, dispersing the product by a dispersing device, for example, a horizontal sand mill, a vertical sand mill, an annular sand mill, or other beads mills, a roll mill, a media-less dispersing device. The pigment derivative can be used by adding it to the pigment to treat the pigment therewith when the pigment is prepared.

### (II) Ink Composition with a Thermal Reactive Compound

Then, the embodiment wherein the thermal reactive compound (D) is contained will be explained.

### (1) Urethane Resin Dispersants

The urethane resin dispersant is also used in the ink composition according to the present invention wherein the thermal reactive compound (D) is contained. The urethane resin dispersant includes, as typical embodiments, the hydroxyl-type urethane resin dispersant and the acid anhydride-type urethane resin dispersant. The above-mentioned hydroxyl-type urethane resin dispersant, and the above-mentioned acid anhydride-type urethane resin dispersant can be used as they are.

### (2) Pigments

The ink composition for ink jet recording according to the present invention contains the pigment. As the pigment, an organic pigment, an inorganic pigment, or carbon black such as acetylene black, channel black, furnace black can be used. A mixture of two of more pigments can be used.

The organic pigment is, for example, diketopyrrolopyrrole-based pigment, azo, disazo, or polyazo, or other azo-based pigments, copper phthalocyanine, copper halogenated phthalocyanine, or metal-free phthalocyanine, or other phthalocyanine-based pigments, aminoanthraquinone, diaminodianthraquinone, anthrapyrimidine, flavanthrone, anthanthrone, indanthrone, pyranthorone, or violanthrone, or other anthraquinone-based pigments, quinacridone-based pigments, dioxazine-based pigments, perinone-based pigments, perylene-based pigments, thioindigo-based pigments, isoindoline-based pigments, isoindolinone-based pigments, quinophthalone-based pigments, threne-based pigments, or metal complex-based pigments, or the like.

The inorganic pigment is, for example, titanium oxide, hydrozincite, zinc sulfide, white lead, calcium carbonate, precipitated barium sulfate, white carbon black, white alumina, kaolin clay, talc, bentonite, black iron oxide, cadmium red, iron red, molybdenum red, molybdate orange, chrome vermilion, chrome yellow, cadmium yellow, yellow oxide, titan yellow, chromium oxide, viridian, titanium cobalt green, cobalt green, cobalt chrome green, victoria green, ultramarine blue, iron blue, cobalt blue, cerulean blue, cobalt silica blue, cobalt zinc silicablue, manganese violet, or cobalt violet, or the like.

The pigments which may be used in the ink composition according to the present invention can be indicated by color index (C.I.) numbers, as follows:

For a red-colored composition, for example, C.I. Pigment Red 7, 9, 14, 41, 48:1, 48:2, 48:3, 48:4, 81:1, 81:2, 81:3, 97, 122, 123, 146, 149, 168, 177, 178, 180, 184, 185, 187, 192, 200, 202, 208, 210, 215, 216, 217, 220, 223, 224, 226, 227, 228, 240, 246, 254, 255, 264, 272, or other red pigments may be used. In the red-colored composition, a yellow pigment, and/or an orange pigment can be mixed together.

For a yellow-colored composition, for example, C.I. Pigment Yellow 1, 2, 3, 4, 5, 6, 10, 12, 13, 14, 15, 16, 17, 18, 20, 24, 31, 32, 34, 35, 35:1, 36, 36:1, 37, 37:1, 40, 42, 43, 53, 55, 60, 61, 62, 63, 65, 73, 74, 77, 81, 83, 86, 93, 94, 95, 97, 98, 100, 101, 104, 106, 108, 109, 110, 113, 114, 115, 116, 117, 118, 119, 120, 123, 125, 126, 127, 128, 129, 137, 138, 139, 147, 148, 150, 151, 152, 153, 154, 155, 156, 161, 162, 164, 166, 167, 168, 169, 170, 171, 172, 173, 174, 175, 176, 177, 179, 180, 181, 182, 185, 187, 188, 193, 194, 199, or other yellow pigments may be used.

For an orange-colored composition, for example, C.I. Pigment Orange 36, 43, 51, 55, 59, 61, or other orange pigments may be used. For a green-colored composition, for example, C.I. Pigment Green 7, 10, 36, 37, or other green pigments may be used. In the green-colored composition, the yellow pigment may be mixed.

For a blue-colored composition, for example, C.I. Pigment Blue 15, 15:1, 15:2, 15:3, 15:4, 15:6, 16, 22, 60, 64, or other blue pigments may be used. In the blue-colored composition, for example, C.I. Pigment Violet 1, 19, 23, 27, 29, 30, 32, 37, 40, 42, 50, or other violet pigments may be mixed together. The ink composition for ink jet recording according to the present invention can contain the above-mentioned pigment alone, or a mixture of two or more pigments.

It is preferable that the particle size of the pigment is sufficiently small with respect to the wavelength of the visible light, in view of the absorption coefficient adequacy of spectrum of the visible light and transparency. More particularly, an average primary particle size of the pigment is preferably 0.01 μm to 0.3 μm, more preferably 0.01 μm to 0.1 μm. The term primary particle size means a diameter of the pigment particle in a minimum unit, and is measured by an electron microscope. The primary particle size of the pigment can be controlled by a known dispersing device, such as a sand mill, a kneader, a twin-roll mill, or the like.

The pigment is contained in the ink composition for ink jet recording according to the present invention at an amount of preferably 1 to 30% by weight, more preferably 3 to 25% by weight with respect to the total weight of the composition. When the amount of the pigment is less than 1% by weight, the concentration within the ink layer is insufficient. When the amount of the pigment is more than 30% by weight, the viscosity may be raised and stability with time may be lowered. A weight ratio of the pigment and the resin dispersant is preferably 100:3 to 100:150, more preferably 100:5 to 100:100. When the weight ratio is less than 100:3, the viscosity of the ink composition may not be sufficiently lowered. When the weight ratio is more than 100:150, an ink-forming property may be deteriorated.

### (3) Thermal Reactive Compounds

The ink composition for ink jet recording according to the present invention contains a thermal reactive compound. The thermal reactive compound which may be used in the ink composition according to the present invention is unreactive at an ordinary temperature, but can be, for example, at 100° C. or more (preferably 150° C. or more), cross-linked, polymerized, polycondensated, or addition-polymerized. The molecular weight of the thermal reactive compound which may be used in the ink composition according to the present invention is not limited, but preferably 50 to 2000, more preferably 100 to 1000.

The thermal reactive compound is, for example, a melamine compound, a benzoguanamine compound, an epoxy compound, a phenol compound, a block isocyanate compound, an acrylate-based monomer, or a silane coupling agent.

The melamine compound is, for example, a compound having an imino group, a methylol group, and/or an alkoxymethyl group, preferably a melamine compound having only an alkoxymethyl group. The melamine compound having an alkoxymethyl group is for example, but is not limited to, a hexamethoxymethylol melamine, or hexabutoxymethylol melamine.

A commercially available melamine compound is, for example, but is not limited to, Nikalac MW-30M, MW-30, MW-22, MS-21, MX-45, MX-500, MX-520, MX-43, MX-302, each manufactured by Sanwa Chemical Co., Ltd.; SCIMEL 300, 301, 303, 350, 285, 232, 235, 236, 238, MYCOAT 506, 508, each manufactured by Japan Scitex Industry.

The benzoguanamine compound is, for example, a compound having an imino group, a methylol group, or an alkoxymethyl group, particularly, an alkoxymethyl group-containing benzoguanamine compound is preferable. A commercially available benzoguanamine compound is, for example, Nikalac BX-4000, SB-401 manufactured by Sanwa Chemical Co., Ltd., SCIMEL 1123 manufactured by Japan Scitex Industry.

The epoxy compound is, for example, but is not limited to, bisphenol fluorinediglycidyl ether, biscresol fluorinediglycidyl ether, bisphenoxyethanol fluorine diglycidyl ether, neopentylglycol diglycidyl ether, 1,6-hexanediol diglycidyl ether, glycerol polyglycidyl ether, trimethylolpropane polyglycidyl ether, pentaerythritol polyglycidyl ether, diglycerol polyglycidyl ether, sorbitol polyglycidyl ether, diglycidyl terephthalate, diglycidyl o-phthalate, ethyleneglycol diglycidyl ether, diethyleneglycol diglycidyl ether, polyethyleneglycol diglycidyl ether, and polypropyleneglycol diglycidyl ether, or glycidyl ethers of other polyols, polyglycidyl isocyanurate, or the like.

As the phenol compound, for example, either of a novolac phenol compound prepared by reacting phenols and aldehydes in the presence of an acidic catalyst, a resol phenol compound prepared by reacting phenols and aldehydes in the presence of a basic catalyst may be used. The phenols are, for example, orthocresol, paracresol, paraphenylphenol, paranonylphenol, 2,3-xylenol, phenol, metacresol, 3,5-xylenol, resorcinol, catechol, hydroquinone, bisphenol A, bisphenol F, bisphenol B, bisphenol E, bisphenol H, bisphenol S, or the like. The aldehydes are, for example, formaldehyde, or acetaldehyde. The phenol or the aldehyde may be used alone or in combination of two or more compounds, respectively.

The blocked isocyanate is, for example, but not limited to, hexamethylene diisocyanate, isophorone diisocyanate, toluidine isocyanate, diphenylmethane-4,4′-diisocyanate, diphenylmethane-2,4′-diisocyanate, bis(4-isocyanatecyclohexyl)methane, tetramethylxylylene diisocyanate, or other diisocyanates, isocyanurate derivatives, trimethylolpropane adducts, or burettes of the above diisocyanates, a prepolymer (a low molecular weight compound prepared from a diisocyanate and a polyol) having an isocyanate residue, urethodione having an isocyanate residue, or the like.

The blocking agent is, for example, but not limited to, phenol (dissociation temperature: 180° C. or more), s-caprolactam (dissociation temperature: 160 to 180° C.), oxime (dissociation temperature: 130 to 160° C.), or an active methylene (100 to 120° C.), or the like. The blocking agent may be used alone or a combination thereof.

The acrylate monomer is, for example, but not limited to, methyl (meta)acrylate, ethyl (meta)acrylate, 2-hydroxyethyl (meta)acrylate, 2-hydroxypropyl (meta)acrylate, cyclohexyl (meta)acrylate, β-carboxyethyl (meta)acrylate, polyethyleneglycol di(meta)acrylate, 1,6-hexanediol di(meta)acrylate, glycerine di(meta)acrylate, triethyleneglycol di(meta)acrylate, tripropyleneglycol di(meta)acrylate, trimethylolpropane tri(meta)acrylate, pentaerythritol tri(meta)acrylate, 1,6-hexanedioldiglycidylether di(meta)acrylate, bisphenol A diglycidyl ether di(meta)acrylate, neopentylglycol diglycidyl ether di(meta)acrylate, dipentaerythritol hexa(meta)acrylate, tricyclodecanyl (meta)acrylate, ester acrylate, (meta)acrylic ester of methylolated melamine, epoxy (meta)acrylate, urethane acrylate, or other acrylic esters and methacrylic acid esters, (meta)acrylic acid, styrene, vinyl acetate, hydroxyethylvinyl ether, ethyleneglycol divinyl ether, pentaerythritol trivinyl ether, (meta)acrylamide, N-hydroxymethyl (meta) acrylamide, N-vinylformamide, acrylonitrile.

When the acrylate monomer is used, a polymerization initiator may be used together in order to enhance a curing property. As the polymerization initiator, a thermal polymerization initiator may be used to enhance the curing property when heated. The thermal polymerization initiator may be an organic peroxide initiator, an azo-based initiator, or the like.

The silane coupling agent is, for example, vinyl tris (β-methoxyethoxy)silane, vinyl ethoxysilane, vinyl trimethoxysilane, or other vinyl silanes, γ-methacryloxy propyltrimethoxysilane, or other (meta) acrylsilanes, β-(3,4-epoxycyclohexyl)ethyl trimethoxysilane, β-(3,4-epoxycyclohexyl)methyl trimethoxysilane, β-(3,4-epoxycyclohexyl)ethyl triethoxysilane, β-(3,4-epoxycyclohexyl)methyl triethoxysilane, γ-glycidoxy propyl trimethoxysilane, γ-glycidoxy propyl triethoxysilane, or other epoxysilanes, N-β (aminoethyl)γ-aminopropyl trimethoxysilane, N-β (aminoethyl)γ-aminopropyl triethoxysilane, N-β (aminoethyl)γ-aminopropylmethyl diethoxysilane, γ-aminopropyl triethoxysilane, γ-aminopropyl trimethoxysilane, N-phenyl-γ-aminopropyl trimethoxysilane, N-phenyl-γ-aminopropyl triethoxysilane, or other aminosilanes, γ-mercaptopropyl trimethoxysilane, γ-mercaptopropyl triethoxysilane, or other thiosilanes.

Of these thermal reactive compounds, the melamine compound or the benzoguanamine compound is contained at an amount of preferably 1% by weight to 40% by weight in the ink composition according to the present invention. The epoxy compound, the phenol compound, the blocked isocyanate compound, or the acrylate monomers is contained at an amount of preferably 1% by weight to 40% by weight in the ink composition according to the present invention. Further, the silane coupling agent is contained at an amount of preferably 0.1% by weight to 40% by weight in the ink composition according to the present invention. When the amount is insufficient, a heat resistance, or a chemical resistance may be lowered. When the amount is more than 40%, a viscosity may be raised or stability in storage may be lowered.

### (4) Organic Solvents

The ink composition for ink jet recording according to the present invention contains an organic solvent.

In the present invention, an organic solvent which is usually used in an ink composition for ink jet recording may be used. It is preferable that the organic solvent usually used in an ink composition for ink jet recording has a high solubility to resins, a low swellability to printer materials brought into contact with an ink, and a low viscosity. Thus, the organic solvent is selected, taking into account solubility to resins, swellability to printer materials, viscosity, and a drying property of an ink at a nozzle. As the organic solvent, an alcoholic solvent, a glycolic solvent, an ester solvent, and/or a ketone solvent may be used alone or in combination thereof.

The alcoholic solvent is, for example, hexanol, heptanol, octanol, nonanol, decanol, undecanol, cyclohexanol, benzyl alcohol, or amyl alcohol.

The glycolic solvent is, for example, ethyleneglycol monomethyl ether, ethyleneglycol monoethyl ether, ethyleneglycol monoisopropyl ether, ethyleneglycol monobutyl ether, ethyleneglycol monohexyl ether, methoxymethoxyethanol, diethyleneglycol monomethyl ether, diethyleneglycol monoethyl ether, diethyleneglycol monobutyl ether, diethyleneglycol monomethyl ether acetate, diethyleneglycol monoethyl ether acetate, diethyleneglycol monobutyl ether acetate, triethyleneglycol monomethyl ether, triethyleneglycol monoethyl ether, propyleneglycol monomethyl ether, propyleneglycol monoethyl ether, propyleneglycol isopropyl ether, propyleneglycol monobutyl ether, propyleneglycol monomethyl ether acetate, propyleneglycol monoethyl ether acetate, 1-butoxyethoxypropanol, or 1-methoxy-2-propyl acetate.

The ester solvent is, for example, ethyl lactate, propyl lactate, or butyl lactate. The ketone solvent is, for example, cyclohexanone, ethyl amyl ketone, diacetone alcohol, diisobutyl ketone, isophorone, methyl cyclohexanone, or acetophenone.

### (5) Pigment Derivative

The ink composition for ink jet recording according to the present invention may further contain a pigment derivative. As the pigment derivative is, for example, a compound of the general formula (1a):

G¹-(E)q (1a)

wherein G¹ is a residue of a chromogen compound, E is a basic substituent, an acidic substituent or a neutral substituent, q is an integer from 1 to 4 can be used.

The basic substituent E is, for example, a compound of one of the following general formulae (3), (4), (5), and (6).

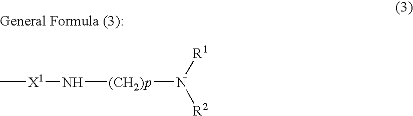

X¹: —SO₂—, —CO—, —CH₂NHCOCH₂—, —CH₂— or a direct bond.
p: an integer of 1 to 10.
R¹, R²: independently of each other, an optionally substituted alkyl group, an optionally substituted alkenyl group, an optionally substituted phenyl group, or R¹ and R² form together an optionally substituted heterocyclic ring containing a nitrogen atom, an oxygen atom or a sulfur atom, wherein the alkyl group or the alkenyl group has preferably 1 to 10 carbon atoms.

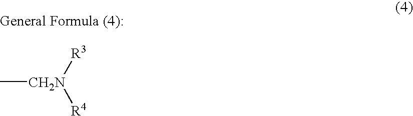

R³, R⁴: independently of each other, an optionally substituted alkyl group, an optionally substituted alkenyl group, an optionally substituted phenyl group, or R³ and R⁴ form together an optionally substituted heterocyclic ring containing a nitrogen atom, an oxygen atom or a sulfur atom, wherein the alkyl group or the alkenyl group has preferably 1 to 10 carbon atoms.

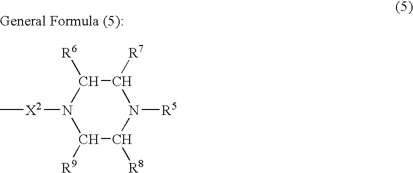

X²: —SO₂—, —CO—, —CH₂NHCOCH₂—, —CH₂— or a direct bond.
R⁵: an optionally substituted alkyl group, an optionally substituted alkenyl group or an optionally substituted phenyl group, wherein the alkyl group or the alkenyl group has preferably 1 to 10 carbon atoms.
R⁶, R⁷, R⁸, R⁹: independently of each other, a hydrogen atom, an optionally substituted alkyl group, an optionally substituted alkenyl group or an optionally substituted phenyl group, wherein the alkyl group or the alkenyl group has preferably 1 to 5 carbon atoms.

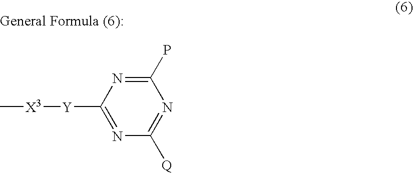

X³: —SO₂—, —CO—, —CH₂NHCOCH₂—, —CH₂— or a direct bond.
Y: —NR³⁰-Z-NR³¹— or a direct bond.
R³⁰, R³¹: independently of each other, a hydrogen atom, an optionally substituted alkyl group, an optionally substituted alkenyl group or an optionally substituted phenyl group, wherein the alkyl group or the alkenyl group has preferably 1 to 5 carbon atoms.
Z: an optionally substituted alkylene group, an optionally substituted alkenylene group, or an optionally substituted phenylene group, wherein the alkyl group or the alkenyl group has preferably 1 to 8 carbon atoms.
P: a substituent of the following general formula (7) or (8).
Q: a hydroxyl group, an alkoxyl group, a substituent of the following general formula (7), or a substituent of the following general formula (8).

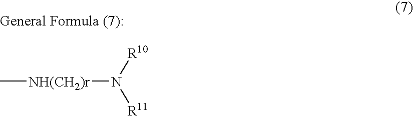

R: an integer of 1 to 10.
R¹⁰, R¹¹: independently of each other, an optionally substituted alkyl group, an optionally substituted alkenyl group, an optionally substituted phenyl group, or R¹⁰, R¹¹ form together an optionally substituted heterocyclic ring containing a nitrogen atom, an oxygen atom or a sulfur atom, wherein the alkyl group or the alkenyl group has preferably 1 to 10 carbon atoms.

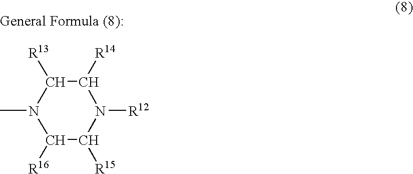

R¹⁶: an optionally substituted alkyl group, an optionally substituted alkenyl group or an optionally substituted phenyl group, wherein the alkyl group or the alkenyl group has preferably 1 to 10 carbon atoms.
R¹³, R¹⁴, R¹⁵, R¹⁶: independently of each other, a hydrogen atom, an optionally substituted alkyl group, an optionally substituted alkenyl group or an optionally substituted phenyl group, wherein the alkyl group or the alkenyl group has preferably 1 to 5 carbon atoms.

The acidic substituent E or the neutral substituent E is, for example, the substituent of one of the following general formulae (9), (10) and (11).

—SO₃M/l (9)

M: hydrogen atom, calcium atom, barium atom, strontium atom, manganese atom, or aluminum atom.
l: a valent number of M.

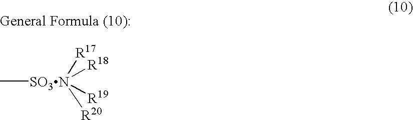

R¹⁷, R¹⁸, R¹⁹, R²⁰: hydrogen atom or an alkyl group having 1 to 30 carbon atoms, proviso that all of R¹⁷, R¹⁸, R¹⁹, and R²⁰ are not hydrogen atoms at the same time.

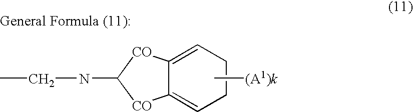

A¹: hydrogen atom, halogen atom, —NO₂, —NH₂ or SO₃H.
k: an integer of 1 to 4.

The residue of a chromogen compound G¹ is, for example, diketopyrrolopyrrole-based colorants, azo, disazo, or polyazo colorant, or other azo-based colorants, phthalocyanine-based colorant, diaminodianthraquinone, anthrapyrimidine, flavanthrone, anthanthrone, indanthrone, pyranthorone, violanthrone, or other anthraquinone-based colorants, quinacridone-based colorants, dioxazine-based colorants, perinone-based colorants, perylene-based colorants, thioindigo-based colorants, isoindoline-based colorants, isoindolinon-based colorants, quinophthalone-based colorants, threne-based colorants, or metal complex-based colorants, anthraquinone residues, or triazine residues, or the like.

As the anthraquinone derivative, an anthraquinone containing the above basic substituent, acidic substituent or neutral substituent may be used. The triazine derivative is, for example, a compound prepared by introducing the above basic substituent, acidic substituent or neutral substituent into 1,3,5-triazine optionally containing methyl group, or ethyl group, or other alkyl groups, or amino group or dimethylamino group, diethylamino group, or dibutylamino group, or other alkylamino groups, or nitro group or hydroxyl group or methoxy group, ethoxy group, or butoxy group, or other alkoxy group, or chlorine, or other halogen atoms, or phenyl group optionally substituted by methyl group, methoxy group, amino group, dimethylamino group, hydroxyl group or the like, or phenylamino group optionally substituted by methyl group, ethyl group, methoxy group, ethoxy group, amino group, dimethylamino group, diethylamino group, nitro group, or hydroxyl group, or the like.

Of these compounds, the pigment derivative containing a triazine ring, or an anthraquinone group is more preferable. The pigment derivative containing a triazine ring or anthraquinone group structure has a high adsorbability to a pigment and thus a high dispersibility, and effectively causes a curing reaction of the thermal reactive compound, whereby a further improvement of resistances can be expected.

### (6) Binder Resins

The ink composition for ink jet recording according to the present invention may further contain a binder resin. It is preferable that the binder resin is nonreactive at a reaction temperature of the thermal reactive compound, and a thermoplastic resin.

The binder resin is, for example, petroleum-derived resin, maleic resin, nitrocellulose, celluloseacetate butylate, cyclized rubber, chlorinated rubber, alkyd resin, acrylic resin, polyester resin, amino resin, vinyl resin, or butyral resin.

The binder resin having a cross-linkable functional group can be used. The cross-linkable functional group is, for example, hydroxyl group, carboxyl group, sulfonic group, phosphate group, or an alkoxyl group. As the resin having a cross-linkable functional group, an acrylic resin having a hydroxyl group or carboxyl group is preferable, because of a moderate cross-linking of the resin by an esterification. The acrylic resin having a hydroxyl group or carboxyl group is prepared by copolymerizing a monomer containing a hydroxyl group or a monomer having a carboxyl group with an acrylic monomer without a hydroxyl group or a carboxyl group.

The monomer having a hydroxyl group is, for example, 2-hydroxyethyl (meta) acrylate, 2-hydroxypropyl (meta)acrylate, 3-hydroxypropyl (meta)acrylate, 2-hydroxybutyl (meta)acrylate, 3-hydroxybutyl (meta)acrylate, 4-hydroxybutyl (meta)acrylate, glycerine (meta)acrylate, polyethyleneglycol mono(meta)acrylate (n=2 to 50), polycaprolactone-modified hydroxyethyl (meta)acrylate (number of the repeating caprolactone unit 1 to 6), epoxy (meta)acrylate, terminal-hydroxyl-group-urethane (meta)acrylate, N-methylol acrylamide, allyl alcohol, polyethyleneglycol monomethacrylate, polyethyleneglycol monoacrylate, hydroxypropyl methacrylate, polypropyleneglycol monomethacrylate, polypropyleneglycol monoacrylate, poly(ethyleneglycol propyleneglycol) monomethacrylate, polyethyleneglycol polypropyleneglycol monomethacrylate, polyethyleneglycol polypropyleneglycol monoacrylate, poly(ethyleneglycol tetramethyleneglycol methyleneglycol) monomethacrylate, poly(ethyleneglycol tetramethyleneglycol) monoacrylate, poly(propyleneglycol-tetramethyleneglycol) monomethacrylate, poly(propyleneglycol-tetramethyleneglycol) monoacrylate, propyleneglycol polybutyleneglycol monomethacrylate, propyleneglycol polybutyleneglycol monoacrylate, or the like.

The monomer having a carboxyl group is, for example, acrylic acid, methacrylic acid, crotonic acid, maleic acid, fumaric acid, itaconic acid, citraconic acid, 2-carboxyethyl acrylate, ω-carboxy-polycaprolactone monoacrylate, phthalic acid monohydroxyethyl acrylate, glutaconic acid, tetrahydro phthalic acid, or the like.

As the acrylic monomer without a hydroxyl group or a carboxyl group, the monomer of the following general formula (12) may be used.

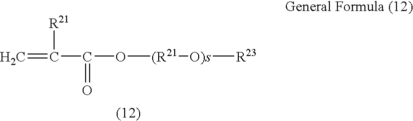

R⁴³: an alkyl group having 1 to 30 carbon atoms, —CH₂—CH═CH₂, an optionally substituent phenyl group or C=0-C(R⁵¹)═CH₂.
R⁴¹ and R⁵¹: hydrogen atom or methyl group.
R⁴²: an alkylene group having 1 to 4 carbon atoms.
s: an integer of 1 to 100.

The monomer of the general formula (12) is, for example, methoxy polyethyleneglycol monomethacrylate, methoxy polyethyleneglycol monoacrylate, octoxy polyethyleneglycol monoacrylate, octoxy polyethyleneglycol polypropyleneglycol monomethacrylate, octoxy polyethyleneglycol polypropyleneglycol monoacrylate, lauroxy polyethyleneglycol monoacrylate, lauroxy polyethyleneglycol monoacrylate, stearoxy polyethyleneglycol monomethacrylate, stearoxy polyethyleneglycol-polypropyleneglycol monoacrylate, allyloxy polyethyleneglycol-polypropyleneglycol monomethacrylate, allyloxy polyethyleneglycol-polypropyleneglycol monoacrylate, ethyleneglycol dimethacrylate, diethyleneglycol dimethacrylate, polyethyleneglycol dimethacrylate, polyethyleneglycol diacrylate, polypropyleneglycol dimethacrylate, polypropyleneglycol diacrylate, polytetramethyleneglycol dimethacrylate, polytetramethyleneglycol diacrylate, poly(ethyleneglycol tetramethyleneglycol) dimethacrylate, poly(ethyleneglycol tetramethyleneglycol) diacrylate, poly(propyleneglycol-tetramethyleneglycol) dimethacrylate, poly(propyleneglycol-tetramethyleneglycol) diacrylate, polyethyleneglycol-polypropyleneglycol-polyethyleneglycol diacrylate, nonyl phenoxypolyethyleneglycol monoacrylate, nonyl phenoxypolyethyleneglycol-polypropyleneglycol monomethacrylate, nonyl phenoxypolypropyleneglycol-polyethyleneglycol monomethacrylate, nonyl phenoxypoly(ethyleneglycol-propyleneglycol) monoacrylate, phenolethylene oxide modified acrylate, nonyl phenolethylene oxide modified acrylate, bisphenol F ethylene oxide modified diacrylate, or the like. The above monomers are commercially available, for example, as Blenmer series from NOF Corporation, or as Aronix series from TOAGOSEI Co., Ltd.

The acrylic monomer without a hydroxyl group or a carboxyl group other than the monomer of the general formula (12) is, for example, methyl (meta)acrylate, ethyl (meta)acrylate, butyl (meta)acrylate, 2-ethylhexyl (meta)acrylate, octyl (meta)acrylate, stearyl (meta)acrylate, cyclohexyl (meta)acrylate, benzyl (meta)acrylate, tetrahydrofurfuryl (meta)acrylate, or other alkyl (meta)acrylate esters, styrene, α-methylstyrene, vinyl toluene, vinyl acetate, or the like. Further, monomers generally used in preparing an acrylic resin, for example, an alkyl (meta)acrylate wherein a part or all of hydrogen atoms in the alkyl group are substituted by an aromatic ring, a heterocyclic ring, a halogen atom, or the like may be used.

As the resin having a cross-linkable functional group, a resin having a phosphate group or a sulfonic group is preferable, because dispersibility and stability with time as to the pigment are improved, and viscosity of the ink composition for ink jet recording becomes low. The phosphate group or the sulfonic group may form a salt with sodium, potassium, lithium, or other alkali metals, calcium, magnesium, aluminium, zinc, or other polyvalent metals, ammonia, or ethylamine, dibutylamine, triethanolamine, ethylamine, propylamine, butylamine, pentylamine, hexylamine, octylamine, dodecyl amine, stearylamine, oleylamine, distearylamine, or other organic amines.

The phosphate group contained in the resin having a phosphate group may be a monovalent phosphate group of the formula (13) or a divalent phosphate group of the formula (14).

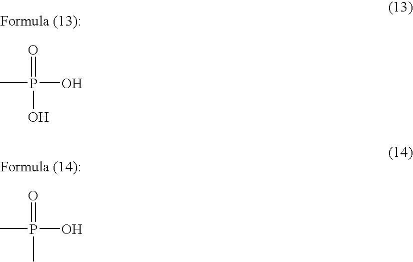

The resin having a phosphate group is, for example, a vinyl polymer containing as polymerizing component the monomer of the following general formula (15), such as ethyleneglycol methacrylate phosphate, propyleneglycol methacrylate phosphate, ethyleneglycol acrylate phosphate, propyleneglycol acrylate phosphate.

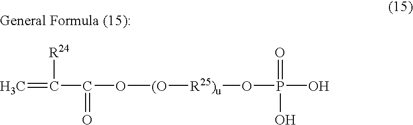

R²⁴: hydrogen or methyl group.
R²⁵: alkylene group.
U: an integer of 1 to 20.

The monomer containing a phosphate group is, for example, but not limited to, the following monomers.

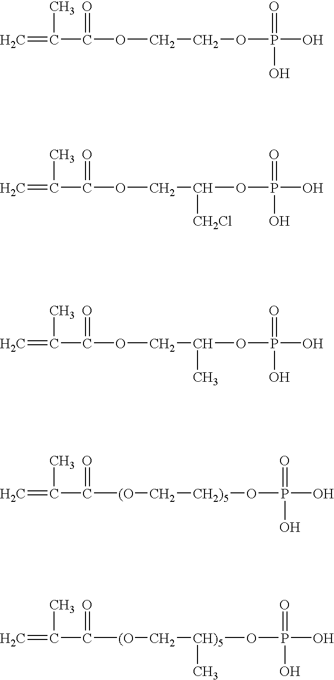

The monomer containing a phosphate group can be prepared by the methods disclosed in Japanese Unexamined Patent Publication (Kokai) No. 50-22536, or Japanese Unexamined Patent Publication (Kokai) No. 58-128393. Commercially available monomers are, for example, Phosmer M, Phosmer CL, Phosmer PE, and Phosmer MH, each manufactured by Uni-Chemical, Light-ester P-1M manufactured by Kyoeisha chemical Co., Ltd., JAMP-514 manufactured by Johoku Chemical Industry Co., Ltd., KAYAMER PM-2, and KAYAMER PM-21, each manufactured by Nippon Kayaku Co., Ltd.

The monomer containing a phosphate group can be used alone or in combination thereof. A copolymerized ratio of the monomer containing a phosphate group in the copolymer is preferably 0.1 to 30 parts by weight or less, more preferably 0.1 to 5 parts by weight or less with respect to 100 parts by weight of all monomers.

The resin containing a sulfonic group is, for example, a vinyl polymer containing a monomer containing a sulfonic group as a polymerizing component. The monomer containing a sulfonic group is, for example, 2-acrylamide-2-methylpropane sulfonic acid, vinyl sulfonic acid, 3-allyloxy-2-hydroxypropane sulfonic acid, p-styrene sulfonic acid, methallyl sulfonic acid, allyl sulfonic acid, methallyloxy benzenesulfonic acid, allyloxy benzenesulfonic acid, 2-sulfoethyl methacrylate, 4-sulfobutyl methacrylate, or the like.

The monomer containing a sulfonic group can be used alone or in combination thereof. Further, a copolymerizing ratio of the monomer containing a sulfonic group in the copolymer is preferably 0.1 to 30 parts by weight, more preferably 0.1 to 5 parts by weight with respect to 100 parts by weight of all monomers.

A weight average molecular weight (Mw) of the resin containing a phosphate group or a sulfonic group is preferably 1000 to 50000, more preferably 2000 to 30000. The resin containing a phosphate group can be prepared by radical polymerization of monomers containing a phosphate group and monomers without a phosphate group. The resin containing a sulfonic group can be prepared by radical polymerization of monomers containing a sulfonic group and monomers without a sulfonic group. As the monomer without a phosphate group or the monomer without a sulfonic group, the above-mentioned monomer containing a hydroxyl group, the above-mentioned monomer containing a carboxyl group, or the above-mentioned monomer without a hydroxyl group or a carboxyl group may be used.

The preparation of the acrylic resin having a hydroxyl group or a carboxyl group, or the resin containing a phosphate group or a sulfonic group is carried out in the presence of an initiator under an inactive gas stream at 50 to 150° C. for 2 to 10 hours. If necessary, a solvent may be present. The initiator is, for example, benzoyl peroxide, cumene hydroperoxide, t-butyl hydroperoxide, diisopropyl peroxycarbonate, di-t-butyl peroxide, t-butyl peroxybenzoate, or other organic peroxides, 2,2′-azobisisobutyronitrile, or other azo compounds. The initiator is used at an amount of preferably 1 to 20 parts by weight with respect of 100 parts by weight of the monomer.

In the preparation of the resin containing a sulfonic group, water and/or water-miscible organic solvent is preferably used as the solvent. The water-miscible organic solvent is, for example, ethyl alcohol, isopropyl alcohol, n-propyl alcohol, or other alcohol-based solvents, mono- or di-alkyl ether of ethyleneglycol or diethyleneglycol, or the like.

In the preparation of the resin containing a functional group other than a sulfonic group, an acetic acid ester solvent, such as ethylcellosolve acetate, propyleneglycol monomethylether acetate, a ketone-based solvent, such as cyclohexanone, or methyl isobutyl ketone, xylene, ethylbenzene, or the like may be used as the solvent.

It is preferable to use the resin containing, as polymerizing monomers, the monomer of the following general formula (16) or (17) as the resin, because dispersibility and stability with time as to the pigment are improved, and viscosity of the ink composition for ink jet recording becomes low.

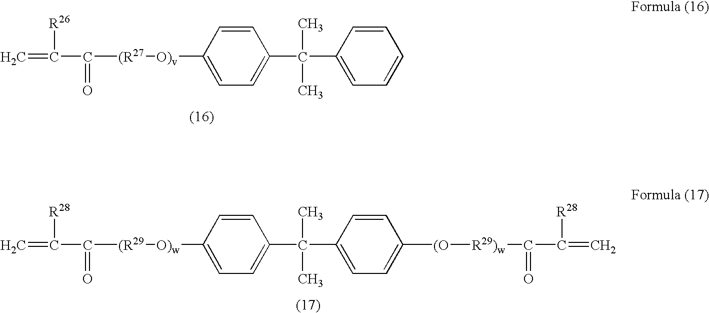

In the general formulae (16) and (17), R²⁶ and R²⁸ are hydrogen atom or methyl group, R²⁷ and R²⁹ are an alkylene group having 1 to 4 carbon atoms, and v and W are an integer of 1 to 100.

The monomer of the general formula (16) or (17) is, for example, paracumyl phenol ethylene oxide modified acrylate, ethylene oxide modified bisphenol A dimethacrylate, ethylene oxide modified bisphenol A diacrylate, propylene oxide modified bisphenol A dimethacrylate, propylene oxide modified bisphenol A diacrylate, ethylene oxide-propylene oxide modified bisphenol A dimethacrylate, ethylene oxide-propylene oxide modified bisphenol A diacrylate, propylene oxide-ethylene oxide (block type) modified bisphenol A dimethacrylate, propylene oxide tetramethylene oxide modified bisphenol A dimethacrylate, propylene oxide tetramethylene oxide modified bisphenol A diacrylate, or the like. The above monomers are commercially available, for example, as Blenmer series from NOF Corporation, or as Aronix series from TOAGOSEI Co., Ltd.

The monomer of the general formula (16) or (17) can be used alone or in combination thereof. The copolymerizing ratio of the monomer of the general formula (16) or (17) in the copolymer is preferably 0.1 to 50 parts by weight with respect to 100 parts by weight of all monomers. A weight average molecular weight (MW) of the resin containing the monomers of the general formula (16) or (17) as polymerizing components is preferably 5000 to 100000, more preferably 10000 to 50000.

The resin containing the monomers of the general formula (16) or (17) as polymerizing components can be prepared by radical polymerization of the monomers of the general formula (16) or (17) and other monomers, as the acrylic resin containing a hydroxyl group or a carboxyl group. The other monomer is, for example, the above-mentioned monomer having a hydroxyl group, the above-mentioned monomer having a carboxyl group, the above-mentioned monomer without a hydroxyl group or a carboxyl group, the above-mentioned monomer having a phosphate group, or the above-mentioned monomer having a sulfonic group.

### (7) Coating Treatment of Pigment

After homogeneously mixing the pigment, the resin dispersant of the general formula (1a), the organic solvent, the pigment derivative, and the binder resin in advance, the coating treatment of the pigment can be carried out by kneading the whole, using a dispersing device. It is preferable to adjust an amount of the solvent added, depending on machine characteristics of the mixture. In the coating treatment, a dispersing device, such as a kneader, a roll mill, a ball mill, a Banbury mixer, a roller mill, a stone mill can be used. A twin-roll mill is preferable, because a mixing and a kneading can be carried out by a single device.

In the coating treatment, amounts of the starting materials are preferably 1 to 30 parts by weight of the pigment derivative, 20 to 200 parts by weight of the resin dispersant and binder resin (hereinafter referred to as resin components), 4 to 200 parts by weight of the solvent, with respect to 100 parts by weight of the pigment. When the amount of the pigment derivative added is less than 1 part by weight, an anchor effect becomes low, and thus, an effect to lower the viscosity is reduced. When the amount of the pigment derivative added is more than 30 parts by weight, the amount of the pigment derivative added is excess, and unadsorbed pigment derivatives adhere to each other and the inks becomes viscous. When the amount of the resin components is less than 20 parts by weight, the surface of the pigment is not sufficiently coated, and thus, dispersing stability of the pigment becomes lowered. When the amount of the resin components is more than 200 parts by weight, the viscosity of the ink is increased by free resin components which do not adhere to the pigment. When the amount of the solvent added is less than 4 parts by weight, an initial wetting of the pigment with the pigment derivative and the resin components is too insufficient to sufficiently coat the pigment, and thus the viscosity of the ink may be unstable. When the amount of the solvent added is more than 200 parts by weight, the coating treatment of the pigment may be difficult.

The coating treatment of the pigment comprises two steps as follows:

The first step is a chipped step wherein the composition composed of the pigment, the resin components, the solvent and so on is passed through two rolled about 20 times to expedite progress of the wetting of the pigment with the resin components and the adhering the resin components to the pigment. In this step, about 80% by weight of the solvent is vaporized.

The second step is a coating treatment wherein a kneaded product which is the pigment to which the resin components are adhered by the chipping is successively heated and kneaded to thereby form a coating layer on the surface of the pigment particle. When the viscosity is too high to knead on the machine, a suitable amount of the solvent is added to accelerate the kneading.

When the resin components contain a cross-linkable functional group, the resin components are cross-linked and a partial cleavage of the resin is observed in the coating treatment. This reaction is mechanochemical as a result of excessive mechanical pressure and grinding, as well as heating. The cross-linking reaction of the resin components rarely occurs only from the pigment and the resin components. It is assumed that, when the pigment and the resin components are kneaded in the presence of the pigment derivative, the pigment derivative and the resin components are firmly adhered to the surface of the pigment, and the heating and the kneading under pressure cause the cross-linking of the resin components. The heating temperature preferably ranges 80° C. to 120° C. When the temperature is less than 80° C., the cross-linking of the resin components may be insufficient. When the temperature is more than 120° C., the resin components may be deteriorated.

If the surplus resin components which have not adheres to the surface of the pigment affect the properties such as the viscosity of the ink, it is preferable to remove the surplus resin components by washing or filtration. When the coated pigment is not aggregated after dried, it may be washed and then dried. If the solvent used in the coating treatment may be used as the solvent as a liquid medium for the inkjet ink, it is not necessary to dry the coated pigment.

### (8) Properties

A solid content of the ink composition for ink jet recording according to the present invention is preferably 3 to 60% by weight, more preferably 4 to 40% by weight with respect to the total weight of the ink composition. When the solid content is less than 3% by weight, the concentration or resistances of the ink layer is insufficient. When the solid content is more than 60% by weight, the viscosity of the ink is raised and stability with time may be lowered.

The ink composition for ink jet recording according to the present invention is characterized by satisfying the following viscosity properties I and II.

### (Viscosity Property I)

When a concentration of a solid content ranges from 20% by weight to less than 40% by weight, a viscosity [applied only in case that a shear rate is 100 (1/s)] is 3 to 200 (mPa·s), and a T.I. value [the T.I. value is a ratio (ηa/ηb) of a viscosity ηa (mPa·s) at a shear rate of 10 (1/s) to a viscosity ηb (mPa·s) at a shear rate of 1000 (1/s)] is 1 to 2.

### (Viscosity Property II)

When a concentration of a solid content ranges from 40% by weight to 60% by weight, the viscosity [applied only in case that a shear rate is 100 (1/s)] is 10 to 200 (mPa·s), and the T.I. value [the T.I. value is a ratio (ηa/ηb) of a viscosity ηa (mPa·s) at a shear rate of 10 (1/s) to a viscosity ηb (mPa·s) at a shear rate of 1000 (1/s)] is 1 to 3.

The viscosity of the colored resin composition according to the present invention ranges from 2 mPa·s to 40 mPa·s, preferably from 3 mPa·s to 30 mPa·s, more preferably from 4 mPa·s to 20 mPa·s. When the viscosity is too high, it cannot be stably discharged when continuously discharged.

The viscosity of the colored resin composition according to the present invention may vary from 2 to 40 mPa·s, but if the solid content is adjusted from 20% by weight to less than 40% by weight, or from 40% by weight to 60% by weight, the above viscosity properties I and II are satisfied.

When the solid content of the colored resin composition according to the present invention is 40 to 60% by weight, the viscosity is 10 to 200 mPa·s, and the T.I. value is 1 to 4, preferably 1 to 3. The T.I. value is relevant to thixotropic nature, and defined by the following formula (A):

T.I. value=V1/V2

wherein V1 means a viscosity measured when the number of revolutions of a rotor at a rheometer is 10 (1/s), and V2 means a viscosity measured when the number of revolutions of a rotor at a rheometer is 1000(1/s).

In the relationship between the solid content concentration, viscosity, and T.I. value, it is more preferable that the viscosity is 4 to 150 mPa·s, and the thixotropic nature is 1 to 3 when the solid content concentration in the colored resin composition is 40% by weight, and the viscosity is 5 to 100 mPa·s and the thixotropic nature is 1 to 2 when the solid content concentration in the ink is 40% by weight.

An average dispersed particle diameter of the ink composition for ink jet recording according to the present invention is preferably 5 nm to 200 nm, more preferably 10 nm to 150 nm. When the average dispersed particle diameter is too large, a head is liable to be clogged and the ink cannot be stably discharged. When the average dispersed particle diameter is too small, re-aggregation easily occurs and stability with time is deteriorated.

A surface tension of the ink composition for ink jet recording according to the present invention is preferably 20 mN/m to 40 mN/m, more preferably 24 mN/m to 35 mN/m. When the surface tension is too high, the ink cannot be stably discharged from a head. When the surface tension is too low, a droplet of the ink cannot be formed after discharged from a head.

The ink composition for ink jet recording according to the present invention can be prepared by charging the resin dispersant, the pigment, the thermal reactive compound, and the organic solvent, and if necessary, the binder resin and/or the pigment derivative into a usual dispersing device, and dispersing the whole to desired average particle diameter and particle size distribution. The starting materials of the ink composition can be mixed and dispersed collectively, or separately taking into account the properties thereof and economic efficiency. When the viscosity of the ink composition is too high and a dilution is necessary, a liquid medium for diluting an ink stock liquid may be added and homogeneously agitated to thereby prepare the ink composition.

As the dispersing devise, a sand mill, a bead mill, an agitator mill, a dino mill, or a cobol mill is preferable.

When the dispersing device has an appropriate viscosity scope for dispersing the pigment, the viscosity can be adjusted by changing the ratio of the resin components and the pigment. After dispersing the ink composition for ink jet recording in the dispersing device, the product is preferably filtered by a filter or centrifuged to remove oversized particles or foreign substance.

In the preparation of the ink composition for ink jet recording, a surfactant dispersing agent, an anthraquinone derivative, and/or a triazine derivative may also be used. The surfactant dispersing agent is, for example, naphthalenesulfonic acid formalin condensed salt, aromatic sulphonic acid formalin condensed salt, polyoxyethylene alkylphosphoric ester, polyoxyethylenenonylphenyl ether, or stearylamine acetate, or the like.

Various additives may be added to the ink composition for ink jet recording, so long as the viscosity of the ink composition ranges from 2 to 40 mPa·s at 25° C. For example, a surfactant can be added to control the wetting of a substrate with the ink. When a surfactant is select, it is necessary to take into account compatibility with other components constituting the ink. The surfactant includes an anionic surfactant, a cationic surfactant, an amphoteric surfactant, or a nonionic surfactant, and can be appropriately selected.

The ink composition for ink jet recording according to the present invention has a high pigment concentration and at the same time a low viscosity, whereby stability in discharging is excellent, and an amount of the ink discharged can be reduced because the amount of the pigment contained is larger than that in the conventional inkjet ink. Therefore, a productivity and quality can be improved in a printed material such as a substrate for a color filter wherein a high printing concentration is desired.

Particularly, the ink composition for ink jet recording according to the present invention is suitable for preparation of a substrate for a color filter wherein a high productivity and quality are desired.

In the ink composition for ink jet recording according to the present invention, the pigment is dispersed at a high concentration. Therefore, a high printing concentration can be obtained on paper wherein an ink composition penetrates in a depth direction, or on a plastic, glass or metal substrate wherein an ink composition spreads to a lateral direction while wetting. Further, an amount of the ink discharged can be lessened, and therefore, it is possible to prevent the ink from overflowing and blending a color due to an insufficient capacity for receiving an ink in a receiving layer. Furthermore, an insufficient roundness of a dot shape can be remedied. Therefore, the ink composition for ink jet recording according to the present invention can be used in applications to which the conventional inkjet ink is restricted.

### (9) Substrates for a Color Filter

The ink composition for ink jet recording according to the present invention can be used to produce a substrate for a color filter by an inkjet printing method. The substrate for a color filter can be used, for example, in a liquid crystal display panel for a thin-screen television set.

A substrate for a color filter has filter segments of the desired shades, and the filter segments can be formed by discharging the ink composition for a color filter by an inkjet recording method into the areas which has been separated by black matrices formed on the substrate.

A glass plate, or a resin plate of, for example, polycarbonate, polymethyl methacrylate, or polyethylene terephthalate may be used as the substrate. The black matrices can be formed on the substrate by, for example, a photolithographic method comprising coating a radical polymerizing black resist, exposing, developing and patterning, a printing method comprising printing a black ink, or an evaporation method comprising evaporating metal and etching.

### EXAMPLES

The present invention now will be further illustrated by, but is by no means limited to, the following Examples.

The term “parts” denotes parts by weight, and the term “%” denotes % by weight. The weight average molecular weight is a molecular weight corresponding to that of polystyrene which is measured by a GPC (manufactured by TOSOH Corporation, HLC-8120GPC) equipped with a detector, using a TSKGEL column (manufactured by TOSOH Corporation) and THF as a developing solvent.

### (1-1) Urethane-Based Dispersants

In the first place, Manufacturing Examples of the urethane-based dispersants will be explained hereinafter.

### Preparation Example I-1

To a reacting apparatus equipped with a gas supplying tube, a condenser, an agitating fan, and a thermometer, 67 parts of 1-decanol and 433 parts of ε-caprolactone were charged. After the air in a reaction vessel was displaced by a nitrogen gas, the reaction was carried out at 120° C. for 2 hours. After the reaction was completed, the product was diluted with 214 parts of methoxypropyl acetate to obtain a polycaprolactone solution (I-MC).

### Preparation Example I-2

To a reacting apparatus equipped with a gas supplying tube, a condenser, an agitating fan, and a thermometer, 250 parts of butyl methacrylate and 250 parts of benzyl methacrylate 250 parts were charged. After the air in a reaction vessel was displaced by a nitrogen gas, the whole was heated to 80° C. Then, 138 parts of 2-mercaptoethano was added dropwise over 10 minutes, and the reaction was carried out for 7 hours. After the reaction was completed, the product was diluted with 214 parts of methoxypropyl acetate to obtain an acrylic resin solution (1-MA).

### Preparation Example I-3

To a reacting apparatus equipped with a gas supplying tube, a condenser, an agitating fan, and a thermometer, 250 parts of butyl methacrylate and 250 parts of benzyl methacrylate were charged. After the air in a reaction vessel was displaced by a nitrogen gas, the whole was heated to 80° C. Then, 38 parts of thioglycerol (Asahi Chemical Co., Ltd.) was added dropwise over 10 minute, the reaction was carried out for 7 hours. After the reaction was completed, the product was diluted with 214 parts of methoxypropyl acetate to obtain an acrylic resin solution (I-DA).

### Manufacturing Example I-1 of Branched Urethane Resin Dispersant (I-U)

To a reacting apparatus equipped with a gas supplying tube, a condenser, an agitating fan, and a thermometer, 53 parts of polycaprolactone solution (I-MC), 67 parts of VESTANAT T 1890/100 (Degussa Japan Co., Ltd.), 55 parts acrylic resin solution (I-DA), and 103 parts of methoxypropyl acetate were charged. After the air in a reaction vessel was displaced by a nitrogen gas, the whole was heated to 80° C., and the reaction was carried out for 1 hour. Then, 27 parts of dimethylolbutanoic acid (DMBA, manufactured by Nippon Kasei Chemical Co., Ltd.) and 27 parts of methoxypropyl acetate were charged, and the reaction was carried out at 90° C. After the disappearance of the peak at 2270 cm⁻¹ based on the isocyanate group was confirmed by IR, the whole was cooled to 40° C. to obtain a branched urethane resin dispersant solution (I-U-1).

### Manufacturing Examples I-2 to I-7 of Branched Urethane Resin Dispersants (I-U)

The procedure described in Manufacturing Example I-1 was repeated, except that the compositions shown in Table 2 were used, to obtain branched urethane resin dispersant solutions (I-U), namely, (I-U-2) to (I-U-7).

TABLE 2

| | I-U-1 | I-U-2 | I-U-3 | I-U-4 | I-U-5 | I-U-6 | I-U-7 |
|---|---|---|---|---|---|---|---|
| VESTANAT T 1890/100 | 53 | 71 | 55 | 71 | 46 | 93 | 30 |
| Polycaprolactone solution (I-MC) | 67 | | | | | | |
| <M.E. (*1) I-1> | | | | | | | |
| Blemmer PP-1000 | | 56 | | | | 90 | 90 |
| Acrylic resin solution (I-MA) | | | 65 | | | | |
| <M.E. I-2> | | | | | | | |
| FM-0411 | | | | 56 | | | |
| Benzyl alcohol | | | | | 4 | 8 | 2 |
| DMBA | 27 | 43 | 27 | 43 | 16 | 56 | |
| Acrylic resin solution (I-DA) | 55 | | 57 | | 121 | | 189 |
| <M.E. I-3> | | | | | | | |
| PGMAc | 128 | 168 | 130 | 168 | 114 | | 108 |
| VESTANAT T 1890/100 | 32% | 43% | 33% | 43% | 31% | 59% | 18% |
| (wt % with respect to resin) | | | | | | | |
| Weight average | 12000 | 23000 | 11000 | 16000 | 19000 | 18000 | 12000 |
| molecular weight | | | | | | | |
| Acid value | 61 | 97 | 62 | 97 | 41 | 135 | 0 |
| Solid content (%) | 50% | 50% | 50% | 50% | 50% | 100% | 50% |

(*1): M.E. = Manufacturing Example
VESTANAT T 1890/100: IPDI (isophorone diisocyanate) trimer (manufactured by Degussa Japan Co., Ltd.)
Blemmer PP-1000: polypropylene glycolmonomethacrylate (manufactured by NOF Corporation)
FM-0411: one-terminal-monoalcohol-containing polysiloxane (manufactured by Chisso Corporation)
Benzyl alcohol: manufactured by Wako Pure Chemical Industries, Ltd.
DMBA: dimethylolbutanoic acid (Nippon Kasei Chemical Co., Ltd.)

### (I-2) Vinyl-Based Dispersants

Manufacturing Examples of the vinyl-based resins will be explained hereinafter.

### Manufacturing Example I-1 of Vinyl-Based Dispersant (Resin I-B-1)

To a reacting chamber equipped with a gas supplying tube, a condenser, an agitating fan, and a thermometer, 60 parts of methoxypropyl acetate was charged, then the whole was heated to 110° C. After the air in a reaction vessel was displaced by a nitrogen gas, a liquid mixture which had been prepared by uniformly mixing 40 parts of n-butyl methacrylate, 50 parts of benzyl methacrylate, 5 parts of 2-hydroxyethyl methacrylate, 5 parts of methacrylic acid, 40 parts of methoxypropyl acetate and 5 parts of dimethyl-2,2′-azobisdiisobutyrate was added dropwise over 2 hours from a dripping vessel. The stirring was continued at the same temperature for 3 hours to complete the reaction. Consequently, vinyl-based resin (I-B1) having a number average molecular weight of 12000 was obtained. A ratio of a solid content in the vinyl-based resin (I-B1) was 50%.

### (1-3) Pigment Derivatives

Further, the pigment derivatives having properties shown in Table 3 were prepared in accordance with a conventional method, as the pigment derivative of the general formula (1).

TABLE 3

| | Pigment | Pigment |
|---|---|---|
| | Derivative A | Derivative B |
| P | Quinacridone | Copper |
| | | phthalocyanine |
| X | —SO₂— | —SO₂— |
| Y | —NH— | —NH— |
| Z | Propylene group | Propylene group |
| R⁴ | Butyl group | Ethyl group |
| R⁵ | Butyl group | Ethyl group |
| v | 1 | 1 |

### (1-4) Pigment-Dispersed Products

Then, the pigment-dispersed products I-A to I-H were prepared from the compositions shown in the Table 4. More particularly, the pigment, the pigment derivative and the dispersing agent were incorporated to the organic solvent, and agitated by a high-speed mixer or the like until uniformly mixed. The resulting milled base was dispersed for about 1 hour in a horizontal sand mill.

TABLE 4

| | | Dispersed | Dispersed | Dispersed | Dispersed | Dispersed | Dispersed | Dispersed | Dispersed |
|---|---|---|---|---|---|---|---|---|---|
| | | product | product | product | product | product | product | product | product |
| | | I-A | I-B | I-C | I-D | I-E | I-F | I-G | I-H |
| Pigment | | E5B02 | E5B02 | E5B02 | FG7351 | FG7351 | E5B02 | FG7351 | E5B02 |
| Pigment | | A | A | A | B | B | A | B | A |
| derivative | | | | | | | | | |
| Dispersing | | I-U-1 | I-U-2 | I-U-3 | I-U-4 | I-U-5 | I-U-6 | I-U-7 | I-B-1 |
| agent | | | | | | | | | |
| Solvent | | BGAc | BGAc | BGAc | BGAc | BGAc | BGAc | BGAc | BGAc |
| Ratio of components | Pigment | 25 | 25 | 25 | 35 | 35 | 25 | 35 | 25 |
| | Derivative | 1.5 | 1.5 | 1.5 | 5 | 5 | 1.5 | 5 | 1.5 |
| | Dispersing | 7.5 | 7.5 | 7.5 | 10.5 | 10.5 | 7.5 | 10.5 | 10 |
| | agent | | | | | | | | |
| | Solvent | 66 | 66 | 66 | 49.5 | 49.5 | 66 | 49.5 | 63.5 |

Abbreviations in Table 4
E5B02; quinacridone pigment, Hostaperm Red E5B 02 (manufactured by Clariant K.K.)
FG7351; phthalocyanine pigment, Lionol Blue FG-7351 (manufactured by TOYO INK MFG. Co., Ltd.)
BGAc; ethyleneglycol monobutylether acetate

### Example I-1

An inkjet ink was prepared from the following components including the above pigment-dispersed product I-A.
Pigment-dispersed product I-A: 20.0 parts
Vinyl resin VYHD (manufactured by Dow Chemical Company; vinyl chloride-vinyl acetate resin: 5.0 parts
Cyclohexanone: 20.0 parts
Diethyleneglycol monoethylether acetate: 10.0 parts
Ethyleneglycol monobutylether acetate: 45.0 parts

### Example I-2

The procedure described in Example I-1 was repeated to use the formulation ingredients thereof, except that the pigment-dispersed product I-B was used instead of the pigment-dispersed product I-A, to obtain an inkjet ink.

### Example I-3

The procedure described in Example I-1 was repeated to use the formulation ingredients thereof, except that the pigment-dispersed product I-C was used instead of the pigment-dispersed product I-A, to obtain an inkjet ink.

### Example I-4

An inkjet ink was prepared from the following components including the above pigment-dispersed product I-D.
Pigment-dispersed product I-D: 12.0 parts
Vinyl resin VYHD (manufactured by Dow Chemical Company; vinyl chloride-vinyl acetate resin): 6.0 parts
Cyclohexanone: 20.0 parts
Diethyleneglycol monoethylether acetate: 10.0 parts
Ethyleneglycol monobutylether acetate: 52.0 parts

### Example I-5

The procedure described in Example I-4 was repeated to use the formulation ingredients thereof, except that the pigment-dispersed product I-E was used instead of the pigment-dispersed product I-D, to obtain an inkjet ink.

### Comparative Example I-1

The procedure described in Example I-1 was repeated to use the formulation ingredients thereof, except that the pigment-dispersed product I-F was used instead of the pigment-dispersed product I-A, to obtain an inkjet ink.

### Comparative Example I-2

The procedure described in Example I-4 was repeated to use the formulation ingredients thereof, except that the pigment-dispersed product I-G was used instead of the pigment-dispersed product I-D, to obtain an inkjet ink.

### Comparative Example I-3

The procedure described in Example I-1 was repeated to use the formulation ingredients thereof, except that the pigment-dispersed product I-H was used instead of the pigment-dispersed product I-A, to obtain an inkjet ink.

### [Evaluation of Properties]

The inkjet inks prepared in Examples I-1 to I-5 and Comparative Examples I-1 to I-3 were evaluated as to (1) a dispersed particle diameter as an index of dispersing properties, (2) a viscosity as an index of flowability, (3) a discharging condition as an index of stability in printing.

### (1) Dispersed Particle Diameter:

The inkjet ink was diluted to 200 to 1000-fold volume with ethyl acetate, and then a dispersed particle diameter was measured by the Particle Size Analyzer, Microtrac UPA150 manufactured by Nikkiso Co., Ltd.

### (2) Viscosity:

The temperature of the inkjet ink was adjusted at 25° C., and then a viscosity was measured by the Meodel E viscometer RE80 (manufactured by Toki Sangyo Co., Ltd.).

### (3) Stability in Printing:

The inkjet ink was used in printing by a wideformat inkjet printer, IP-6500 (manufactured by Seiko I Infotech Inc.), and then, the printed result on a nozzle check pattern was observed. When printing defects such as nozzle lacking or bending were no more than 1%, the grade was evaluated as ◯. When the printing defects were 1 to 10%, the grade was evaluated as Δ. When the printing defects were more than 10%, the grade was evaluated as x.

The results of the evaluation were shown in the following Table 5.

TABLE 5

| | Example | Example | Example | Example | Example | C. E. (*1) | C. E. (*1) | C. E. (*1) |
|---|---|---|---|---|---|---|---|---|
| | I-1 | I-2 | I-3 | I-4 | I-5 | I-1 | I-2 | I-3 |
| Dispersed | 230 | 245 | 225 | 153 | 155 | 325 | 220 | 550 |
| particle | | | | | | | | |
| Diameter | | | | | | | | |
| (nm) | | | | | | | | |
| Viscosity | 12.1 | 11.8 | 11.5 | 10.8 | 10.5 | 22.3 | 18.3 | 52 |
| (mPa · s) | | | | | | | | |
| Stability | ◯ | ◯ | ◯ | ◯ | ◯ | Δ | Δ | X |
| in | | | | | | | | |
| printing | | | | | | | | |

(*1): C.E. = Comparative Example

The inkjet inks prepared in Examples I-1 to I-5 exhibited the values suitable for an inkjet ink about the viscosity and the dispersed particle diameter, and thus, exhibited an excellent stability in printing. On the other hand, the inkjet inks of Comparative Examples I-1 and I-2 could be discharged, but the printing defects were as high as 5 to 10%, due to a high viscosity. The inkjet ink of Comparative Example I-3 had a high viscosity and a large dispersed particle diameter, and thus, could hardly be discharged from a printer head.

### (II-1) Urethane-Based Dispersants

Manufacturing Examples of the urethane-based dispersants will be mentioned below.

### Preparation Example II-1

To a reacting apparatus equipped with a gas supplying tube, a condenser, an agitating fan, and a thermometer, 67 parts of 1-decanol, and 433 parts of ε-caprolactone were charged. After the air in a reaction vessel was displaced by a nitrogen gas, the reaction was carried out at 120° C. for 2 hours. After the reaction was completed, the product was diluted with 14 parts of methoxypropyl acetate to obtain a polycaprolactone solution (II-MC).

### Preparation Example II-2

To a reacting apparatus equipped with a gas supplying tube, a condenser, an agitating fan, and a thermometer, 250 parts of butyl methacrylate and 250 parts of benzyl methacrylate were charged. After the air in a reaction vessel was displaced by a nitrogen gas, the whole was heated to 80° C. Then, 138 parts of 2-mercaptoethano was added dropwise over 10 minutes, the reaction was carried out for 7 hours. After the reaction was completed, the product was diluted with 214 parts of methoxypropyl acetate to obtain an acrylic resin solution (II-MA).

### Preparation Example II-3

To a reacting apparatus equipped with a gas supplying tube, a condenser, an agitating fan, and a thermometer, 250 parts of butyl methacrylate and 250 parts of benzyl methacrylate were charged. After the air in a reaction vessel was displaced by a nitrogen gas, the whole was heated to 80° C. Then, 38 parts of thioglycerol (Asahi chemical co., Ltd.) was added dropwise over 10 minutes, the reaction was carried out for 7 hours. After the reaction was completed, the product was diluted with 214 parts of methoxypropyl acetate to obtain acrylic resin solution (II-DA).

### Manufacturing Example II-1 of Branched Urethane Resin Dispersant (II-U)

To a reacting apparatus equipped with a gas supplying tube, a condenser, an agitating fan, and a thermometer, 84 parts of polycaprolactone solution (II-MC), 66 parts of VESTANAT T 1890/100 (Degussa Japan Co., Ltd.), and 100 parts of methoxypropyl acetate were charged. After the air in a reaction vessel was displaced by a nitrogen gas, the whole was heated to 80° C., and the reaction was carried out for 1 hour. Then, 40 parts of dimethylolbutanoic acid (DMBA, manufactured by Nippon Kasei Chemical Co., Ltd.) and 40 parts of methoxypropyl acetate were charged, and the reaction was carried out at 90° C. After the disappearance of the peak at 2270 cm⁻¹ based on the isocyanate group was confirmed by IR, 6 parts of pyromellitic dianhydride and 6 parts of methoxypropyl acetate were charged, and the reaction was carried out at 100° C. After the disappearance of the peak at 1855 cm⁻¹ and 1785 cm⁻¹ based on the acid anhydride group was confirmed by IR, the whole was cooled to 40° C. to obtain a branched urethane resin dispersant solution (II-U-1).

### Manufacturing Examples II-2 to II-7 of Branched Urethane Resin Dispersants (II-U)

The procedure described in Manufacturing Example II-1 was repeated, except that the compositions shown in Table 6 were used, to obtain branched urethane resin dispersant solutions (II-U), namely, (II-U-2) to (II-U-7).

### Manufacturing Example II-8 of Branched Urethane Resin Dispersant (II-U8)

To a reacting apparatus equipped with a gas supplying tube, a condenser, an agitating fan, and a thermometer, 4 parts of one-terminal-monoalcohol-containing polysiloxane FM-0041 (manufactured by Chisso Corporation), 46 parts of VESTANAT T 1890/100 and 125 parts of methoxypropyl acetate were charged. After the air in a reaction vessel was displaced by a nitrogen gas, the whole was heated to 80° C., and the reaction was carried out for 1 hour. Then, 121 parts of acrylic resin (II-DA), 11 parts of neopentyl glycol, and 96 parts of methoxypropyl acetate were charged, and the reaction was carried out at 90° C. After the disappearance of the peak at 2270 cm⁻¹ based on the isocyanate group was confirmed by IR, the whole was cooled to 40° C. to obtain a branched urethane resin dispersant solution (II-U8).

TABLE 6

| | II-U-1 | II-U-2 | II-U-3 | II-U-4 | II-U-5 | II-U-6 | II-U-7 | II-U-8 |
|---|---|---|---|---|---|---|---|---|
| VESTANAT T 1890/100 | 66 | 71 | 68 | 71 | 57 | 61 | 93 | 46 |
| Polycaprolactone | 84 | | | | | | | |
| solution (II-MC) | | | | | | | | |
| <M.E. (*1) II-1> | | | | | | | | |
| Blemmer PP-1000 | | 56 | | | | | | |
| Acrylic resin solution | | | 81 | | | | | |
| (II-MA) | | | | | | | | |
| <M.E. (*1) II-2> | | | | | | | | |
| FM-0411 | | | | 56 | | | 12 | 6 |
| Viscoat #300 | | | | | 13 | | | |
| OXT-101 | | | | | | 4 | | |
| DMBA | 40 | 43 | 41 | 43 | 34 | 37 | 56 | |
| Neopentyl glycol | | | | | | | | 11 |
| Acrylic resin solution | | | | | 59 | 64 | | 121 |
| (II-DA) | | | | | | | | |
| Pyromellitic dianhydride | 6 | 6 | 6 | 6 | 9 | 9 | 8 | |
| PGMAc | 145 | 174 | 147 | 168 | 144 | 156 | 160 | 144 |
| VESTANAT T 1890/100 | 39% | 41% | 108% | 41% | 38% | 39% | 57% | 32% |
| (wt % with respect to | | | | | | | | |
| resin) | | | | | | | | |
| Weight average | 32000 | 3000 | 35000 | 29000 | 18900 | 16000 | 15600 | 8700 |
| molecular weight | | | | | | | | |
| Acid value | 106 | 112 | 108 | 112 | 116 | 120 | 154 | 71 |
| Solid content (%) | 50% | 50% | 50% | 50% | 50% | 50% | 50% | 50% |

(*1): M.E. = Manufacturing Example
VESTANAT T 1890/100: IPDI trimer (manufactured by Degussa Japan Co., Ltd.)
Blemmer PP-1000: polypropylene glycolmonomethacrylate (manufactured by NOF Corporation)
FM-0411: one-terminal-monoalcohol-containing polysiloxane (manufactured by Chisso Corporation)
Viscoat #300: pentaerythritol triacrylate (manufactured by Osaka Organic Chemical Industry Ltd.)
OXT-101: oxetane alcohol (manufactured by Toagosei Co., Ltd.)
DMBA: dimethylolbutanoic acid (manufactured by Nippon Kasei Chemical Co., Ltd.)
Neopentyl glycol (manufactured by Wako Pure Chemical Industries, Ltd.)
Pyromellitic dianhydride (manufactured by Wako Pure Chemical Industries, Ltd.)

### (II-2) Vinyl-Based Dispersants

Manufacturing Examples of the vinyl-based resins will be explained hereinafter.

### Manufacturing Example II-9 (Resin II-B1)

To a reacting chamber equipped with a gas supplying tube, a condenser, an agitating fan, and a thermometer, 60 parts of methoxypropyl acetate was charged, then the whole was heated to 110° C. After the air in a reaction vessel was displaced by a nitrogen gas, a liquid mixture which had been prepared by uniformly mixing 40 parts of n-butyl methacrylate, 50 parts of benzyl methacrylate, 5 parts of 2-hydroxyethyl methacrylate, 5 parts of methacrylic acid, 40 parts of methoxypropyl acetate and 5 parts of dimethyl-2,2′-azobispolysiloxane was added dropwise over 2 hours from a dripping vessel. The stirring was continued at the same temperature for 3 hours to complete the reaction. Consequently, vinyl-based resin (I-B1) having a number average molecular weight of 12000 was obtained. A ratio of solid content in the vinyl-based resin (II-B1) was 50%.

### (II-3) Pigment-Dispersed Products

Then, the pigment-dispersed products II-A to II-I was prepared from the compositions shown in the Table 7. More particularly, the pigment, the pigment derivative and the dispersing agent were incorporated to the organic solvent, and agitated by a high-speed mixer or the like until uniformly mixed. The resulting milled base was dispersed for about 1 hour in a horizontal sand mill.

TABLE 7

| | | Dispersed | Dispersed | Dispersed | Dispersed | Dispersed | Dispersed | Dispersed | Dispersed | Dispersed |
|---|---|---|---|---|---|---|---|---|---|---|
| | | product | product | product | product | product | product | product | product | product |
| | | II-A | II-B | II-C | II-D | II-E | II-F | II-G | II-H | II-I |
| Pigment | | E5B02 | E5B02 | E5B02 | FG7351 | FG7351 | E5B02 | FG7351 | E5B02 | E5B02 |
| Pigment | | A | A | A | B | B | A | B | A | A |
| derivative | | | | | | | | | | |
| Dispersing | | II-U-1 | II-U-2 | II-U-3 | II-U-4 | II-U-5 | II-U-6 | II-U-7 | II-U-8 | II-B-1 |
| agent | | | | | | | | | | |
| Solvent | | BGAc | BGAc | BGAc | BGAc | BGAc | BGAc | BGAc | BGAc | BGAc |
| Ratio of | Pigment | 25 | 25 | 25 | 35 | 35 | 25 | 35 | 30 | 25 |
| components | Derivative | 1.5 | 1.5 | 1.5 | 5 | 5 | 1.5 | 5 | 1.5 | 1.5 |
| | Dispersing | 7.5 | 7.5 | 7.5 | 10.5 | 10.5 | 7.5 | 10.5 | 10 | 10 |
| | agent | | | | | | | | | |
| | Solvent | 66 | 66 | 66 | 49.5 | 49.5 | 66 | 49.5 | 58.5 | 63.5 |

Abbreviations in Table 7
E5B02; quinacridone pigment, Hostaperm Red E5B 02 (manufactured by Clariant K.K.)
FG7351; phthalocyanine pigment, Lionol Blue FG-7351 (manufactured by TOYO INK MFG. CO., Ltd.)
BGAc; ethyleneglycol monobutylether acetate

### Example II-1

An inkjet ink was prepared from the following components including the above pigment-dispersed product II-A.
Pigment-dispersed product II-A: 20.0 parts
Vinyl resin VYHD (manufactured by Dow Chemical Company; vinyl chloride-vinyl acetate resin): 5.0 parts
Cyclohexanone: 20.0 parts
Diethyleneglycol monoethylether acetate: 10.0 parts
Ethyleneglycol monobutylether acetate: 45.0 parts

### Example II-2

The procedure described in Example II-1 was repeated to use the formulation ingredients thereof, except that the pigment-dispersed product II-B was used instead of the pigment-dispersed product II-A, to obtain an inkjet ink.

### Example II-3

The procedure described in Example II-1 was repeated to use the formulation ingredients thereof, except that the pigment-dispersed product II-C was used instead of the pigment-dispersed product II-A, and the similar components was used to obtain an inkjet ink.

### Example II-4

An inkjet ink was prepared from the following components including the above pigment-dispersed product II-D.
Pigment-dispersed product II-D: 12.0 parts
Vinyl resin VMCA (manufactured by Dow Chemical Company; vinyl chloride-vinyl acetate resin): 6.0 parts
Cyclohexanone: 20.0 parts
Diethyleneglycol monobutylether acetate: 10.0 parts
Ethyleneglycol monobutylether acetate: 52.0 parts

### Example II-5

The procedure described in Example II-4 was repeated to use the formulation ingredients thereof, except that the pigment-dispersed product II-E was used instead of the pigment-dispersed product II-D, to obtain an inkjet ink.

### Example II-6

The procedure described in Example II-4 was repeated to use the formulation ingredients thereof, except that the pigment-dispersed product II-F was used instead of the pigment-dispersed product II-D, to obtain an inkjet ink.

### Example II-7

The procedure described in Example II-4 was repeated, except that the pigment-dispersed product II-G was used instead of the pigment-dispersed product II-D, and the similar components was used to obtain an inkjet ink.

### Example II-8

An inkjet ink was prepared from the following components including the above pigment-dispersed product II-H.
Pigment-dispersed product II-H, 12.0 parts
Vinyl resin VMCA (manufactured by Dow Chemical Company; vinyl chloride-vinyl acetate resin): 6.0 parts
N-methyl-2-pyrrolidone: 20.0 parts
Diethyleneglycol monobutylether acetate: 10.0 parts
Ethyleneglycol monobutylether acetate: 52.0 parts

### Comparative Example II-1

The procedure described in Example II-1 was repeated to use the formulation ingredients thereof, except that the pigment-dispersed product II-I was used instead of the pigment-dispersed product II-A, to obtain an inkjet ink.

### Comparative Example II-2

The procedure described in Example II-4 was repeated to use the formulation ingredients thereof, except that the pigment-dispersed product II-I was used instead of the pigment-dispersed product II-D, to obtain an inkjet ink.

### Comparative Example II-3

The procedure described in Example II-8 was repeated to use the formulation ingredients thereof, except that the pigment-dispersed product II-I was used instead of the pigment-dispersed product II-H, to obtain an inkjet ink.

### [Evaluation of Properties]

The inkjet inks prepared in Examples II-1 to II-8 and Comparative Examples II-1 to II-3 were evaluated as to (1) a dispersed particle diameter as an index of dispersing properties, (2) a viscosity as an index of flowability, (3) a discharging condition as an index of stability in printing, in accordance with the methods as mentioned above.

The results of the evaluation were shown in the following Table 8.

TABLE 8

| | | | | | | | | | C. E. | | |
|---|---|---|---|---|---|---|---|---|---|---|---|
| | Example | Example | Example | Example | Example | Example | Example | Example | (*1) | C. E. (*1) | C. E. (*1) |
| | II-1 | II-2 | II-3 | II-4 | II-5 | II-6 | II-7 | II-8 | II-1 | II-2 | II-3 |
| Dispersed | 230 | 245 | 225 | 153 | 155 | 201 | 147 | 212 | 325 | 220 | 550 |
| particle | | | | | | | | | | | |
| diameter | | | | | | | | | | | |
| (nm) | | | | | | | | | | | |
| Viscosity | 12.1 | 11.8 | 11.5 | 10.8 | 10.5 | 12.1 | 10.4 | 11.7 | 22.3 | 18.3 | 52 |
| (mPa · s) | | | | | | | | | | | |
| Stability | ◯ | ◯ | ◯ | ◯ | ◯ | ◯ | ◯ | ◯ | Δ | Δ | X |
| in | | | | | | | | | | | |
| printing | | | | | | | | | | | |

(*1): C.E. = Comparative Example

The inkjet inks prepared in Examples II-1 to II-8 exhibited the values suitable for an inkjet ink about the viscosity and the dispersed particle diameter, and thus, exhibited an excellent stability in printing. On the other hand, the inkjet inks of Comparative Examples II-1 and II-2 could be discharged, but the printing defects were as high as 5 to 10%, due to a high viscosity. The inkjet ink of Comparative Example II-3 had a high viscosity and a large dispersed particle diameter, and thus, could hardly be discharged from a printer head.

### [Ink Compositions]

Pigments, pigment derivatives, solvents and resin dispersants used in the following Examples and Comparative Examples will be explained hereinafter. Further, the final ink compositions in the following Examples and Comparative Examples will be shown in the following Tables (Examples and Comparative Examples).

### (III-1) Pigments

Red pigment: C.I. Pigment Red 254 (manufactured by Ciba Specialty Chemicals, IRGAPHORRED B-CF)
Red pigment-2: C.I. Pigment Red 177 (manufactured by Ciba Specialty Chemicals, Chromophtal Red A2B)
Green pigment: C.I. Pigment Green 36 (manufactured by TOYO INK MFG. Co., Ltd., Lionol Green 6YK)
Blue pigment: C.I. Pigment Blue 15:6 (manufactured by TOYO INK MFG. Co., Ltd., Lionol Blue E)
Yellow pigment: C.I. Pigment Yellow 138 (manufactured by TOYO INK MFG. Co., Ltd., Lionogen Yellow 1010)
Magenta pigment: C.I. Pigment Red 122 (manufactured by TOYO INK MFG. Co., Ltd., Lionogen Magenta 5750)
Cyan pigment: C.I. Pigment Blue 15:3 (manufactured by TOYO INK MFG. Co., Ltd., Lionol Blue FG-7351)
Violet pigment: C.I. Pigment Violet 23 (manufactured by

### Clariant GmbH; Hostaperm Violet RL-NF)

### (III-2) Pigment Derivatives:

### Pigment Derivative [1] (for Red)

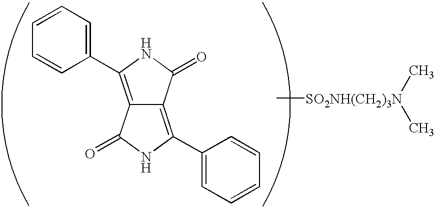

### Pigment Derivative [2] (for Green, for Blue, for Cyan)

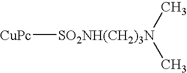

### Pigment Derivative [3] (for Yellow)

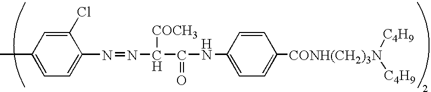

### Pigment Derivative [4] (for Magenta)

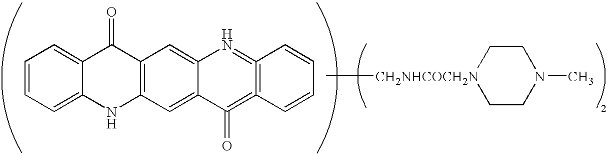

### Pigment Derivative [5] (for Red-2)

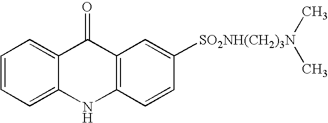

### Pigment Derivative [6] (for Violet)

### (III-3) Solvent

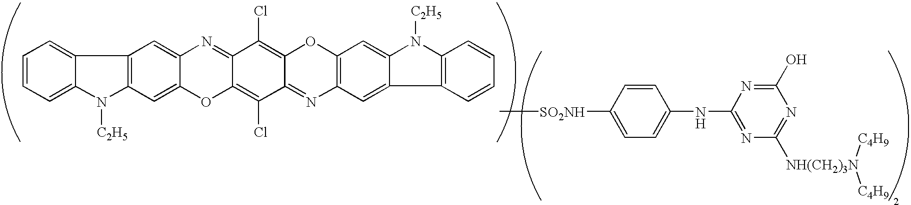

CBAc: diethyleneglycol monoethylether acetate
BuCBAc: diethyleneglycol monobutylether acetate
PGMAc: propyleneglycol monomethylether acetate

### (III-4) Urethane-Based Dispersants

Manufacturing Examples of the urethane-based dispersants will be explained hereinafter.

### Preparation Example III-1

To a reacting apparatus equipped with a gas supplying tube, a condenser, an agitating fan, and a thermometer, 67 parts of 1-decanol and 433 parts of ε-caprolactone were charged. After the air in a reaction vessel was displaced by a nitrogen gas, the reaction was carried out at 120° C. for 2 hours. After the reaction was completed, the product was diluted with 214 parts of methoxypropyl acetate to obtain a polycaprolactone solution (III-MC).

### Preparation Example III-2

To a reacting apparatus equipped with a gas supplying tube, a condenser, an agitating fan, and a thermometer, 250 parts of butyl methacrylate and 250 parts of benzyl methacrylate were charged. After the air in a reaction vessel was displaced by a nitrogen gas, the whole was heated to 80° C. Then, 38 parts of 2-mercaptoethanol was added dropwise over 10 minutes, the reaction was carried out for 7 hours. After the reaction was completed, the product was diluted with 214 parts of methoxypropyl acetate to obtain an acrylic resin solution (III-MA).

### Preparation Example III-3

To a reacting apparatus equipped with a gas supplying tube, a condenser, an agitating fan, and a thermometer, 250 parts of butyl methacrylate and 250 parts of benzyl methacrylate were charged. After the air in a reaction vessel was displaced by a nitrogen gas, the whole was heated to 80° C. Then, 38 parts of thioglycerol (Asahi Chemical Co., Ltd.) was added dropwise over 10 minutes, the reaction was carried out for 7 hours. After the reaction was completed, the product was diluted with 214 parts of methoxypropyl acetate to obtain an acrylic resin solution (III-DA).

### Manufacturing Example III-1 of Branched Urethane Resin Dispersant (III-U)

To a reacting apparatus equipped with a gas supplying tube, a condenser, an agitating fan, and a thermometer, 53 parts of polycaprolactone solution (III-MC), 67 parts of VESTANAT T 1890/100 (Degussa Japan Co., Ltd.), 55 parts of acrylic resin solution (III-DA) and 103 parts of methoxypropyl acetate were charged. After the air in a reaction vessel was displaced by a nitrogen gas, the whole was heated to 80° C., and the reaction was carried out for 1 hour. Then, 27 parts of dimethylolbutanoic acid (DMBA, manufactured by Nippon Kasei Chemical Co., Ltd.) and 27 parts of methoxypropyl acetate were charged, and the reaction was carried out at 90° C. After the disappearance of the peak at 2270 cm⁻¹ based on the isocyanate group was confirmed by IR, the whole was cooled to 40° C. to obtain a branched urethane resin dispersant solution (III-U1).

### Manufacturing Examples III-2 to III-7 of Branched Urethane Resin Dispersants (III-U)

The procedure described in Manufacturing Example III-1 was repeated, except that the compositions shown in Table 9 were used, to obtain branched urethane resin dispersant solutions (III-U), namely, (III-U-2) to (III-U-7).

TABLE 9

| | III-U-1 | III-U-2 | III-U-3 | III-U-4 | III-U-5 | III-U-6 | III-U-7 |
|---|---|---|---|---|---|---|---|
| VESTANAT T 1890/100 | 53 | 71 | 55 | 71 | 46 | 93 | 30 |
| Polycaprolactone | 67 | | | | | | |
| solution (III-MC) | | | | | | | |
| <M.E. (*1) III-1> | | | | | | | |
| Blemmer PP-1000 | | 56 | | | | 90 | 90 |
| Acrylic resin solution | | | 65 | | | | |
| (III-MA) | | | | | | | |
| <M.E. (*1) III-2> | | | | | | | |
| FM-0411 | | | | 56 | | | |
| Benzyl alcohol | | | | | 4 | 8 | 2 |
| DMBA | 27 | 43 | 27 | 43 | 16 | 56 | |
| Acrylic resin solution | 55 | | 57 | | 121 | | 189 |
| (III-DA) | | | | | | | |
| <M.E. (*1) III-3> | | | | | | | |
| PGMAc | 128 | 168 | 130 | 168 | 114 | | 108 |
| VESTANAT T 1890/100 | 32% | 43% | 33% | 43% | 31% | 59% | 18% |
| (wt % with respect | | | | | | | |
| to resin) | | | | | | | |
| Weight average | 12000 | 23000 | 11000 | 16000 | 19000 | 18000 | 12000 |
| molecular weight | | | | | | | |
| Acid value | 61 | 97 | 62 | 97 | 41 | 135 | 0 |
| Solid content (%) | 50% | 50% | 50% | 50% | 50% | 100% | 50% |

(*1): M.E. = Manufacturing Example
VESTANAT T 1890/100: IPDI trimer (manufactured by Degussa Japan Co., Ltd.)
Blemmer PP-1000: polypropyleneglycol monomethacrylate (manufactured by NOF Corporation)
FM-0411: one-terminal-monoalcohol-containing polysiloxane (manufactured by Chisso Corporation)
Benzyl alcohol: manufactured by Wako Pure Chemical Industries, Ltd.
DMBA: dimethylolbutanoic acid (manufactured by Nippon Kasei Chemical Co., Ltd.)

### (III-5) Vinyl-Based Resins

Manufacturing Examples of the vinyl-based resins will be explained hereinafter.

### Manufacturing Example III-8 (Resin III-B1)

To a reacting chamber equipped with a gas supplying tube, a condenser, an agitating fan, and a thermometer, 60 parts of methoxypropyl acetate was charged, and then heated to 110° C. After the air in a reaction vessel was displaced by a nitrogen gas, a liquid mixture which had been prepared by uniformly mixing 40 parts of n-butyl methacrylate, 50 parts of benzyl methacrylate, 5 parts of 2-hydroxyethyl methacrylate, 5 parts of methacrylic acid, 40 parts of methoxypropyl acetate and 5 parts of dimethyl-2,2′-azobispolysiloxane was added dropwise over 2 hours from a dripping vessel. The stirring was continued at the same temperature for 3 hours to complete the reaction. Consequently, vinyl-based resin (III-B1) having a number average molecular weight of 12000 was obtained. A ratio of solid content in the vinyl-based resin (III-B1) was 50%.

### (III-6) Melamine Resins

Nikalac MX-43: alkoxyalkyl group-containing melamine resin manufactured by Sanwa Chemical Co., Ltd.

Nikalac MS-001: imino methylol group-containing melamine resin manufactured by Sanwa Chemical Co., Ltd.

### (III-7) Benzoguanamine Resins

Nikalac SB-401: alkoxyalkyl group-containing benzoguanamine resin manufactured by Sanwa Chemical Co., Ltd.

Nikalac SB-201: imino methylol group-containing benzoguanamine resin manufactured by Sanwa Chemical Co., Ltd.

### Example III-1

To a sand mill, 90 parts of the red pigment, 10 parts of the pigment derivative [1], 133 parts of the urethane-based dispersant (III-U1) and 410 parts of the solvent (CBAc) were charged, and the whole was dispersed for 4 hours. Thereafter, 40 parts of the melamine resin (MX-43) and 86 parts of the solvent (CBAc) were added in a mixer, and mixed. The product was filtered under pressure by a membrane filter to obtain the ink composition for ink jet recording, containing the pigment concentration of 13%.

### Example III-2

To a sand mill, 90 parts of the red pigment, 10 parts of the pigment derivative [1], 133 parts of the urethane-based dispersant (III-U1) and 410 parts of the solvent (CBAc) were charged, and the whole was dispersed for 4 hours. Thereafter, 40 parts of the melamine resin (MX-43), 20 parts of the epoxy compound (EPPN-201) (manufactured by Nippon Kayaku Co., Ltd.) and 66 parts of the solvent (CBAc) were added in a mixer, and mixed. The product was filtered under pressure by a membrane filter to obtain the ink composition for ink jet recording, containing the pigment concentration of 13%.

### Comparative Example III-1

To a sand mill, 90 parts of the red pigment, 10 parts of the pigment derivative [1], 67 parts of the urethane-based dispersant (III-U6), 66 parts of the solvent (PGMAc) and 410 parts of the solvent (CBAc) were charged, and the whole was dispersed for 4 hours. Thereafter, 40 parts of the melamine resin (MX-43) and 86 parts of the solvent (CBAc) were added in a mixer, and mixed. The product was filtered under pressure by a membrane filter to obtain the ink composition for ink jet recording, containing the pigment concentration of 13%.

### Comparative Example III-2

To a sand mill, 90 parts of the red pigment, 10 parts of the pigment derivative [1], 133 parts of the urethane-based dispersant (III-U1) and 410 parts of CBAc were charged, and the whole was dispersed for 4 hours. Thereafter, 40 parts of the melamine resin (MX-43) and 86 parts of the solvent (CBAc) were added in a mixer, and mixed. The product was filtered under pressure by a membrane filter to obtain the ink composition for ink jet recording, containing the pigment concentration of 13%.

### Example III-3

A mixture was obtained by homogeneously stirring 90 parts of the green pigment, 10 parts of the pigment derivative [2] and 100 parts of the urethane-based dispersant (III-U2), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. The solvents evaporated during the dispersing treatment, and the kneaded mixture became an elastic solid product. The resulting solid product was cooled and ground to obtain a coated pigment.

Then, 150 parts of the coated pigment and 250 parts of the solvent (CBAc) were mixed in a mixer, and the mixture was charged to a sand mill and dispersed. Thereafter, 40 parts of the melamine resin (MX-43) and 116 parts of the solvent (CBAc) were added, and mixed. Finally, the product was filtered under pressure by a membrane filter to obtain the ink composition for ink jet recording, containing the pigment concentration of 18%.

### Example III-4

The procedure described in Example III-3 was repeated, except that benzoguanamine resin (Nikalac SB-401; Nikalac SB-401) was used instead of 40 parts of the melamine resin (MX-43), to obtain the ink composition for ink jet recording, containing the pigment concentration of 18%.

### Comparative Example III-3

The procedure described in Example III-3 was repeated, except that 100 parts of the urethane-based dispersant (III-U7) was used instead of 100 parts of the urethane-based dispersant (III-U2), to obtain the ink composition for ink jet recording, containing the pigment concentration of 18%.

### Comparative Example III-4

A mixture was obtained by homogeneously stirring 90 parts of the green pigment, 10 parts of the pigment derivative [2] and 100 parts of the urethane-based dispersant (III-U2), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. The solvents evaporated during the dispersing treatment, and the kneaded mixture became an elastic solid product. The resulting solid product was cooled and ground to obtain a coated pigment.

Then, 150 parts of the coated pigment and 250 parts of the solvent (CBAc) were mixed in a mixer, and the mixture was charged to a sand mill and dispersed. Thereafter, 156 parts of the solvent (CBAc) was added, and mixed. Finally, the product was filtered under pressure by a membrane filter to obtain the ink composition for ink jet recording, containing the pigment concentration of 18%.

### Example III-5

A mixture was obtained by homogeneously stirring 90 parts of the yellow pigment, 10 parts of the pigment derivative [3] and 133 parts of urethane dispersing agent (III-U3), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. The solvents evaporated during the dispersing treatment, and the kneaded mixture became an elastic solid product. The resulting solid product was cooled and ground to obtain a coated pigment.

Then, 167 parts of the coated pigment and 267 parts of the solvent (CBAc) were mixed in a mixer, and the mixture was charged to a sand mill and dispersed. Thereafter, 40 parts of the melamine resin (MX-43) and 53 parts of the solvent (CBAc) were added, and mixed. After the mixture was filtered to remove any impurities and oversized particles, an ink composition for ink jet recording, containing the pigment concentration of 19%, was obtained.

### Comparative Example III-5

The procedure described in Example III-5 was repeated, except that 133 parts of the vinyl-based resin (III-B1) was used instead of 133 parts of urethane dispersing agent (III-U3), to obtain the ink composition for ink jet recording, containing the pigment concentration of 19%.

### Example III-6

A mixture was obtained by homogeneously stirring 90 parts, 10 parts of the pigment derivative [2] and 133 parts of the urethane-based dispersant (III-U4), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. The solvents evaporated during the dispersing treatment, and the kneaded mixture became an elastic solid product. The resulting solid product was cooled and ground to obtain a coated pigment.

Then, 167 parts of the coated pigment and 552 parts of the solvent (CBAc) were mixed in a mixer, and the mixture was charged to a sand mill and dispersed. Thereafter, 40 parts of the melamine resin (MX-43) and 60 parts of the solvent (CBAc) were added, and mixed. After the mixture was filtered to remove any impurities and oversized particles, an ink composition for ink jet recording, containing the pigment concentration of 12%, was obtained.

### Example III-7

A mixture was obtained by homogeneously stirring 90 parts of the blue pigment, 10 parts of the pigment derivative [2] and 133 parts of the urethane-based dispersant (III-U4), and kneaded for 10 minutes by two rolls heated at 60° C., whereby the solvents were volatilized to obtain a sheet. Then, 50 parts of the solvent (PGMAc) was added, the whole was kneaded by the two rolls heated at 80° C. The solvents evaporated during the dispersing treatment, and the kneaded mixture became an elastic solid product. The resulting solid product was cooled and ground to obtain a coated pigment.

Then, 167 parts of the coated pigment and 532 parts of the solvent (CBAc) were mixed in a mixer, and the mixture was charged to a sand mill and dispersed. Thereafter, 40 parts of the melamine resin (MX-43), 20 parts of acrylic monomer (Kayarad TPA-330; manufactured by Nippon Kayaku Co., Ltd.) and 60 parts of the solvent (CBAc) were added, and mixed. After the mixture was filtered to remove any impurities and oversized particles, an ink composition for ink jet recording, containing the pigment concentration of 12%, was obtained.

### Comparative Example III-6

The procedure described in Example III-6 was repeated, except that 133 parts of the vinyl-based resin (III-B1) was used instead of 133 parts of the urethane-based dispersant (III-U4), to obtain the ink composition for ink jet recording, containing the pigment concentration of 12%.

### Comparative Example III-7

A mixture was obtained by homogeneously stirring 90 parts of the blue pigment, 10 parts of the pigment derivative [2] and 133 parts of the urethane-based dispersant (III-U4), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. The solvents evaporated during the dispersing treatment, and the kneaded mixture became an elastic solid product. The resulting solid product was cooled and ground to obtain a coated pigment.

Then, 167 parts of the coated pigment and 532 parts of the solvent (CBAc) were mixed in a mixer, and the mixture was charged to a sand mill and dispersed. Thereafter, 120 parts of the solvent (CBAc) was added, and mixed. After the mixture was filtered to remove any impurities and oversized particles, an ink composition for ink jet recording, containing the pigment concentration of 12%, was obtained.

### Example III-8

To a sand mill, 90 parts of the cyan pigment, 10 parts of the pigment derivative [2], 133 parts of the urethane-based dispersant (III-U4) and 340 parts of the solvent (BuCBAc) were charged, and the whole was dispersed for 4 hours. Thereafter, 40 parts of the melamine resin (MX-43) and 54 parts of the solvent (BuCBAc) were added in a mixer, and mixed. The product was filtered under pressure by a membrane filter to obtain the ink composition for ink jet recording, containing the pigment concentration of 15%.

### Comparative Example III-8

The procedure described in Example III-8 was repeated, except that 133 parts of the vinyl-based resin (III-B1) was used instead of 133 parts of the urethane-based dispersant (III-4), to obtain the ink composition for ink jet recording, containing the pigment concentration of 15%.

### Example III-9

To a sand mill, 90 parts of the magenta pigment, 10 parts of the pigment derivative [4], 133 parts of the urethane-based dispersant (III-U5) and 294 parts of the solvent (BuCBAc) were charged, and the whole was dispersed for 4 hours. Thereafter, 40 parts of the melamine resin (MX-43) and 100 parts of the solvent (BuCBAc) were added in a mixer, and mixed. The product was filtered under pressure by a membrane filter to obtain the ink composition for ink jet recording, containing the pigment concentration of 15%.

### Comparative Example III-9

The procedure described in Example III-9 was repeated, except that 67 parts of the urethane-based dispersant (III-U6) and 66 parts of the solvent (PGMAc) were used instead of 133 parts of the urethane-based dispersant (III-U5), to obtain the ink composition for ink jet recording, containing the pigment concentration of 15%.

### Example III-10

A mixture was obtained by homogeneously stirring 90 parts of the red pigment, 10 parts of the pigment derivative [1] and 133 parts of the urethane-based dispersant (III-U1), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. The solvents evaporated during the dispersing treatment, and the kneaded mixture became an elastic solid product. The resulting solid product was cooled and ground to obtain a coated pigment.

Then, 167 parts of the coated pigment and 426 parts of the solvent (CBAc) were mixed in a mixer, and the mixture was charged to a sand mill and dispersed. Thereafter, 40 parts of the melamine resin (MS-001), 76 parts of the solvent (CBAc), and 66 parts of the solvent (BuCBAc) were added, and mixed. Finally, the product was filtered under pressure by a membrane filter to obtain the ink composition for ink jet recording, containing the pigment concentration of 13%.

### Example III-11

A mixture was obtained by homogeneously stirring 90 parts of the red pigment, 10 parts of the pigment derivative [1] and urethane-based dispersant (III-U1) 133 parts, and kneaded for 10 minutes by two rolls heated at 60° C., whereby the solvents were volatilized to obtain a sheet. Then, 50 parts of the solvent (PGMAc) was added, and the whole was kneaded by the two rolls were heated at 80° C. The solvents evaporated during the dispersing treatment, and the kneaded mixture became an elastic solid product. The resulting solid product was cooled and ground to obtain a coated pigment.

Then, 167 parts of the coated pigment and 426 parts of the solvent (CBAc) were mixed in a mixer, and the mixture was charged to a sand mill and dispersed. Thereafter, 40 parts of the melamine resin (MS-001), 20 parts of acrylic monomer (M-400; manufactured by Toagosei Co., Ltd.), 56 parts of the solvent (CBAc) and 66 parts of the solvent (BuCBAc) were added, and mixed. Finally, the product was filtered to obtain the ink composition for ink jet recording, containing the pigment concentration of 13%.

### Comparative Example III-10

The procedure described in Example III-10 was repeated, except that 133 parts of the vinyl-based resin (III-B1) was used instead of 133 parts of the urethane-based dispersant (III-U1), to obtain the ink composition for ink jet recording, containing the pigment concentration of 13%.

### Example III-12

A mixture was obtained by homogeneously stirring 90 parts of the green pigment, 10 parts of the pigment derivative [2] and 100 parts of the urethane-based dispersant (III-U2), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. During the dispersing treatment, the solvents were volatilized, and the kneaded and heated product was converted to an elastic solid product. The resulting solid product was cooled and ground to obtain a coated pigment.

Then, 150 parts of the coated pigment and 250 parts of the solvent (CBAc) were mixed in a mixer, and the mixture was charged to a sand mill and dispersed. Thereafter, 40 parts of benzoguanamine resin (SB-201), 83 parts of the solvent (CBAc) and 33 parts of the solvent (BuCBAc) were added, and mixed. Finally, the product was filtered under pressure by a membrane filter to obtain the ink composition for ink jet recording, containing the pigment concentration of 18%.

### Example III-13

A mixture was obtained by homogeneously stirring 90 parts of the green pigment, 10 parts of the pigment derivative [2] and 100 parts of the urethane-based dispersant (III-U2), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. The solvents evaporated during the dispersing treatment, and the kneaded mixture became an elastic solid product. The resulting solid product was cooled and ground to obtain a coated pigment.

Then, 150 parts of the coated pigment and 250 parts of the solvent (CBAc) were mixed in a mixer, and the mixture was charged to a sand mill and dispersed. Thereafter, 40 parts of benzoguanamine resin (SB-201), 20 parts of acrylic monomer (M-400; manufactured by Toagosei Co., Ltd.), 63 parts of the solvent (CBAc) and 33 parts of the solvent (BuCBAc) were added, and mixed. Finally, the product was filtered under pressure by a membrane filter to obtain the ink composition for ink jet recording, containing the pigment concentration of 18%.

### Comparative Example III-11

The procedure described in Example III-12 was repeated, except that 100 parts of the vinyl-based resin (III-B1) was used instead of 100 parts of the urethane-based dispersant (III-U2), to obtain the ink composition for ink jet recording, containing the pigment concentration of 18%.

### Example III-14

A mixture was obtained by homogeneously stirring 90 parts of the yellow pigment, 10 parts of the pigment derivative [3] and 133 parts of urethane dispersing agent (III-U3), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. D The solvents evaporated during the dispersing treatment, and the kneaded mixture became an elastic solid product. The resulting solid product was cooled and ground to obtain a coated pigment.

Then, 167 parts of the coated pigment and 267 parts of the solvent (CBAc) were mixed in a mixer, and the mixture was charged to a sand mill and dispersed. Thereafter, 40 parts of the melamine resin (MS-001), 20 parts of the solvent (CBAc) and 33 parts of the solvent (BuCBAc) were added, and mixed. After the mixture was filtered to remove any impurities and oversized particles, an ink composition for ink jet recording, containing the pigment concentration of 19% was obtained.

### Comparative Example III-12

The procedure described in Example III-14 was repeated, except that 67 parts of the urethane-based dispersant (III-U6) and 66 parts of the solvent (PGMAc) were used instead of 133 parts of the urethane-based dispersant (III-U3), to obtain the ink composition for ink jet recording, containing the pigment concentration of 19%.

### Example III-15

A mixture was obtained by homogeneously stirring 90 parts of the blue pigment, 10 parts of the pigment derivative [2] and 133 parts of the urethane-based dispersant (III-U4), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. The solvents evaporated during the dispersing treatment, and the kneaded mixture became an elastic solid product. The resulting solid product was cooled and ground to obtain a coated pigment.

Then, 167 parts of the coated pigment and 506 parts of the solvent (CBAc) were mixed in a mixer, and the mixture was charged to a sand mill and dispersed. Thereafter, 40 parts of the melamine resin (MS-001), 40 parts of the solvent (CBAc) and 66 parts of the solvent (BuCBAc) were added, and mixed. After the mixture was filtered to remove any impurities and oversized particles, an ink composition for ink jet recording, containing the pigment concentration of 12%, was obtained.

### Example III-16

A mixture was obtained by homogeneously stirring 90 parts of the blue pigment, 10 parts of the pigment derivative [2] and 133 parts of the urethane-based dispersant (III-U4), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. The solvents evaporated during the dispersing treatment, and the kneaded mixture became an elastic solid product. The resulting solid product was cooled and ground to obtain a coated pigment.

Then, 167 parts of the coated pigment and 506 parts of the solvent (CBAc) were mixed in a mixer, and the mixture was charged to a sand mill and dispersed. Thereafter, 40 parts of the melamine resin (MS-001), 20 parts of acrylic monomer (M-400; manufactured by Toagosei Co., Ltd.), 20 parts of the solvent (CBAc) and 66 parts of the solvent (BuCBAc) were added, and mixed. After the mixture was filtered to remove any impurities and oversized particles, an ink composition for ink jet recording, containing the pigment concentration of 12%, was obtained.

### Comparative Example III-13

The procedure described in Example III-15 was repeated, except that 133 parts of the urethane-based dispersant (III-U7) was used instead of 133 parts of the urethane-based dispersant (III-U4), to obtain the ink composition for ink jet recording, containing the pigment concentration of 12%.

### Example III-17

A mixture was obtained by homogeneously stirring 90 parts of red-2 pigment, 10 parts of the pigment derivative [5], 133 parts of the urethane-based dispersant (III-U4), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. The solvents evaporated during the dispersing treatment, and the kneaded mixture became an elastic solid product.

The resulting solid product was cooled and ground to obtain a coated pigment.

Then, 167 parts of the coated pigment and 426 parts of the solvent (CBAc) were mixed in a mixer, and the mixture was charged to a sand mill and dispersed. Thereafter, 40 parts of the melamine resin (MS-001), 76 parts of the solvent (CBAc), and 66 parts of the solvent (BuCBAc) were added, and mixed. Finally, the product was filtered under pressure by a membrane filter to obtain the ink composition for ink jet recording, containing the pigment concentration of 13%.

### Comparative Example III-17

The procedure described in Example III-17 was repeated, except that 133 parts of the vinyl-based resin (III-B1) was used instead of 133 parts of the urethane-based dispersant (III-U4), to obtain the ink composition for ink jet recording, containing the pigment concentration of 13%.

### Example III-18

A mixture was obtained by homogeneously stirring 90 parts of violet pigment, 10 parts of the pigment derivative [6] and 133 parts of the urethane-based dispersant (III-U5), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. The solvents evaporated during the dispersing treatment, and the kneaded mixture became an elastic solid product.

The resulting solid product was cooled and ground to obtain a coated pigment.

Then, 167 parts of the coated pigment and 506 parts of the solvent (CBAc) were mixed in a mixer, and the mixture was charged to a sand mill and dispersed. Thereafter, 40 parts of the melamine resin (MS-001), 40 parts of the solvent (CBAc), and 66 parts of the solvent (BuCBAc) were added, and mixed. After the mixture was filtered to remove any impurities and oversized particles, an the ink composition for ink jet recording, containing the pigment concentration of 12%, was obtained.

### Comparative Example III-15

The procedure described in Example III-18 was repeated, except that 67 parts of the urethane-based dispersant (III-U6) and 66 parts of the solvent (PGMAc) were used instead of 133 parts of the urethane-based dispersant (III-U5), to obtain the ink composition for ink jet recording, containing the pigment concentration of 12%.

### [Evaluation of Properties]

The inkjet inks prepared in Examples III-1 to III-18 and Comparative Examples III-1 to III-15 were evaluated as to a viscosity, a flowability, a storage stability, and a chemical resistance, in accordance with the following methods. Further, the inkjet inks prepared in Examples III-1 to III-18 and Comparative Examples III-1 to III-15 were discharged from an inkjet printer having piezo heads capable of changing frequency from 4 to 10 KHz, to evaluate a discharging stability and a printed concentration in accordance with the following methods.

The results of the evaluation were shown in the following Tables 10 and 11.

A viscosity (η: mPa·s) at a shear rate of 100 (1/s) was determined by a measuring apparatus for dynamic viscoelasticity.

◯: η<30
x: 30≦η

### [Flowability]

A viscosity (ηa: mPa·s) at a shear rate of 10 (1/s) was determined by a measuring apparatus for dynamic viscoelasticity, and a ratio (ηa/η) thereof to the previously determined viscosity (η: mPa·s) at a shear rate of 100 (1/s) was calculated. Flowability was evaluated according to the following criteria.

◯: 0.9≦ηa/η<1.5
x: 1.5≦ηa/η

### [Storage Stability]

A viscosity was measured after heating in an oven at 45° C. for 7 days.

◯: Increased rate from the viscosity before heated was less than 10%.
x: Increased rate from the viscosity before heated was not less than 10%.

### [Chemical Resistance]

A glass substrate having a coated film thereon was dipped in N-methylpyrrolidone, and a change (ΔE) between the color before dipped and the color after dipped was measured.

### ◯: ΔE<2

### Δ: ΔE<4

### x: ΔE≧4

### [Discharging Stability]

The printed condition was visually observed, and a discharging stability was evaluated, based on the following criteria.

∘: A nozzle lacking in a printing after a pausing period for 15 minutes was less than 10%.
Δ: A nozzle lacking in a printing after a pausing period for 15 minutes ranged from not less than 10% to less than 30%.
x: A nozzle lacking in a printing after a pausing period for 15 minutes was not less than 30%.

### [Printed Concentration]

A cardboard was printed in a solid color, and the value of OD was measured after dried.

◯: The value of OD was not less than 1.3
x: The value of OD was less than 1.3

TABLE 10

| | | Example | | | | | | | | |
|---|---|---|---|---|---|---|---|---|---|---|
| | | III-1 | III-2 | III-3 | III-4 | III-5 | III-6 | III-7 | III-8 | III-9 |
| Pigment | Red | 90 | 90 | | | | | | | |
| | Green | | | 90 | 90 | | | | | |
| | Yellow | | | | | 90 | | | | |
| | Blue | | | | | | 90 | 90 | | |
| | Cyan | | | | | | | | 90 | |
| | Magenta | | | | | | | | | 90 |
| Pigment | [1] | 10 | 10 | | | | | | | |
| derivative | [2] | | | 10 | 10 | | 10 | 10 | 10 | |
| | [3] | | | | | 10 | | | | |
| | [4] | | | | | | | | | 10 |
| Urethane-based | III-U1 | 67 | 67 | | | | | | | |
| Dispersing | III-U2 | | | 50 | 50 | | | | | |
| agent (*1) | III-U3 | | | | | 67 | | | | |
| | III-U4 | | | | | | 67 | 67 | 67 | |
| | III-U5 | | | | | | | | | 67 |
| Process for | | No | No | Yes | Yes | Yes | Yes | Yes | No | No |
| coating pigments | | | | | | | | | | |
| Melamine resin | MX-43 | 40 | 40 | 40 | | 40 | 40 | 40 | 40 | 40 |
| Benzoguanamine | SB-401 | | | | 40 | | | | | |
| resin | | | | | | | | | | |
| Epoxy compound | EPPN- | | 20 | | | | | | | |
| | 201 | | | | | | | | | |
| Acrylic monomer | TPA- | | | | | | | 20 | | |
| | 330 | | | | | | | | | |
| Solvent (*2) | CBAc | 496 | 476 | 366 | 366 | 320 | 612 | 592 | | |
| | BuCBAc | | | | | | | | 394 | 394 |
| | PGMAc | 66 | 66 | | | | | | 66 | 66 |

(*1): The values in Table 10 are the solid contents
(*2): The values in Table 10 mean the contents in resulting ink compositions.

TABLE 11

| | | Example | | | | | | | | |
|---|---|---|---|---|---|---|---|---|---|---|
| | | III-10 | III-11 | III-12 | III-13 | III-14 | III-15 | III-16 | III-17 | III-18 |
| Pigment | Red | 90 | 90 | | | | | | | |
| | Green | | | 90 | 90 | | | | | |
| | Yellow | | | | | 90 | | | | |
| | Blue | | | | | | 90 | 90 | | |
| | Red-2 | | | | | | | | 90 | |
| | Violet | | | | | | | | | 90 |
| Pigment | [1] | 10 | 10 | | | | | | | |
| derivative | [2] | | | 10 | 10 | | 10 | 10 | | |
| | [3] | | | | | 10 | | | | |
| | [5] | | | | | | | | 10 | |
| | [6] | | | | | | | | | 10 |
| Urethane-based | III-U1 | 67 | 67 | | | | | | | |
| Dispersing | III-U2 | | | 50 | 50 | | | | | |
| agent (*1) | III-U3 | | | | | 67 | | | | |
| | III-U4 | | | | | | 67 | 67 | 67 | |
| | III-U5 | | | | | | | | | 67 |
| Process for | | Yes | Yes | Yes | Yes | Yes | Yes | Yes | Yes | Yes |
| coating pigments | | | | | | | | | | |
| Melamine resin | MS-001 | 40 | 40 | | | | 40 | 40 | 40 | 40 |
| Benzoguanamine | SB-201 | | | 40 | 40 | | | | | |
| resin | | | | | | | | | | |
| Acrylic monomer | M-400 | | 20 | | 20 | | 20 | | | |
| Solvent (*2) | CBAc | 496 | 476 | 333 | 313 | 287 | 546 | 526 | 496 | 546 |
| | BuCBAc | 66 | 66 | 33 | 33 | 33 | 66 | 66 | 66 | 66 |

(*1): The values in Table 11 are the solid contents
(*2): The values in Table 11 mean the contents in resulting ink compositions

TABLE 12

| | | Comparative Example | | | | | | | | |
|---|---|---|---|---|---|---|---|---|---|---|
| | | III-1 | III-2 | III-3 | III-4 | III-5 | III-6 | III-7 | III-8 | III-9 |
| Pigment | Red | 90 | 90 | | | | | | | |
| | Green | | | 90 | 90 | | | | | |
| | Yellow | | | | | 90 | | | | |
| | Blue | | | | | | 90 | 90 | | |
| | Cyan | | | | | | | | 90 | |
| | Magenta | | | | | | | | | 90 |
| Pigment | [1] | 10 | 10 | | | | | | | |
| derivative | [2] | | | 10 | 10 | | 10 | 10 | 10 | |
| | [3] | | | | | 10 | | | | |
| | [4] | | | | | | | | | 10 |
| Urethane-based | III-U1 | | 67 | | | | | | | |
| Dispersing agent | III-U2 | | | | 50 | | | | | |
| (Note 1) | III-U4 | | | | | | | 67 | | |
| | III-U6 | 67 | | | | | | | | 67 |
| | III-U7 | | | 50 | | | | | | |
| Vinyl resin (*1) | III-B1 | | | | | 67 | 67 | | 67 | |
| Process for | | No | No | Yes | Yes | Yes | Yes | Yes | No | No |
| coating pigments | | | | | | | | | | |
| Melamine resin | MX-43 | 40 | | 40 | | 40 | 40 | | 40 | 40 |
| Solvent (*2) | CBAc | 496 | 536 | 416 | 406 | 320 | 612 | 652 | | |
| | BuCBAc | | | | | | | | 394 | 394 |
| | PGMAc | 66 | 66 | | | | | | 66 | 66 |

(*1): The values in Table 12 are the solid contents
(*2): The values in Table 12 mean the contents in resulting ink compositions

TABLE 13

| | | Comparative Example | | | | | |
|---|---|---|---|---|---|---|---|
| | | III-10 | III-11 | III-12 | III-13 | III-14 | III-15 |
| Pigment | Red | 90 | | | | | |
| | Green | | 90 | | | | |
| | Yellow | | | 90 | | | |
| | Blue | | | | 90 | | |
| | Red-2 | | | | | 90 | |
| | Violet | | | | | | 90 |
| Pigment | [1] | 10 | | | | | |
| derivative | [2] | | 10 | | 10 | | |
| | [3] | | | 10 | | | |
| | [5] | | | | | 10 | |
| | [6] | | | | | | 10 |
| Urethane-based | III-U6 | | | 67 | | | 67 |
| Dispersing | III-U7 | | | | 67 | | |
| agent(Note 1) | | | | | | | |
| Vinyl resin (*1) | III-B1 | 67 | 50 | | | 67 | |
| Process for | | Yes | Yes | Yes | Yes | Yes | Yes |
| coating pigments | | | | | | | |
| Melamine resin | MS-001 | 40 | | | 40 | 40 | 40 |
| Benzoguanamine | SB-201 | | 40 | | | | |
| resin | | | | | | | |
| Solvent (*2) | CBAc | 496 | 333 | 320 | 546 | 496 | 546 |
| | BuCBAc | 66 | 33 | 33 | 66 | 66 | 66 |

(*1): The values in Table 13 are the solid contents
(*2): The values in Table 13 mean the contents in resulting ink compositions

TABLE 14

| | Example | | | | | | | | |
|---|---|---|---|---|---|---|---|---|---|
| | III-1 | III-2 | III-3 | III-4 | III-5 | III-6 | III-7 | III-8 | III-9 |
| Viscosity | 24 | 26 | 22 | 21 | 28 | 15 | 17 | 13 | 26 |
| (mPa · s) | | | | | | | | | |
| Flowability | 1.3 | 1.4 | 1.2 | 1.2 | 1.4 | 1.1 | 1.1 | 1.1 | 1.4 |
| Storage | 4% | 6% | 6% | 4% | 8% | 0% | 1% | −1% | 8% |
| stability | | | | | | | | | |
| Discharging | ◯ | ◯ | ◯ | ◯ | ◯ | ◯ | ◯ | ◯ | ◯ |
| stability | | | | | | | | | |
| Chemical | 1.7 | 1.9 | 1.8 | 1.5 | 1.4 | 1.6 | 1.8 | 1.7 | 1.6 |
| resistance | | | | | | | | | |
| Printed concentration | 1.3 | 1.3 | 1.4 | 1.4 | 1.2 | 1.4 | 1.3 | 1.3 | 1.3 |

TABLE 15

| | Example | | | | | | | | |
|---|---|---|---|---|---|---|---|---|---|
| | III-10 | III-11 | III-12 | III-13 | III-14 | III-15 | III-16 | III-17 | III-18 |
| Viscosity | 23 | 25 | 24 | 23 | 27 | 16 | 18 | 19 | 29 |
| (mPa · s) | | | | | | | | | |
| Flowability | 1.3 | 1.3 | 1.2 | 1.2 | 1.4 | 1.1 | 1.1 | 1.1 | 1.4 |
| Storage | 6% | 9% | 8% | 5% | 9% | 2% | 3% | 6% | 9% |
| stability | | | | | | | | | |
| Discharging | ◯ | ◯ | ◯ | ◯ | ◯ | ◯ | ◯ | ◯ | ◯ |
| stability | | | | | | | | | |
| Chemical | 1.5 | 1.5 | 1.6 | 1.4 | 1.3 | 1.4 | 1.5 | 1.5 | 1.5 |
| resistance | | | | | | | | | |
| Printed concentration | 1.3 | 1.3 | 1.4 | 1.4 | 1.2 | 1.4 | 1.3 | 1.3 | 1.2 |

TABLE 16

| | Comparative Example | | | | | | | | |
|---|---|---|---|---|---|---|---|---|---|
| | III-1 | III-2 | III-3 | III-4 | III-5 | III-6 | III-7 | III-8 | III-9 |
| Viscosity | 59 | 20 | Unflowable | 20 | 48 | 40 | 14 | 32 | 51 |
| (mPa · s) | | | | | | | | | |
| Flowability | 3.5 | 1.2 | Unflowable | 1.1 | 3.1 | 2.8 | 1.1 | 2.5 | 3.2 |
| Storage | 190% | 2% | Unflowable | 3% | 67% | 30% | −2% | 22% | 83% |
| stability | | | | | | | | | |
| Discharging | X | ◯ | Unflowable | ◯ | Δ | Δ | ◯ | Δ | Δ |
| stability | | | | | | | | | |
| Tolerance | 2.1 | 7.2 | Unflowable | 7.9 | 1.9 | 2.0 | 6.2 | 1.8 | 2.2 |
| Printed | 1.0 | 1.3 | Unflowable | 1.4 | 1.1 | 1.2 | 1.4 | 1.2 | 1.0 |
| concentration | | | | | | | | | |

TABLE 17

| | Comparative Example | | | | | |
|---|---|---|---|---|---|---|
| | III-10 | III-11 | III-12 | III-13 | III-14 | III-15 |
| Viscosity | 44 | 88 | 75 | Unflowable | 57 | 51 |
| (mPa · s) | | | | | | |
| Flowability | 3.0 | 4.1 | 3.9 | Unflowable | 3.5 | 3.7 |
| Storage | 120% | 143% | 99% | Unflowable | 111% | 131% |
| stability | | | | | | |
| Discharging | X | X | X | Unflowable | X | X |
| stability | | | | | | |
| Chemical | 1.9 | 2.0 | 2.5 | Unflowable | 1.9 | 2.1 |
| resistance | | | | | | |
| Printed | 1.0 | 1.1 | 1.1 | Unflowable | 1.2 | 1.1 |
| concentration | | | | | | |

### (IV-1) Urethane-Based Dispersants

Manufacturing Example of the urethane-based dispersants will be explained hereinafter.

### Preparation Example IV-1

To a reacting apparatus equipped with a gas supplying tube, a condenser, an agitating fan, and a thermometer, 67 parts of 1-decanol and 433 parts of ε-caprolactone were charged. After the air in a reaction vessel was displaced by a nitrogen gas, the reaction was carried out at 120° C. for 2 hours. After the reaction was completed, the product was diluted with 214 parts of methoxypropyl acetate to obtain a polycaprolactone solution (IV-MC).

### Preparation Example IV-2

To a reacting apparatus equipped with a gas supplying tube, a condenser, an agitating fan, and a thermometer, 250 parts of butyl methacrylate and 250 parts of benzyl methacrylate were charged. After the air in a reaction vessel was displaced by a nitrogen gas, the whole was heated to 80° C. Then, 38 parts of 2-mercaptoethanol was added dropwise over 10 minutes, the reaction was carried out for 7 hours. After the reaction was completed, the product was diluted with 214 parts of methoxypropyl acetate to obtain an acrylic resin solution (IV-MA).

### Preparation Example IV-3

To a reacting apparatus equipped with a gas supplying tube, a condenser, an agitating fan, and a thermometer, 250 parts of butyl methacrylate and 250 parts of benzyl methacrylate were charged. After the air in a reaction vessel was displaced by a nitrogen gas, the whole was heated to 80° C. Then, 38 parts of thioglycerol (Asahi Chemical Co., Ltd.) was added dropwise over 10 minutes, the reaction was carried out for 7 hours. After the reaction was completed, the product was diluted with 214 parts of methoxypropyl acetate to obtain an acrylic resin solution (IV-DA).

### Manufacturing Example IV-1 of Branched Urethane Resin Dispersant (IV-U)

To a reacting apparatus equipped with a gas supplying tube, a condenser, an agitating fan, and a thermometer, 84 parts of polycaprolactone solution (IV-MC), 66 parts of VESTANAT T 1890/100 (Degussa Japan Co., Ltd.) and 100 parts of methoxypropyl acetate were charged. After the air in a reaction vessel was displaced by a nitrogen gas, the whole was heated to 80° C., and the reaction was carried out for 1 hour. Then, 40 parts of dimethylolbutanoic acid (DMBA, manufactured by Nippon Kasei Chemical Co., Ltd.) and 40 parts of methoxypropyl acetate were charged, and the reaction was carried out at 90° C. After the disappearance of the peak at 2270 cm⁻¹ based on the isocyanate group was confirmed by IR, 6 parts of pyromellitic dianhydride and 6 parts of methoxypropyl acetate were charged, and the reaction was carried out at 100° C. After the disappearance of the peak at 1855 cm⁻¹ and 1785 cm⁻¹ based on the acid anhydride group was confirmed by IR, the whole was cooled to 40° C. to obtain a branched urethane resin dispersant solution (IV-U1).

### Manufacturing Examples IV-2 to IV-7 of Branched Urethane Resin Dispersants (IV-U)

The procedure described in Manufacturing Example 1 was repeated, except that the compositions shown in Table 18 were used, to obtain branched urethane resin dispersant solutions (IV-U), namely, (IV-U-2) to (IV-U-7).

### Manufacturing Example IV-8 of Branched Urethane Resin Dispersant (IV-U8)

To a reacting apparatus equipped with a gas supplying tube, a condenser, an agitating fan, and a thermometer, 4 parts of one-terminal-monoalcohol-containing polysiloxane FM-0041 (manufactured by Chisso Corporation), 46 parts of VESTANAT T 1890/100 and 125 parts of methoxypropyl acetate were charged. After the air in a reaction vessel was displaced by a nitrogen gas, the whole was heated to 80° C., and the reaction was carried out for 1 hour. Then, 121 parts acrylic resin (IV-DA), 11 parts of neopentyl glycol and 96 parts of methoxypropyl acetate were charged, and the reaction was carried out at 90° C. After the disappearance of the peak at 2270 cm⁻¹ based on the isocyanate group was confirmed by IR, the whole was cooled to 40° C. to obtain a branched urethane resin dispersant solution (IV-U8).

TABLE 18

| | IV-U-1 | IV-U-2 | IV-U-3 | IV-U-4 | IV-U-5 | IV-U-6 | IV-U-7 | IV-U-8 |
|---|---|---|---|---|---|---|---|---|
| VESTANAT T 1890/100 | 66 | 71 | 68 | 71 | 57 | 61 | 93 | 46 |
| Polycaprolactone solution | 84 | | | | | | | |
| (IV-MC) | | | | | | | | |
| <M.E. (*1) IV-1> | | | | | | | | |
| BlemmerPP-1000 | | 56 | | | | | | |
| Acrylic resin | | | 81 | | | | | |
| solution(IV-MA) | | | | | | | | |
| <M.E. (*1) IV-2> | | | | | | | | |
| FM-0411 | | | | 56 | | | 12 | 6 |
| Viscoat #300 | | | | | 13 | | | |
| OXT-101 | | | | | | 4 | | |
| DMBA | 40 | 43 | 41 | 43 | 34 | 37 | 56 | |
| Neopentyl glycol | | | | | | | | 11 |
| Acrylic resin | | | | | 59 | 64 | | 121 |
| solution (IV-DA) | | | | | | | | |
| Pyromellitic | 6 | 6 | 6 | 6 | 9 | 9 | 8 | |
| dianhydride | | | | | | | | |
| PGMAc | 145 | 174 | 147 | 168 | 144 | 156 | 160 | 144 |
| VESTANAT T 1890/100 | 39% | 41% | 108% | 41% | 38% | 39% | 57% | 32% |
| (wt % with respect | | | | | | | | |
| to resin) | | | | | | | | |
| Weight average | 32000 | 3000 | 35000 | 29000 | 18900 | 16000 | 15600 | 8700 |
| molecular weight | | | | | | | | |
| Acid value | 106 | 112 | 108 | 112 | 116 | 120 | 154 | 71 |
| Solid content (%) | 50% | 50% | 50% | 50% | 50% | 50% | 50% | 50% |

(*1): M.E. = Manufacturing Example
VESTANAT T 1890/100: IPDI trimer (manufactured by Degussa Japan Co., Ltd.)
Blemmer PP-1000: polypropyleneglycol monomethacrylate (manufactured by NOF Corporation)
FM-0411: one-terminal-monoalcohol-containing polysiloxane (manufactured by Chisso Corporation)
Viscoat #300: pentaerythritol triacrylate (manufactured by Osaka Organic Chemical Industry Ltd.)
OXT-101: oxetane alcohol (manufactured by Toagosei Co., Ltd.)
DMBA: dimethylolbutanoic acid (manufactured by Nippon Kasei Chemical Co., Ltd.)
Neopentyl glycol (manufactured by Wako Pure Chemical Industries, Ltd.)
Pyromellitic dianhydride (manufactured by Wako Pure Chemical Industries, Ltd.)
(IV-2) Vinyl-based resins

Manufacturing Examples of the vinyl-based resins will be explained hereinafter.

### Manufacturing Example IV-9 (resin IV-B1)

To a reacting chamber equipped with a gas supplying tube, a condenser, an agitating fan, and a thermometer, 60 parts of methoxypropyl acetate was charged, and then the whole was heated to 110° C. After the air in a reaction vessel was displaced by a nitrogen gas, a liquid mixture which had been prepared by uniformly mixing 40 parts of n-butyl methacrylate, 50 parts of benzyl methacrylate, 5 parts of 2-hydroxyethyl methacrylate, 5 parts of methacrylic acid, 40 parts of methoxypropyl acetate and 5 parts of dimethyl-2,2′-azobispolysiloxane was added dropwise over 2 hours from a dripping vessel. The stirring was continued at the same temperature for 3 hours to complete the reaction. Consequently, vinyl-based resin (IV-B1) having a number average molecular weight of 12000 was obtained. A ratio of solid content in the vinyl-based resin (IV-B1) was 50%.

### (IV-3) Melamine Resins

Nikalac MX-43: alkoxyalkyl group-containing melamine resin manufactured by Sanwa Chemical Co., Ltd.
Nikalac MS-001: imino methylol group-containing melamine resin manufactured by Sanwa Chemical Co., Ltd.

### (IV-4) Benzoguanamine Resins

Nikalac SB-401: alkoxyalkyl group-containing benzoguanamine resin manufactured by Sanwa Chemical Co., Ltd.
Nikalac SB-201: imino methylol group-containing benzoguanamine resin manufactured by Sanwa Chemical Co., Ltd.

### Example IV-1

To a sand mill, 90 parts of the red pigment, 10 parts of the pigment derivative [1], 133 parts of the urethane-based dispersant (IV-U1) and 410 parts of the solvent (CBAc) were charged, and the whole was dispersed for 4 hours. Thereafter, 40 parts of the melamine resin (MX-43) and 86 parts of the solvent (CBAc) were added in a mixer, and mixed. The product was filtered under pressure by a membrane filter to obtain the ink composition for ink jet recording, containing the pigment concentration of 13%.

### Example IV-2

To a sand mill, 90 parts of the red pigment, 10 parts of the pigment derivative [1], 133 parts of the urethane-based dispersant (IV-U1) and 410 parts of the solvent (CBAc) were charged, and the whole was dispersed for 4 hours. Thereafter, 40 parts of the melamine resin (MX-43), 20 parts of the epoxy compound (EPPN-201; manufactured by Nippon Kayaku Co., Ltd.) and 66 parts of the solvent (CBAc) were added in a mixer, and mixed. The product was filtered under pressure by a membrane filter to obtain the ink composition for ink jet recording, containing the pigment concentration of 13%.

### Comparative Example IV-1

To a sand mill, 90 parts of the red pigment, 10 parts of the pigment derivative [1], 133 parts of the urethane-based dispersant (IV-U7) and 410 parts of the solvent (CBAc) were charged, and the whole was dispersed for 4 hours. Thereafter, 40 parts of the melamine resin (MX-43) and 86 parts of the solvent (CBAc) were added in a mixer, and mixed. The product was filtered under pressure by a membrane filter to obtain the ink composition for ink jet recording, containing the pigment concentration of 13%.

### Comparative Example IV-2

To a sand mill, 90 parts of the red pigment, 10 parts of the pigment derivative [1], 133 parts of the urethane-based dispersant (IV-U1) and 410 parts of CBAc were charged, and the whole was dispersed for 4 hours. Thereafter, 86 parts of the solvent (CBAc) was added in a mixer, and mixed. The product was filtered under pressure by a membrane filter to obtain the ink composition for ink jet recording, containing the pigment concentration of 13%.

### Example IV-3

A mixture was obtained by homogeneously stirring 90 parts of the green pigment, 10 parts of the pigment derivative [2] and 100 parts of the urethane-based dispersant (IV-U2), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. The solvents evaporated during the dispersing treatment, and the kneaded mixture became an elastic solid product. The resulting solid product was cooled and ground to obtain a coated pigment.

Then, 167 parts of the coated pigment and 426 parts of the solvent (CBAc) were mixed in a mixer, and the mixture was charged to a sand mill and dispersed. Thereafter, 40 parts of the melamine resin (MX-43) and 116 parts of the solvent (CBAc) were added, and mixed. Finally, the product was filtered under pressure by a membrane filter to obtain the ink composition for ink jet recording, containing the pigment concentration of 18%.

### Example IV-4

The procedure described in Example 3 was repeated, except that benzoguanamine resin (Nikalac SB-401) was used instead of 40 parts of the melamine resin (MX-43), to obtain the ink composition for ink jet recording, containing the pigment concentration of 18%.

### Comparative Example IV-3

The procedure described in Example 3 was repeated, except that 100 parts of the urethane-based dispersant (IV-U8) was used instead of 100 parts of the urethane-based dispersant (IV-U2), to obtain the ink composition for ink jet recording, containing the pigment concentration of 18%.

### Comparative Example IV-4

A mixture was obtained by homogeneously stirring 90 parts of the green pigment, 10 parts of the pigment derivative [2] and 100 parts of the urethane-based dispersant (IV-U2), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. The solvents evaporated during the dispersing treatment, and the kneaded mixture became an elastic solid product. The resulting solid product was cooled and ground to obtain a coated pigment.

Then, 150 parts of the coated pigment and 250 parts of the solvent (CBAc) were mixed in a mixer, and the mixture was charged to a sand mill and dispersed. Thereafter, 156 parts of the solvent (CBAc) was added, and mixed. Finally, the product was filtered under pressure by a membrane filter to obtain the ink composition for ink jet recording, containing the pigment concentration of 18%.

### Example IV-5

A mixture was obtained by homogeneously stirring 90 parts of the yellow pigment, 10 parts of the pigment derivative [3] and 133 parts of urethane dispersing agent (IV-U3), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. The solvents evaporated during the dispersing treatment, and the kneaded mixture became an elastic solid product. The resulting solid product was cooled and ground to obtain a coated pigment.

Then, 167 parts of the coated pigment and 267 parts of the solvent (CBAc) were mixed in a mixer, and the mixture was charged to a sand mill and dispersed. Thereafter, 40 parts of melamine resin (MX-43) and 53 parts of the solvent (CBAc) were added, and mixed. After the mixture was filtered to remove any impurities and oversized particles, an ink composition for ink jet recording, containing the pigment concentration of 19%, was obtained.

### Comparative Example IV-5

The procedure described in Example IV-5 was repeated, except that 133 parts of the vinyl-based resin (IV-B1) was used instead of 133 parts of urethane dispersing agent (IV-U3), to obtain the ink composition for ink jet recording, containing the pigment concentration of 19%.

### Example IV-6

A mixture was obtained by homogeneously stirring 90 parts of the blue pigment, 10 parts of the pigment derivative [2] and 133 parts of the urethane-based dispersant (IV-U4), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. The solvents evaporated during the dispersing treatment, and the kneaded mixture became an elastic solid product. The resulting solid product was cooled and ground to obtain a coated pigment.

Then, 167 parts of the coated pigment and 552 parts of the solvent (CBAc) were mixed in a mixer, and the mixture was charged to a sand mill and dispersed. Thereafter, 40 parts of the melamine resin (MX-43) and 60 parts of the solvent (CBAc) were added, and mixed. After the mixture was filtered to remove any impurities and oversized particles, an ink composition for ink jet recording, containing the pigment concentration of 12%, was obtained.

### Example IV-7

A mixture was obtained by homogeneously stirring 90 parts of the blue pigment, 10 parts of the pigment derivative [2] and 133 parts of the urethane-based dispersant (IV-U4), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. The solvents evaporated during the dispersing treatment, and the kneaded mixture became an elastic solid product. The resulting solid product was cooled and ground to obtain a coated pigment.

Then, 167 parts of the coated pigment and 532 parts of the solvent (CBAc) were mixed in a mixer, and the mixture was charged to a sand mill and dispersed. Thereafter, 40 parts of the melamine resin (MX-43), 20 parts of acrylic monomer (Kayarad TPA-330; manufactured by Nippon Kayak Co., Ltd.) and 60 parts of the solvent (CBAc) were added, and mixed. After the mixture was filtered to remove any impurities and oversized particles, an ink composition for ink jet recording, containing the pigment concentration of 12%, was obtained.

### Comparative Example IV-6

The procedure described in Example IV-6 was repeated, except that 133 parts of the vinyl-based resin (IV-B1) was used instead of 133 parts of the urethane-based dispersant (IV-U4), to obtain the ink composition for ink jet recording, containing the pigment concentration of 12%.

### Comparative Example IV-7

A mixture was obtained by homogeneously stirring 90 parts of the blue pigment, 10 parts of the pigment derivative [2] and 133 parts of the urethane-based dispersant (IV-U4), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. The solvents evaporated during the dispersing treatment, and the kneaded mixture became an elastic solid product. The resulting solid product was cooled and ground to obtain a coated pigment.

Then, 167 parts of the coated pigment and 532 parts of the solvent (CBAc) was mixed in a mixer, and the mixture was charged to a sand mill and dispersed. Thereafter, 120 parts of the solvent (CBAc) was added, and mixed. After the mixture was filtered to remove any impurities and oversized particles, an ink composition for ink jet recording, containing the pigment concentration of 12%, was obtained.

### Example IV-8

To a sand mill, 90 parts of the cyan pigment, 10 parts of the pigment derivative [2], 133 parts of the urethane-based dispersant (IV-U5) and 340 parts of the solvent (BuCBAc) were charged, and dispersed for 4 hours. Thereafter, 40 parts of the melamine resin (MX-43) and 54 parts of the solvent (BuCBAc) were added in a mixer, and mixed. The product was filtered under pressure by a membrane filter to obtain the ink composition for ink jet recording, containing the pigment concentration of 15%.

### Comparative Example IV-8

The procedure described in Example IV-8 was repeated, except that 133 parts of the vinyl-based resin (IV-B1) was used instead of 133 parts of the urethane-based dispersant (IV-U5), to obtain the ink composition for ink jet recording, containing the pigment concentration of 15%.

### Example IV-9

To a sand mill, 90 parts of the magenta pigment, 10 parts of the pigment derivative [4], 133 parts of the urethane-based dispersant (IV-U6) and 294 parts of the solvent (BuCBAc) were charged, and dispersed for 4 hours. Thereafter, 40 parts of the melamine resin (MX-43) and 100 parts of the solvent (BuCBAc) were added in a mixer, and mixed. The product was filtered under pressure by a membrane filter to obtain the ink composition for ink jet recording, containing the pigment concentration of 15%.

### Comparative Example IV-9

The procedure described in Example IV-9 was repeated, except that 133 parts of the urethane-based dispersant (IV-U7) was used instead of 133 parts of the urethane-based dispersant (IV-U6), to obtain the ink composition for ink jet recording, containing the pigment concentration of 15%.

### Example IV-10

A mixture was obtained by homogeneously stirring 90 parts of the red pigment, 10 parts of the pigment derivative [1] and 133 parts of the urethane-based dispersant (IV-U1), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. The solvents evaporated during the dispersing treatment, and the kneaded mixture became an elastic solid product. The resulting solid product was cooled and ground to obtain a coated pigment.

Then, 167 parts of the coated pigment and 426 parts of the solvent (CBAc) were mixed in a mixer, and the mixture was charged to a sand mill and dispersed. Thereafter, 40 parts of the melamine resin (MS-001), 76 parts of the solvent (CBAc) and 66 parts of the solvent (BuCBAc) were added, and mixed. Finally, the product was filtered under pressure by a membrane filter to obtain the ink composition for ink jet recording, containing the pigment concentration of 13%.

### Example IV-11

A mixture was obtained by homogeneously stirring 90 parts of the red pigment, 10 parts of the pigment derivative [1] and 133 parts of the urethane-based dispersant (IV-U1), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. The solvents evaporated during the dispersing treatment, and the kneaded mixture became an elastic solid product. The resulting solid product was cooled and ground to obtain a coated pigment.

Then, 167 parts of the coated pigment and 426 parts of the solvent (CBAc) were mixed in a mixer, and the mixture was charged to a sand mill and dispersed. Thereafter, 40 parts of the melamine resin (MS-001), 20 parts of acrylic monomer (M-400) (manufactured by Toagosei Co., Ltd.), 56 parts of the solvent (CBAc) and 66 parts of the solvent (BuCBAc) were added, and mixed. Finally, the product was filtered under pressure by a membrane filter to obtain the ink composition for ink jet recording, containing the pigment concentration of 13%.

### Comparative Example IV-10

The procedure described in Example IV-10 was repeated, except that 133 parts of the vinyl-based resin (IV-B1) was used instead of 133 parts of the urethane-based dispersant (IV-U1), to obtain the ink composition for ink jet recording, containing the pigment concentration of 13%.

### Example IV-12

A mixture was obtained by homogeneously stirring 90 parts of the green pigment, 10 parts of the pigment derivative [2] and 100 parts of the urethane-based dispersant (IV-U2), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. The solvents evaporated during the dispersing treatment, and the kneaded mixture became an elastic solid product. The resulting solid product was cooled and ground to obtain a coated pigment.

Then, 150 parts of the coated pigment and 250 parts of the solvent (CBAc) were mixed in a mixer, and the mixture was charged to a sand mill and dispersed. Thereafter, 40 parts of benzoguanamine resin (SB-201), 83 parts of the solvent (CBAc), and 33 parts of the solvent (BuCBAc) were added, and mixed. Finally, the product was filtered under pressure by a membrane filter to obtain the ink composition for ink jet recording, containing the pigment concentration of 18%.

### Example IV-13

A mixture was obtained by homogeneously stirring 90 parts of the green pigment, 10 parts of the pigment derivative [2] and 100 parts of the urethane-based dispersant (IV-U2), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. The solvents evaporated during the dispersing treatment, and the kneaded mixture became an elastic solid product. The resulting solid product was cooled and ground to obtain a coated pigment.

Then, 150 parts of the coated pigment and 250 parts of the solvent (CBAc) were mixed in a mixer, and the mixture was charged to a sand mill and dispersed. Thereafter, 40 parts of benzoguanamine resin (SB-201), 20 parts of acrylic monomer (M-400; manufactured by Toagosei Co., Ltd.), solvent (CBAc) 63 parts and 33 parts of the solvent (BuCBAc) were added, and mixed. Finally, the product was filtered under pressure by a membrane filter to obtain the ink composition for ink jet recording, containing the pigment concentration of 18%.

### Comparative Example IV-11

The procedure described in Example IV-12 was repeated, except that 100 parts of the vinyl-based resin (IV-B1) was used instead of 100 parts of the urethane-based dispersant (IV-U2), to obtain the ink composition for ink jet recording, containing the pigment concentration of 18%.

### Example IV-14

A mixture was obtained by homogeneously stirring 90 parts of the yellow pigment, 10 parts of the pigment derivative [3] and 133 parts of urethane dispersing agent (IV-U3), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. The solvents evaporated during the dispersing treatment, and the kneaded mixture became an elastic solid product. The resulting solid product was cooled and ground to obtain a coated pigment.

Then, 167 parts of the coated pigment and 267 parts of the solvent (CBAc) were mixed in a mixer, and the mixture was charged to a sand mill and dispersed. Thereafter, 40 parts of the melamine resin (MS-001), 20 parts of the solvent (CBAc), and 33 parts of the solvent (BuCBAc) were added, and mixed. After the mixture was filtered to remove any impurities and oversized particles, an ink composition for ink jet recording, containing the pigment concentration of 19%, was obtained.

### Comparative Example IV-12

The procedure described in Example 14 was repeated, except that 67 parts of the urethane-based dispersant (IV-U7) and 66 parts of the solvent (PGMAc) were used instead of 133 parts of the urethane-based dispersant (IV-U3), to obtain the ink composition for ink jet recording, containing the pigment concentration of 19%.

### Example IV-15

A mixture was obtained by homogeneously stirring 90 parts of the blue pigment, 10 parts of the pigment derivative [2] and 133 parts of the urethane-based dispersant (IV-U4), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. The solvents evaporated during the dispersing treatment, and the kneaded mixture became an elastic solid product. The resulting solid product was cooled and ground to obtain a coated pigment.

Then, 167 parts of the coated pigment and 506 parts of the solvent (CBAc) were mixed in a mixer, and the mixture was charged to a sand mill and dispersed. Thereafter, 40 parts of the melamine resin (MS-001), 40 parts of the solvent (CBAc) and 66 parts of the solvent (BuCBAc) were added, and mixed. After the mixture was filtered to remove any impurities and oversized particles, an ink composition for ink jet recording, containing the pigment concentration of 12%, was obtained.

### Example IV-16

A mixture was obtained by homogeneously stirring 90 parts of the blue pigment, 10 parts of the pigment derivative [2] and 133 parts of the urethane-based dispersant (IV-U4), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. The solvents evaporated during the dispersing treatment, and the kneaded mixture became an elastic solid product. The resulting solid product was cooled and ground to obtain a coated pigment.

Then, 167 parts of the coated pigment and 506 parts of the solvent (CBAc) were mixed in a mixer, and the mixture was charged to a sand mill and dispersed. Thereafter, 40 parts of the melamine resin (MS-001), 20 parts of acrylic monomer (M-400; manufactured by Toagosei Co., Ltd.), 20 parts of the solvent (CBAc) and 66 parts of the solvent (BuCBAc) were added, and mixed. After the mixture was filtered to remove any impurities and oversized particles, an ink composition for ink jet recording, containing the pigment concentration of 12%, was obtained.

### Comparative Example IV-13

The procedure described in Example IV-15 was repeated, except that 133 parts of the urethane-based dispersant (IV-U8) was used instead of 133 parts of the urethane-based dispersant (IV-U4), to obtain the ink composition for ink jet recording, containing the pigment concentration of 12%.

### Example IV-17

A mixture was obtained by homogeneously stirring 90 parts of red-2 pigment, 10 parts of the pigment derivative [5] and 133 parts of the urethane-based dispersant (IV-U5), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. The solvents evaporated during the dispersing treatment, and the kneaded mixture became an elastic solid product. The resulting solid product was cooled and ground to obtain a coated pigment.

Then, 167 parts of the coated pigment and 426 parts of the solvent (CBAc) were mixed in a mixer, and the mixture was charged to a sand mill and dispersed. Thereafter, 40 parts of the melamine resin (MS-001), 76 parts of the solvent (CBAc) and 66 parts of the solvent (BuCBAc) were added, and mixed. Finally, the product was filtered under pressure by a membrane filter to obtain the ink composition for ink jet recording, containing the pigment concentration of 13%.

### Comparative Example IV-14

The procedure described in Example IV-17 was repeated, except that 133 parts of the vinyl-based resin (IV-B1) was used instead of 133 parts of the urethane-based dispersant (IV-U5), to obtain the ink composition for ink jet recording, containing the pigment concentration of 13%.

### Example IV-18

A mixture was obtained by homogeneously stirring 90 parts of violet pigment, 10 parts of the pigment derivative [6] and 133 parts of the urethane-based dispersant (IV-U6), and kneaded for 10 minutes by two rolls heated at 60° C., whereby the solvents were volatilized to obtain a sheet. Then, 50 parts of the solvent (PGMAc) was added, and the whole was kneaded by the two rolls heated at 80° C. The solvents evaporated during the dispersing treatment, and the kneaded mixture became an elastic solid product. The resulting solid product was cooled and ground to obtain a coated pigment.

Then, 167 parts of the coated pigment and 506 parts of the solvent (CBAc) were mixed in a mixer, and the mixture was charged to a sand mill and dispersed. Thereafter, 40 parts of the melamine resin (MS-001), 40 parts of the solvent (CBAc) and 66 parts of the solvent (BuCBAc) were added, and mixed. After the mixture was filtered to remove any impurities and oversized particles, an ink composition for ink jet recording, containing the pigment concentration of 12%, was obtained.

### Comparative Example IV-15

The procedure described in Example IV-18 was repeated, except that 67 parts of the urethane-based dispersant (IV-U7) and 66 parts of the solvent (PGMAc) were used instead of 133 parts of the urethane-based dispersant (IV-U6), to obtain the ink composition for ink jet recording, containing the pigment concentration of 12%.

### [Evaluation of Properties]

The inkjet inks prepared in Examples IV-1 to IV-18 and Comparative Examples IV-1 to IV-15 were evaluated as to a viscosity, a flowability, a storage stability, and a chemical resistance, in accordance with the methods as mentioned above. Further, the inkjet inks prepared in Examples IV-1 to IV-18 and Comparative Examples IV-1 to IV-15 were discharged from an inkjet printer having piezo heads capable of changing frequency from 4 to 10 KHz to evaluate a discharging stability and a printed concentration in accordance with the methods as mentioned above.

The results of the evaluation were shown in the following Tables.

TABLE 19

| | | Example | | | | | | | | |
|---|---|---|---|---|---|---|---|---|---|---|
| | | IV-1 | IV-2 | IV-3 | IV-4 | IV-5 | IV-6 | IV-7 | IV-8 | IV-9 |
| Pigment | Red | 90 | 90 | | | | | | | |
| | Green | | | 90 | 90 | | | | | |
| | Yellow | | | | | 90 | | | | |
| | Blue | | | | | | 90 | 90 | | |
| | Cyan | | | | | | | | 90 | |
| | Magenta | | | | | | | | | 90 |
| Pigment | [1] | 10 | 10 | | | | | | | |
| derivative | [2] | | | 10 | 10 | | 10 | 10 | 10 | |
| | [3] | | | | | 10 | | | | |
| | [4] | | | | | | | | | 10 |
| Urethane-based | IV-U1 | 67 | 67 | | | | | | | |
| Dispersing agent (*1) | IV-U2 | | | 50 | 50 | | | | | |
| | IV-U3 | | | | | 67 | | | | |
| | IV-U4 | | | | | | 67 | 67 | | |
| | IV-U5 | | | | | | | | 67 | |
| | IV-U6 | | | | | | | | | 67 |
| Process for | | No | No | Yes | Yes | Yes | Yes | Yes | No | No |
| coating pigments | | | | | | | | | | |
| Melamine resin | MX-43 | 40 | 40 | 40 | | 40 | 40 | 40 | 40 | 40 |
| Benzoguanamine | SB-401 | | | | 40 | | | | | |
| resin | | | | | | | | | | |
| Epoxy compound | EPPN-201 | | 20 | | | | | | | |
| Acrylic monomer | TPA-330 | | | | | | | 20 | | |
| Solvent (*2) | CBAc | 496 | 476 | 366 | 366 | 320 | 612 | 592 | | |
| | BuCBAc | | | | | | | | 394 | 394 |
| | PGMAc | 66 | 66 | | | | | | 66 | 66 |

(*1): The values in Table 19 are the solid contents
(*2): The values in Table 19 mean the contents in resulting ink compositions

TABLE 20

| | | Example | | | | | | | | |
|---|---|---|---|---|---|---|---|---|---|---|
| | | IV-1 | IV-2 | IV-3 | IV-4 | IV-5 | IV-6 | IV-7 | IV-8 | IV-9 |
| Pigment | Red | 90 | 90 | | | | | | | |
| | Green | | | 90 | 90 | | | | | |
| | Yellow | | | | | 90 | | | | |
| | Blue | | | | | | 90 | 90 | | |
| | Red-2 | | | | | | | | 90 | |
| | Violet | | | | | | | | | 90 |
| Pigment | [1] | 10 | 10 | | | | | | | |
| derivative | [2] | | | 10 | 10 | | 10 | 10 | | |
| | [3] | | | | | 10 | | | | |
| | [5] | | | | | | | | 10 | |
| | [6] | | | | | | | | | 10 |
| Urethane-based | IV-U1 | 67 | 67 | | | | | | | |
| Dispersing agent (*1) | IV-U2 | | | 50 | 50 | | | | | |
| | IV-U3 | | | | | 67 | | | | |
| | IV-U4 | | | | | | 67 | 67 | | |
| | IV-U5 | | | | | | | | 67 | |
| | IV-U6 | | | | | | | | | 67 |
| Process for | | Yes | Yes | Yes | Yes | Yes | Yes | Yes | Yes | Yes |
| coating pigments | | | | | | | | | | |
| Melamine resin | MS-001 | 40 | 40 | | | | 40 | 40 | 40 | 40 |
| Benzoguanamine | SB-201 | | | 40 | 40 | | | | | |
| resin | | | | | | | | | | |
| Acrylic monomer | M-400 | | 20 | | 20 | | | 20 | | |
| Solvent (*2) | CBAc | 496 | 476 | 333 | 313 | 287 | 546 | 526 | 496 | 546 |
| | BuCBAc | 66 | 66 | 33 | 33 | 33 | 66 | 66 | 66 | 66 |

(*1): The values in Table 20 are the solid contents
(*2): The values in Table 20 mean the contents in resulting ink compositions

TABLE 21

| | | Comparative Example | | | | | | | | |
|---|---|---|---|---|---|---|---|---|---|---|
| | | IV-1 | IV-2 | IV-3 | IV-4 | IV-5 | IV-6 | IV-7 | IV-8 | IV-9 |
| Pigment | Red | 90 | 90 | | | | | | | |
| | Green | | | 90 | 90 | | | | | |
| | Yellow | | | | | 90 | | | | |
| | Blue | | | | | | 90 | 90 | | |
| | Cyan | | | | | | | | 90 | |
| | Magenta | | | | | | | | | 90 |
| Pigment | [1] | 10 | 10 | | | | | | | |
| derivative | [2] | | | 10 | 10 | | 10 | 10 | 10 | |
| | [3] | | | | | 10 | | | | |
| | [4] | | | | | | | | | 10 |
| Urethane-based | IV-U1 | | 67 | | | | | | | |
| Dispersing agent (*1) | IV-U2 | | | | 50 | | | | | |
| | IV-U4 | | | | | | | 67 | | |
| | IV-U7 | 67 | | | | | | | | 67 |
| | IV-U8 | | | 50 | | | | | | |
| Vinyl resin (*1) | IV-B1 | | | | | 67 | 67 | | 67 | |
| Process for | | No | No | Yes | Yes | Yes | Yes | Yes | No | No |
| coating pigments | | | | | | | | | | |
| Melamine resin | MX-43 | 40 | | 40 | | 40 | 40 | | 40 | 40 |
| Epoxy compound | EPPN-201 | | | | | | | | | |
| Acrylic monomer | TPA-330 | | | | | | | | | |
| Solvent (*2) | CBAc | 496 | 536 | 416 | 406 | 320 | 612 | 652 | | |
| | BuCBAc | | | | | | | | 394 | 394 |
| | PGMAc | 66 | 66 | | | | | | 66 | 66 |

(*1): The values in Table 21 are the solid contents
(*2): The values in Table 21 mean the contents in resulting ink compositions

TABLE 22

| | | Comparative Example | | | | | |
|---|---|---|---|---|---|---|---|
| | | IV-10 | IV-11 | IV-12 | IV-13 | IV-14 | IV-15 |
| Pigment | Red | 90 | | | | | |
| | Green | | 90 | | | | |
| | Yellow | | | 90 | | | |
| | Blue | | | | 90 | | |
| | Red-2 | | | | | 90 | |
| | Violet | | | | | | 90 |
| Pigment | [1] | 10 | | | | | |
| derivative | [2] | | 10 | | 10 | | |
| | [3] | | | 10 | | | |
| | [5] | | | | | 10 | |
| | [6] | | | | | | 10 |
| Urethane-based | IV-U7 | | | 67 | | | 67 |
| Dispersing agent | IV-U8 | | | | 67 | | |
| (Note 1) | | | | | | | |
| Vinyl resin (*1) | IV-B1 | 67 | 50 | | | 67 | |
| Process for | | Yes | Yes | Yes | Yes | Yes | Yes |
| coating pigments | | | | | | | |
| Melamine resin | MS-001 | 40 | | | 40 | 40 | 40 |
| Benzoguanamine | SB-201 | | 40 | | | | |
| resin | | | | | | | |
| Solvent (*2) | CBAc | 496 | 333 | 320 | 546 | 496 | 546 |
| | BuCBAc | 66 | 33 | 33 | 66 | 66 | 66 |

(*1): The values in Table 22 are the solid contents
(*2): The values in Table 22 mean the contents in resulting ink compositions

TABLE 23

| | Example | | | | | | | | |
|---|---|---|---|---|---|---|---|---|---|
| | IV-1 | IV-2 | IV-3 | IV-4 | IV-5 | IV-6 | IV-7 | IV-8 | IV-9 |
| Viscosity | 21 | 23 | 20 | 19 | 25 | 14 | 15 | 13 | 23 |
| (mPa · s) | | | | | | | | | |
| Flowability | 1.3 | 1.4 | 1.3 | 1.2 | 1.3 | 1.1 | 1.1 | 1.1 | 1.3 |
| Storage | 4% | 6% | 5% | 4% | 6% | 0% | 0% | −2% | 7% |
| stability | | | | | | | | | |
| Discharging | ◯ | ◯ | ◯ | ◯ | ◯ | ◯ | ◯ | ◯ | ◯ |
| stability | | | | | | | | | |
| Chemical | 1.8 | 1.8 | 1.9 | 1.6 | 1.3 | 1.5 | 1.9 | 1.8 | 1.5 |
| resistance | | | | | | | | | |
| Printed concentration | 1.3 | 1.3 | 1.4 | 1.4 | 1.2 | 1.4 | 1.3 | 1.3 | 1.3 |

TABLE 24

| | Example | | | | | | | | |
|---|---|---|---|---|---|---|---|---|---|
| | IV-10 | IV-11 | IV-12 | IV-13 | IV-14 | IV-15 | IV-16 | IV-17 | IV-18 |
| Viscosity | 20 | 23 | 21 | 17 | 25 | 15 | 16 | 15 | 22 |
| (mPa · s) | | | | | | | | | |
| Flowability | 1.2 | 1.3 | 1.3 | 1.2 | 1.3 | 1.1 | 1.1 | 1.1 | 1.3 |
| Storage | 6% | 8% | 6% | 3% | 7% | 3% | 1% | 4% | 6% |
| stability | | | | | | | | | |
| Discharging | ◯ | ◯ | ◯ | ◯ | ◯ | ◯ | ◯ | ◯ | ◯ |
| stability | | | | | | | | | |
| Chemical | 1.6 | 1.7 | 1.5 | 1.4 | 1.4 | 1.4 | 1.6 | 1.8 | 1.4 |
| resistance | | | | | | | | | |
| Printed concentration | 1.3 | 1.3 | 1.4 | 1.4 | 1.2 | 1.4 | 1.3 | 1.3 | 1.2 |

TABLE 25

| | Comparative Example | | | | | | | | |
|---|---|---|---|---|---|---|---|---|---|
| | IV-1 | IV-2 | IV-3 | IV-4 | IV-5 | IV-6 | IV-7 | IV-8 | IV-9 |
| Viscosity | 45 | 19 | Unflowable | 19 | 48 | 40 | 13 | 32 | 49 |
| (mPa · s) | | | | | | | | | |
| Flowability | 3.1 | 1.1 | Unflowable | 1.1 | 3.1 | 2.8 | 1.1 | 2.5 | 3.1 |
| Storage | 145% | 2% | Unflowable | 2% | 67% | 30% | −2% | 22% | 78% |
| stability | | | | | | | | | |
| Discharging | X | ◯ | Unflowable | ◯ | Δ | Δ | ◯ | Δ | Δ |
| stability | | | | | | | | | |
| Chemical | 2.0 | 7.5 | Unflowable | 7.6 | 1.8 | 2.1 | 6.5 | 1.9 | 2.1 |
| resistance | | | | | | | | | |
| Printed | 1.1 | 1.3 | Unflowable | 1.4 | 1.1 | 1.2 | 1.4 | 1.2 | 1.0 |
| concentration | | | | | | | | | |

TABLE 26

| | Comparative Example | | | | | |
|---|---|---|---|---|---|---|
| | IV-10 | IV-11 | IV-12 | IV-13 | IV-14 | IV-15 |
| Viscosity | 36 | 77 | 67 | Unflowable | 51 | 44 |
| (mPa · s) | | | | | | |
| Flowability | 2.6 | 3.6 | 3.3 | Unflowable | 3.7 | 3.1 |
| Storage | 99% | 101% | 90% | Unflowable | 89% | 109% |
| stability | | | | | | |
| Discharging | Δ | X | X | Unflowable | X | X |
| stability | | | | | | |
| Chemical | 1.8 | 2.0 | 2.3 | Unflowable | 2.1 | 2.2 |
| resistance | | | | | | |
| Printed | 1.0 | 1.1 | 1.1 | Unflowable | 1.2 | 1.1 |
| concentration | | | | | | |

### INDUSTRIAL APPLICABILITY

The ink composition for ink jet recording according to the present invention has a good chemical resistance and contains a high concentration of pigments. Nonetheless, the ink composition according to the present invention has a low viscosity and exhibits a good temporal stability in viscosity, when used as a paint or ink. Further, when the ink composition according to the present invention is used as an inkjet ink, it has a low viscosity and a good discharging stability, while maintaining resistance. Furthermore, the ink composition according to the present invention can be used as an inkjet ink to produce a high performance color filter, package, outdoor display, or the like more efficiently than conventional methods.

Although the present invention has been described with reference to specific embodiments, various changes and modifications obvious to those skilled in the art are possible without departing from the scope of the appended claims.

1-38. (canceled)

39. A nonaqueous ink composition for an ink jet recording, comprising
(A) a urethane resin dispersant with an acidic functional group,
(B) a pigment, and
(C) an organic solvent,
wherein
the urethane resin dispersant (A) is a branched urethane resin dispersant prepared by polymerizing a terminal-isocyanate-containing compound (p), which has been prepared by reacting
(a) a polyisocyanate having three or more isocyanate groups, and
(b) a monoalcohol,
under the condition that a molar ratio (Ma/Mb) of the number of moles (Ma) of isocyanate groups (NCO) from the polyisocyanate (a) to the number of moles (Mb) of hydroxyl groups (OH) from the monoalcohol (b) is 3/2 to 3/0.5,
(c) a compound having one or more acidic groups and two or more hydroxyl groups, and (q) a polyol compound having two or more hydroxyl groups via 1 to 30 atoms, under the condition that the hydroxyl groups are in excess; and
in that 25% to 60% by weight of the polyisocyanate (a) is used with respect to a total amount of nonvolatile components in the branched urethane resin dispersant.

40. The nonaqueous ink composition for ink jet recording of claim 39, wherein
(d) an acrylic resin having two or more hydroxyl groups via 1 to 30 atoms and/or
(e) a siloxane resin having two or more hydroxyl groups via 1 to 30 atoms are used as the polyol compound (q).

41. The nonaqueous ink composition for ink jet recording of claim 39, further comprising (D) a thermal reactive compound.

42. The nonaqueous ink composition for ink jet recording of claim 39, wherein the monoalcohol (b) is at least one resin selected from the group consisting of (b1) a lactone resin having one hydroxyl group, (b2) an oxyalkylene resin having one hydroxyl group, (b3) an acrylic resin having one hydroxyl group, and (b4) a siloxane resin having one hydroxyl group.

43. The nonaqueous ink composition for ink jet recording of claim 39, wherein the polyisocyanate (a) is a trimer of diisocyanate.

44. The nonaqueous ink composition for ink jet recording of claim 39, wherein the polyisocyanate (a) is a trimer of isophoronediisocyanate.

45. The nonaqueous ink composition for ink jet recording of claim 42, wherein the lactone resin (b1) having a hydroxyl group is (i) a homopolymer prepared by polymerizing a monoalcohol (b5) with at least one monomer selected from ε-caprolactone, 4-methylcaprolactone, 3,5,5-trimethylcaprolactone, 3,3,5-trimethylcaprolactone, β-propiolactone, γ-butyrolactone, δ-valerolactone, and enantholactone, (ii) a copolymer prepared by copolymerizing at least two or more monomers selected from the above compounds with the monoalcohol (b5), or (iii) a mixture of two or more polymers selected from the above homopolymers (i) and the above copolymers (ii).

46. The nonaqueous ink composition for ink jet recording of claim 42, wherein the acrylic resin (b3) having a hydroxyl group is prepared by polymerizing monomers containing 20% to 70% by weight of benzyl(meta)acrylate.

47. The nonaqueous ink composition for ink jet recording of claim 39, wherein the monoalcohol (b) further comprises (meta)acrylate (b6) having a hydroxyl group.

48. The nonaqueous ink composition for ink jet recording of claim 41, wherein the thermal reactive compound is at least one compound selected from the group consisting of a melamine compound, a benzoguanamine compound, an epoxy compound, a phenol compound, a blocked isocyanate compound, acrylate-based monomer, and silane coupling agent.

49. A nonaqueous ink composition for an ink jet recording, comprising
(A) a urethane resin dispersant with an acidic functional group,
(B) a pigment, and
(C) an organic solvent,
wherein
the urethane resin dispersant (A) is a branched urethane resin dispersant prepared by polymerizing a terminal-isocyanate-containing compound (p), which has been prepared by reacting
(a) a polyisocyanate having three or more isocyanate groups, and
(b) a monoalcohol,
under the condition that a molar ratio (Ma/Mb) of the number of moles (Ma) of isocyanate groups (NCO) from the polyisocyanate (a) to the number of moles (Mb) of hydroxyl groups (OH) from the monoalcohol (b) is 3/2 to 3/0.5, and
(c) a compound having one or more acidic groups and two or more hydroxyl groups, under the condition that the hydroxyl groups are in excess;
in that 25% to 60% by weight of the polyisocyanate (a) is used with respect to a total amount of nonvolatile components in the branched urethane resin dispersant; and
in that the monoalcohol (b) is at least one resin selected from the group consisting of (b1) a lactone resin having a hydroxyl group, (b2) an oxyalkylene resin having a hydroxyl group, (b3) an acrylic resin having a hydroxyl group, and (b4) a siloxane resin having a hydroxyl group.

50. A nonaqueous ink composition for an ink jet recording, comprising
(A) a urethane resin dispersant with an acidic functional group,
(B) a pigment, and
(C) an organic solvent,
wherein
the urethane resin dispersant (A) is a branched urethane resin dispersant prepared by reacting
hydroxyl groups in a terminal-hydroxyl-containing compound prepared by polymerizing a terminal-isocyanate-containing compound (p), which has been prepared by reacting
(a) a polyisocyanate having three or more isocyanate groups, and
(b) a monoalcohol,
under the condition that a molar ratio (Ma/Mb) of the number of moles (Ma) of isocyanate groups (NCO) from the polyisocyanate (a) to the number of moles (Mb) of hydroxyl groups (OH) from the monoalcohol (b) is 3/2 to 3/0.5, and
(q) a polyol compound having two or more hydroxyl groups via 1 to 30 atoms,
under the condition that the hydroxyl groups are in excess, and
acid anhydride groups in a compound (r) having acid anhydride groups; and
in that 25% to 60% by weight of the polyisocyanate (a) is used with respect to a total amount of nonvolatile components in the branched urethane resin dispersant.

51. A nonaqueous ink composition for an ink jet recording, comprising
(A) a urethane resin dispersant with an acidic functional group,
(B) a pigment, and
(C) an organic solvent,
wherein
the urethane resin dispersant (A) is a branched urethane resin dispersant prepared by reacting
hydroxyl groups in a terminal-hydroxyl-containing compound prepared by polymerizing a terminal-isocyanate-containing compound (p), which has been prepared by reacting
(a) a polyisocyanate having three or more isocyanate groups, and
(b) a monoalcohol,
under the condition that a molar ratio (Ma/Mb) of the number of moles (Ma) of isocyanate groups (NCO) from the polyisocyanate (a) to the number of moles (Mb) of hydroxyl groups (OH) from the monoalcohol (b) is 3/2 to 3/0.5, and
(f) a polyol compound,
under the condition that the hydroxyl groups are in excess, and
acid anhydride groups in a compound (r) having acid anhydride groups;
in that 25% to 60% by weight of the polyisocyanate (a) is used with respect to a total amount of nonvolatile components in the branched urethane resin dispersant; and
in that the monoalcohol (b) is at least one resin selected from the group consisting of (b1) a lactone resin having a hydroxyl group, (b2) an oxyalkylene resin having a hydroxyl group, (b3) an acrylic resin having a hydroxyl group, and (b4) a siloxane resin having a hydroxyl group.

52. The nonaqueous ink composition for ink jet recording of claim 39, further comprising a binder resin.

53. The nonaqueous ink composition for ink jet recording of claim 39, further comprising a pigment derivative.

54. The nonaqueous ink composition for ink jet recording of claim 39, wherein the content of the pigment is 1 to 30% by weight with respect to a total weight of the ink composition.

55. The nonaqueous ink composition for ink jet recording of claim 39, wherein an amount of the urethane resin dispersant is 3 to 150 parts by weight with respect to 100 parts by weight of the pigment.

56. The nonaqueous ink composition for ink jet recording of claim 39, wherein when a concentration of a solid content ranges from not less than 20% by weight to less than 40% by weight, a viscosity [applied only in case that a shear rate is 100 (1/s); the viscosity has the same meaning in the following statements] is 3 to 200 (mPa·s), and a T.I. value [the T.I. value is a ratio (ηa/ηb) of a viscosity ηa (mPa·s) at a shear rate of 10 (1/s) to a viscosity ηb (mPa·s) at a shear rate of 1000 (1/s); it has the same meaning in the following statements] is 1 to 2, and when a concentration of a solid content ranges from not less than 40% by weight to not more than 60% by weight, the viscosity is 10 to 200 (mPa·s), and the T.I. value is 1 to 3.

57. The nonaqueous ink composition for ink jet recording of claim 39, wherein a viscosity at 25° C. is 2 to 40 mPa·s.

58. A substrate for a color filter, having a printed layer formed from the nonaqueous ink composition for ink jet recording, of claim 39.
